(19) United States
(12) Patent Application Publication
(10) Pub. No.: US 2023/0055168 A1
(43) Pub. Date: Feb. 23, 2023

(54) PROJECT MANAGEMENT SYSTEM, METHOD OF OPERATING PROJECT MANAGEMENT SYSTEM, AND NON-TRANSITORY COMPUTER-READABLE MEDIUM

(71) Applicant: MANAGEMENT SOLUTIONS CO., LTD., Tokyo (JP)

(72) Inventor: Akira KANEKO, Tokyo (JP)

(73) Assignee: MANAGEMENT SOLUTIONS CO., LTD., Tokyo (JP)

(21) Appl. No.: 17/900,660

(22) Filed: Aug. 31, 2022

Related U.S. Application Data
(63) Continuation of application No. PCT/JP2021/009636, filed on Mar. 10, 2021.

(30) Foreign Application Priority Data
Mar. 10, 2020 (JP) 2020-040573

(51) Int. Cl. G06Q 10/10; G06Q 10/06; G06T 11/20

(52) U.S. Cl. CPC G06Q 10/103; G06Q 10/063114; G06T 11/206

(57) ABSTRACT

Provided is a project management system including a process identifying information holding unit that holds process identifying information for identifying processes of a project, an influencing circumstantial situation information holding unit that holds a plurality of pieces of influencing circumstantial situation information that is information indicating an influencing circumstance being a circumstance influencing progress of the project recognized in the processes of the project, a per-process influencing circumstantial situation information input reception unit that receives per-process influencing circumstantial situation information that is information associating the influencing circumstantial situation information being held and the process identifying information of the process in which the circumstantial situation indicated by the influencing circumstantial situation information is recognized, and a graphical output unit that outputs graphically the per-process influencing circumstantial situation information.

### CROSS-REFERENCE TO RELATED APPLICATION

This application is a continuation application of International Application PCT/JP2021/009636 filed on Mar. 10, 2021 and designated the U.S., which claims the benefits of priorities of Japanese Patent Application No. 2020-040573 filed on Mar. 10, 2020, the entire contents of which are incorporated herein by reference.

### FIELD

The present invention relates to a system that can provide a mechanism for operating and accomplishing relatively large single or multiple projects with relative manpower savings without relying on professional project experts from outside the company, provide a mechanism for inputting and managing information for efficient and reliable utilization of various resources and support for project executors, and also enhance the ability of members involved in a project to accomplish the project. In particular, a main feature of the system is that the results are output graphically so that the project members can intuitively grasp various information and understand what they need to do, as well as the future status of the project.

### BACKGROUND

A system for organizing various information on the project has existed for some time. However, the quality of information on the project was not high in that it was based on the subjectivity of each member and was left to the discretion of each member, since the content was, so to speak, to the extent that the notes of each member were shared on the cloud. It was difficult to clearly grasp what each of the project members should do now, and it could hardly be said to fulfill its function of increasing the probability of success of the project. In addition, the system did not have a structure to give sufficient feedback and awareness to the project member, making it difficult for the project members to grow in their ability to carry out the project. That is, the system was inadequate and posed an issue since there was no opportunity to obtain hints for project success or task (TO DO) completion from the system. The assistance had to rely on experienced professional external project managers.

Therefore, Patent Document 1 (Japanese Laid-open Patent Publication No. 2013-061694) is mentioned as an attempt to solve a part of the above problems.

### SUMMARY

According to an aspect of the present disclosure, there is provided a project management system including: a memory; a processor coupled to the memory and the processor configured to: hold process identification information that identifies a process of a project; hold a plurality of types of influencing circumstance situation information, each of which expressing an influencing circumstance which is a circumstance that influences the progress of the project recognized in the process of the project; receive an input of per-process influencing circumstance situation information which is information that associates the held influencing circumstance situation information with process identification information of a process in which an influencing circumstance indicated by the influencing circumstance situation information is recognized; and graphically output the per-process influencing circumstance situation information.

In addition to the above features, the processor may be further configured to graphically output the per-process influencing circumstance situation information with a matrix of the process and the influencing circumstance.

In addition to the above features, the processor may be further configured to acquire time information, further acquire per-time process influencing situation circumstance information which is information that associates the acquired time information with the per-process influencing situation circumstance information, and indicate a change in the influencing situation on a time axis.

In addition to the above features, the type of the influencing circumstance in the influencing situation circumstance information may include information indicating an influence degree of the influencing circumstance on the completion of the project or process.

In addition to the above features, the type of the influencing circumstance in the influencing situation circumstance information may include information indicating a possibility of appearance of the influencing circumstance on a negative side.

In addition to the above features, the processor may be further configured to hold issue information, which is information indicating an issue which hinders the complete execution of the process recognized in the process, as the influencing circumstance.

In addition to the above features, the processor may be further configured to hold essential work information, which is information indicating a work that must be processed indispensably for the complete execution of the process recognized in the process, as the influencing circumstance.

In addition to the above features, the processor may be further configured to hold change request information, which is information indicating a matter that is required to be changed for the complete execution of the process recognized in the process, as the influencing circumstance.

In addition to the above features, the processor may be further configured to hold the risk information, which is information indicating a risk recognized in the process, as the influencing circumstance.

According to another aspect of the present disclosure, there is provided a project management system including: a memory; a processor coupled to the memory and the processor configured to: hold executor identification information that identifies an executor of a project; hold a plurality of types of influencing circumstance identification information that identifies an influencing circumstance which is a circumstance that influences the progress of the project recognized in a phase of the project; hold status identification information that identifies a status which is information indicating a status of resolution to an influencing circumstance identified by the influencing circumstance identification information; hold execution manager identification information that identifies an execution manager as an executor who is responsible for executing a workaround to avoid an adverse influence on the project due to the influencing circumstance; hold phase identification information that identifies a phase of the project; receive an input of influencing circumstance situation information which is information that associates, with each other, the held influencing circumstance identification information, the phase identification information of the phase in which the influencing circumstance identified by the influencing circumstance identification information is recognized, recognized timing thereof, the execution manager identification information that identifies the execution manager as the executor who is responsible for executing the workaround to avoid the adverse influence on the project due to the influencing circumstance, an influence degree to which the influencing circumstance influences the project, the status identification information of the status which is information indicating the status of resolution to the influencing circumstance; hold the received influencing circumstance situation information; output the held influencing circumstance situation information; and graphically output a graph with one axis as timing and another axis as the recognized number of pieces of influencing circumstance situation information using the held influencing circumstance situation information.

In addition to the above features, the processor may be further configured to graphically output a graph with the one axis as the timing and the another axis as the number of recognitions per influence degree of the influencing circumstance situation information, using received per-phase influencing circumstance situation information.

In addition to the above features, the processor may be further configured to graphically outputting a graph with the one axis as the timing and the another axis as the number of cases per status of the influencing circumstance situation information, using received per-phase influencing circumstance situation information.

In addition to the above features, the processor may be further configured to display a graphical output per phase identified by the phase identification information included in the influencing circumstance situation information.

In addition to the above features, the processor may be further configured to display a graphical output per execution manager identified by the execution manager identification information included in the influencing circumstance situation information.

In addition to the above features, the processor may be further configured to output a pie chart indicating the number of pieces of influencing circumstance situation information per status as a ratio by setting the total number of pieces of held influencing circumstance situation information as a whole.

In addition to the above features, the processor may be further configured to output a pie chart indicating the number of pieces of influencing circumstance situation information per influence degree as a ratio by setting the total number of pieces of held influencing circumstance situation information as a whole.

In addition to the above features, the processor may be further configured to output a pie chart indicating the number of pieces of influencing circumstance situation information per occurrence phase which is an occurred phase as a ratio by setting the total number of pieces of held influencing circumstance situation information as a whole.

In addition to the above features, the processor may be further configured to display, with a pie chart, an influence degree of the held influencing circumstance situation information per execution manager identified by the execution manager identification information.

In addition to the above features, the processor may be further configured to display, with a pie chart, an influence degree of the held influencing circumstance situation information per status identified by the status identification information.

According to still another aspect of the present disclosure, there are provided a method of operating a project management system and a non-transitory computer-readable medium.

Thereby, it is possible to output information on issues, tasks, and risks centrally and graphically over time or not over time by distinguishing each element of the project, such as an executor, influencing circumstance information, a status, an execution manager, and a phase. This makes it possible to intuitively grasp the events occurring in each process, including future conditions, and facilitates an intuitive and in-depth understanding of events that are difficult to convey to a project executor using conventional static text and numerical values.

### BRIEF DESCRIPTION OF THE DRAWINGS

FIGS. 1A and 1B are diagrams illustrating a functional configuration of a project management system according to a first embodiment;

FIGS. 2A to 2C are diagrams illustrating a hardware configuration of the project management system according to the first embodiment;

FIG. 3 is a flowchart illustrating a process when the project management system in the first embodiment is used;

FIGS. 4A and 4B are diagrams illustrating a functional configuration of a project management system according to a second embodiment;

FIGS. 5A to 5C are diagrams illustrating a hardware configuration of the project management system according to the second embodiment;

FIG. 6 is a flowchart illustrating a process when the project management system according to the second embodiment is used;

FIGS. 7A and 7B are diagrams illustrating a functional configuration of a project management system according to a third embodiment;

FIGS. 8A to 8C are diagrams illustrating a hardware configuration of the project management system according to the third embodiment;

FIG. 9 is a flowchart illustrating a process when the project management system in the third embodiment is used;

FIGS. 10A and 10B are diagrams illustrating a functional configuration of a project management system according to a fourth embodiment;

FIGS. 11A to 11C are diagrams illustrating a hardware configuration of the project management system according to the fourth embodiment;

FIG. 12 is a flowchart illustrating a process when the project management system in the fourth embodiment is used;

FIGS. 13A and 13B are diagrams illustrating a functional configuration of a project management system according to a fifth embodiment;

FIGS. 14A to 14C are diagrams illustrating a hardware configuration of the project management system according to the fifth embodiment;

FIG. 15 is a flowchart illustrating a process when the project management system in the fifth embodiment is used;

FIGS. 16A and 16B are diagrams illustrating a functional configuration of a project management system according to a sixth embodiment;

FIGS. 17A to 17C are diagrams illustrating a hardware configuration of the project management system according to the sixth embodiment;

FIG. 18 is a flowchart illustrating a process when the project management system in the sixth embodiment is used;

FIGS. 19A and 19B are diagrams illustrating a functional configuration of a project management system according to a seventh embodiment;

FIGS. 20A to 20C are diagrams illustrating a hardware configuration of the project management system according to the seventh embodiment;

FIG. 21 is a flowchart illustrating a process when the project management system in the seventh embodiment is used;

FIG. 22 is a diagram illustrating an example of a screen for “project registration”, which is a prerequisite for project management;

FIG. 23 is a diagram illustrating an example of the registration screen of members participating in a project;

FIG. 24 is a diagram illustrating an example of status identification information (or status identified by status identification information);

FIG. 25 is a diagram illustrating an example of a screen of status registration;

FIG. 26 is a diagram illustrating an example of information on executors (database of executors);

FIG. 27 is a diagram illustrating an example of influencing circumstance situation information;

FIG. 28 is a diagram illustrating an example of information related to “issue” in the influencing circumstance situation information;

FIG. 29 is a diagram illustrating an example of information related to “risk” in the influencing circumstance situation information;

FIG. 30 is a diagram illustrating an example of information related to “project change” in the influencing circumstance situation information;

FIG. 31 is a diagram illustrating an example of a screen of project phase registration;

FIG. 32 is a diagram illustrating an example of a screen of the project phase registration;

FIG. 33 is a diagram illustrating an example of information related to the phase of the project;

FIG. 34 is a diagram illustrating a relationship between phases;

FIG. 35 is a diagram illustrating an example of reception of influencing circumstance situation information (registration screen when influencing circumstance occurs);

FIG. 36 is a diagram illustrating an example of a screen for “pre-registration so that the influencing circumstance that is expected to occur can be received” in the case of the method of selection by pull-down in the influencing circumstance registration;

FIG. 37 is a diagram illustrating an example of a screen for selecting a mode of graphical output;

FIG. 38 is a diagram illustrating an example of a screen for selecting a time-axis bar graph;

FIG. 39 is a diagram illustrating an example of a screen for selecting a simple time-axis graph display;

FIG. 40 is a diagram illustrating an example of a screen for selecting a percentage presentation graph;

FIG. 41 is a diagram illustrating a screen for selecting a percentage presentation element when the percentage presentation graph is selected;

FIG. 42A is a diagram illustrating an example of a pie chart;

FIG. 42B is a diagram illustrating an example of an area graph;

FIGS. 43A to 43C are diagrams illustrating a functional configuration of a project management system according to an eighth embodiment;

FIGS. 44A to 44C are diagrams illustrating an example of the hardware configuration of the project management system according to the eighth embodiment;

FIG. 45 is a flowchart illustrating a process when the project management system according to the eighth embodiment is used;

FIGS. 46A to 46C are diagrams illustrating a functional configuration of a project management system according to a ninth embodiment;

FIGS. 47A to 47C are diagrams illustrating an example of the hardware configuration of the project management system according to the ninth embodiment;

FIG. 48 is a flowchart illustrating a process when the project management system according to the ninth embodiment is used;

FIGS. 49A to 49C are diagrams illustrating a functional configuration of a project management system according to a tenth embodiment;

FIGS. 50A to 50C are diagrams illustrating an example of the hardware configuration of the project management system according to the tenth embodiment;

FIG. 51 is a flowchart illustrating a process when the project management system according to the tenth embodiment is used;

FIGS. 52A to 52C are diagrams illustrating a functional configuration of a project management system according to an eleventh embodiment;

FIGS. 53A to 53C are diagrams illustrating an example of the hardware configuration of the project management system according to the eleventh embodiment;

FIG. 54 is a flowchart illustrating a process when the project management system according to the eleventh embodiment is used;

FIGS. 55A to 55C are diagrams illustrating a functional configuration of a project management system according to a twelfth embodiment;

FIGS. 56A to 56C are diagrams illustrating an example of the hardware configuration of the project management system according to the twelfth embodiment;

FIG. 57 is a flowchart illustrating a process when the project management system according to the twelfth embodiment is used;

FIGS. 58A to 58C are diagrams illustrating a functional configuration of a project management system according to a thirteenth embodiment;

FIGS. 59A to 59C are diagrams illustrating an example of the hardware configuration of the project management system according to the thirteenth embodiment;

FIG. 60 is a flowchart illustrating a process when the project management system according to the thirteenth embodiment is used;

FIGS. 61A to 61C are diagrams illustrating a functional configuration of a project management system according to a fourteenth embodiment;

FIGS. 62A to 62C are diagrams illustrating an example of the hardware configuration of the project management system according to the fourteenth embodiment;

FIG. 63 is a flowchart illustrating a process when the project management system according to the fourteenth embodiment is used;

FIGS. 64A to 64C are diagrams illustrating a functional configuration of a project management system according to a fifteenth embodiment;

FIGS. 65A to 65C are diagrams illustrating an example of the hardware configuration of the project management system according to the fifteenth embodiment;

FIG. 66 is a flowchart illustrating a process when the project management system according to the fifteenth embodiment is used;

FIGS. 67A to 67C are diagrams illustrating a functional configuration of a project management system according to a sixteenth embodiment;

FIGS. 68A to 68C are diagrams illustrating an example of the hardware configuration of the project management system according to the sixteenth embodiment;

FIG. 69 is a flowchart illustrating a process when the project management system according to the sixteenth embodiment is used;

FIGS. 70A to 70C are diagrams illustrating a functional configuration of a project management system according to a seventeenth embodiment;

FIGS. 71A to 71C are diagrams illustrating an example of the hardware configuration of the project management system according to the seventeenth embodiment;

FIG. 72 is a flowchart illustrating a process when the project management system according to the seventeenth embodiment is used;

FIG. 73 is a diagram illustrating an example of a line graph (recognition number of cumulative influencing circumstances, resolution number of cumulative influencing circumstances, resolution expected number of cumulative influencing circumstances, and recognition number of influencing circumstances for each day);

FIG. 74 is a diagram illustrating an example of a pie chart;

FIG. 75 is a diagram illustrating an example of a pie chart;

FIG. 76 is a diagram illustrating an example of a pie chart;

FIG. 77 is a diagram illustrating an example of a pie chart;

FIG. 78 is a diagram illustrating an example of a bar graph; and

FIG. 79 is a diagram illustrating an example of a bar graph.

### DESCRIPTION OF EMBODIMENTS

Patent Document 1 discloses a risk management tool that manages multiple risks of the project, and updates an influence degree of risk, a probability of occurrence of risk, and a weight of risk countermeasures as the project progresses, and generates a priority for risk countermeasures.

However, although the Patent Document 1 certainly discloses a function intended to calculate risks by considering the possibility of manifestation, the influence degree, and so on, it is only a static organization of risk information when viewed from the perspective of the entire project. In other words, the system was inadequate in that it did not forecast the risk situation based on a time series over the future based on the progress of the project. In other words, the invention described in Patent Document 1 only organizes risk information statically, making it difficult to understand how issues and risks may change throughout the project looking into the future. Therefore, Patent Document 1 was not necessarily significant as a degree of contribution to the success of the project. Although it is important to statically organize risk information to ensure the success of a project, the first step is to have a system for accurately identifying risks and issues. It is also important to manage the situation of various circumstances that may or may not occur in the future based on an accurate understanding of the situation, as well as to accurately understand the dynamic modification of project tasks and other tasks and the anticipated influence of such modifications, in the event of delays in progress or the manifestation of risks.

The present disclosure provides a project management system for centrally managing information on issues, tasks, and risks in consideration of such problems. In particular, a main feature is to graphically output the information on issues, tasks, and risks.

Hereinafter, embodiments of the present disclosure will be described with reference to the accompanying drawings. The interrelationships between embodiments and claims are as follows. The description of a first embodiment relates to claims 31, 34, 35, 40, 43, 44, 49, 52 and 53. The description of a second embodiment relates to claims 32, 41 and 50. The description of a third embodiment relates to claims 33, 42 and 51. The description of a fourth embodiment relates to claims 36, 45 and 54. The description of a fifth embodiment relates to claims 37, 46 and 55. The description of a sixth embodiment relates to claims 38, 47 and 56. The description of a seventh embodiment relates to claims 39, 48 and 57. The description of an eighth embodiment relates to claims 1, 11 and 21. The description of a ninth embodiment relates to claims 2, 12 and 22. The description of a tenth embodiment relates to claims 3, 13 and 23. The description of an eleventh embodiment relates to claims 4, 14 and 24. The description of a twelfth embodiment relates to claims 5, 15 and 25. The description of a thirteenth embodiment relates to claims 6, 16 and 26. The description of a fourteenth embodiment relates to claims 7, 17 and 27. The description of a fifteenth embodiment relates to claims 8, 18 and 28. The description of a sixteenth embodiment relates to claims 9, 19 and 29. The description of a seventeenth embodiment relates to claims 10, 20 and 30. Each claim is not limited to the above embodiment, and various changes and modifications may be made to the embodiments without departing from the scope of the invention disclosed in the claims.

### Hardware Capable of Executing the Present Disclosure

In principle, this disclosure uses a computer, but it can be realized by software, by hardware, or by the collaboration of software and hardware. The hardware that realizes all or a part of elements in each claim includes the basic components of a computer such as a CPU, a memory, a bus, an input/output device, various peripheral devices, and a user interface. Various peripheral devices include storage devices, interfaces such as Internet, devices connected to Internet, displays, keyboards, mice, speakers, cameras, video devices, televisions, various sensors for monitoring production status in laboratories or factories (e.g. flow sensors, temperature sensors, weight sensors, liquid volume sensors, infrared sensors, shipping piece counters, packing piece counters, foreign material inspection devices, defective product counters, radiation inspection devices, surface condition inspection devices, circuit inspection devices, motion sensors, worker work status monitoring devices (by video, ID, PC workload, etc.), CD machines, DVD machines, Blu-ray machines, USB memory, USB memory interface, removable hard disks, general hard disks, projector devices, SSDs (Solid State Drive), telephones, fax machines, copiers, printing devices, movie editing devices, various sensor devices, or the like. This system does not necessarily have to be configured by one housing, but may be configured by combining a plurality of housings by communication. The communication may be a LAN, WANWifi, Bluetooth (registered trademark), infrared communication, ultrasonic communication, and a part of the communication may be installed across national borders. Furthermore, each of the plurality of housings may be operated by a different operational entity, or by a single operational entity. It does not matter whether the system of the present disclosure is operated by one or more entities. In addition to this system, the invention can be configured as a system including a terminal used by a third party and a terminal used by another third party. In addition, these terminals may be installed across national borders. Furthermore, in addition to this system and the terminals, a device used for registering related information and related persons of a third party, a device used for a database for recording the contents of registration, and the like may be prepared. These devices may be provided in this system, or they may be provided outside of this system, and this system may be configured to make information of these devices available.

### Sufficiency of Use of Natural Law

This invention works in cooperation with a computer, communication facilities, and software. This invention makes it possible not only to use ICT (Information and Communication Technology) to handle processes that were previously done by project participants in interviews, but also to use ICT to determine the effects of many complex information exchanges, procedures, authentication, and settlements related to projects, and to support the accumulation, retention, and exchange of effective information via ICT that meets all the necessary requirements that could not be created without skill. This invention is a so-called business model patent because it includes a process unique to ICT. In addition, various types of identification information, risk information, issue information, and task information are held or processed in each part. From this point of view, if the invention is judged on the basis of the resources such as computers described in the claims and the specification, and the common sense of the art related to those matters, the invention is based on the use of natural laws.

### Significance of Use of Natural Law as Required by Patent Law

The use of the laws of nature required by the Patent Law is required to ensure that an invention is industrially useful from the viewpoint that the invention must have industrial applicability and contribute to the development of industry, based on the purpose of the law. In other words, it requires that the invention be industrially useful, i.e., that the effect of the invention declared in the application can be reproduced with a certain degree of certainty through the implementation of the invention. From this point of view, natural law usability is interpreted to mean that the function of each of the invention specific matters (invention constituent requirements), which are the composition of the invention to realize the effect of the invention, should utilize natural laws. Furthermore, the effect of an invention should be the possibility of providing a given usefulness to the users of the invention, not how the users feel or think about the usefulness. Therefore, even if the effect that the user obtains from this system is a psychological effect, the effect itself is an event that is not subject to the required natural law usability.

### First Embodiment

### First embodiment; Summary; mainly relating to claims 31, 34, 35, 40, 43, 44, 49, 52 and 53

The present embodiment is characterized by receiving an input of per-process influencing circumstance situation information which is a circumstance influencing each process (this term “process” may be used as a phase. The same applies throughout this application.), and outputting this information graphically.

### Configuration of First Embodiment

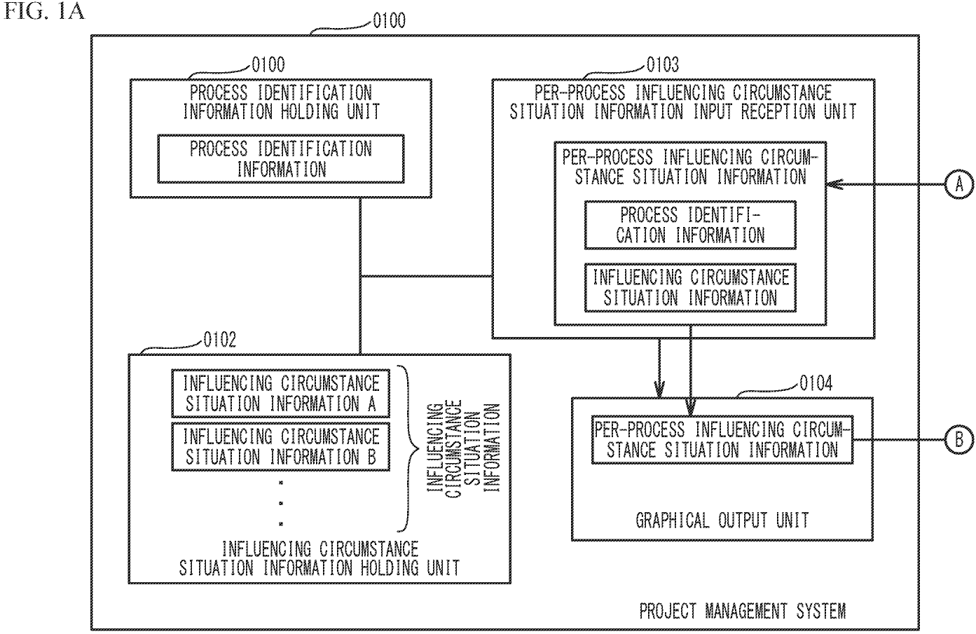

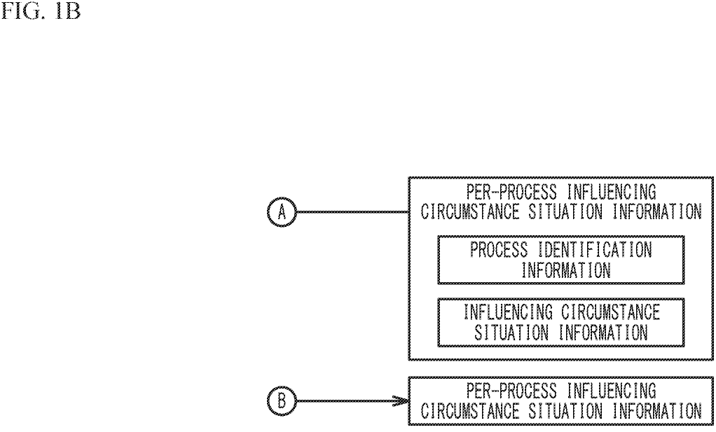

This embodiment provides a project management system including functions of holding process identification information that identifies a process of a project; holding a plurality of types of influencing circumstance situation information, each of which expresses an influencing circumstance which is a circumstance that influences the progress of the project recognized in the process of the project; receiving input of per-process influencing circumstance situation information which is information that associates the held influencing circumstance situation information with process identification information of a process in which an influencing circumstance indicated by the influencing circumstance situation information is recognized; and graphically outputting the per-process influencing circumstance situation information. That is, FIGS. 1A and 1B are diagrams illustrating a functional configuration of a project management system according to the first embodiment. The project management system (0100) of the present embodiment includes a process identification information holding unit (0101), an influencing circumstance situation information holding unit (0102), a per-process influencing circumstance situation information input reception unit (0103), and a graphical output unit A (0104).

Hereinafter, the functional configuration, the hardware configuration, and the process flow of the project management system according to the present embodiment will be described in order.

### First Embodiment; Explanation of Configuration; Process Identification Information Holding Unit

The “process identification information holding unit” has a function of holding process identification information for identifying the process of the project. As mentioned above, “process” can be defined in various ways by the project executor, and thus can refer to either the so-called phases of the project (the phases of the project. For example, “design phase, procurement phase, manufacturing phase, testing phase, and delivery phase” or “requirements definition phase, external design phase, implementation phase, integration testing phase, system testing phase, and system operation and maintenance phase”.) in its general framework, or to the elements (tasks and To-Dos that must be performed by each project execution member or each project execution team in each phase) that further subdivide each phase into medium or small categories viewed from its general framework. In either case, the effect of the present disclosure can be obtained by outputting a graph as explained in the present embodiment. The concept of this process identification information is defined by the project manager or the like and registered in this system (within the general common sense of project operation), and hence the process identification information is held as per-process identification information. The process identification information may be corrected later. The correction is deletion, change, or addition. Relationships with other processes that are not corrected with each work must be made so as not to cause inconsistencies, and the system can be configured to automatically acquire the inconsistencies by defining the attribute of each process. In other words, adjustments and inspections are performed so that the relationship between the production timing of the deliverables of each process and the work tools and processing target resources of the related processes does not cause a contradiction. This is realized by constructing a process database and configuring a process contradiction investigation unit to constantly monitor respective processes. Since the processes are organically and closely connected, it is preferable to configure the processes identified by the process identification information to be associated with mutual interference information that indicates the influence of the processes on each other. This mutual interference information is identified by mutual interference information identification information, and this mutual interference information identification information is preferably held in a mutual interference information identification information holding unit in association with the process identification information by which the interference is mutually given. The mutual interference information is defined as a function whose value (meaning) can be obtained by using the progress information, which is information about the progress of each process, as a variable. Such a function is called a mutual interference function, and it is preferred that the mutual interference function is held in a mutual interference function holding unit and that mutual interference information can be specifically obtained by a mutual interference information acquisition unit based on the mutual interference function and the progress information received in the process identified by the process identification information.

### First Embodiment; Explanation of Configuration; Influencing Circumstance Situation Information Holding Unit

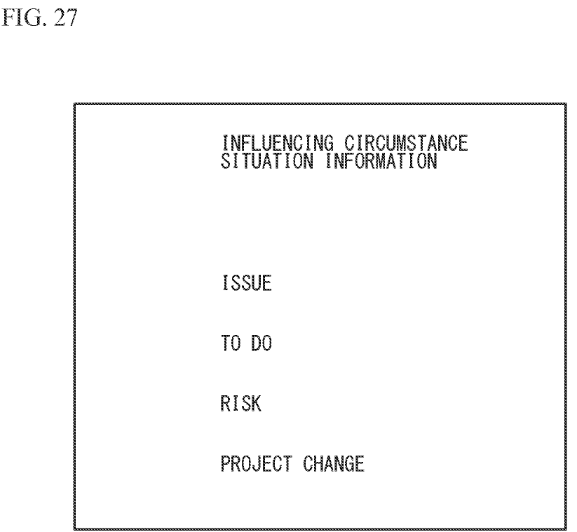

The “influencing circumstance situation information holding unit” has the function of holding a plurality of types of influence circumstance situation information, each of which expresses an influencing circumstance which is a circumstance that influences the progress of the project recognized in the process of the project. It is preferable that the type of the influencing circumstance includes information indicating an influence degree of the influencing circumstance on the completion of the project or process, and a possibility of appearance of the influencing circumstance on a negative side (the same applies hereinafter). An example of the influencing circumstance situation information is illustrated in FIG. 27. The influencing circumstance situation information includes an “issue” to be resolved in each project phase and the process, a “To Do” to be executed, a “risk” that may occur, and a “project change” related to the phase, the process, the issue and the To Do in the project that may occur in the future. The influencing circumstance situation information can further include “integration (combination) of multiple projects”, “division (cutting out) of project”, “developmental dissolution of project (composition of successor project)”, “restructuring of project (reconfiguration of project phases for selection and concentration)”, “exchange of phases between projects”, “external procurement of a part of project” and so on. The influencing circumstance situation information may be changed during the progress of the project. Initially, the influencing circumstance situation information is defined and registered by the project manager before the start of the project. Here, the change is deletion, correction, or addition as described above. The influencing circumstance situation information may be identification information for the influencing circumstance situation information that identifies the influencing circumstance situation information. In this application, the influencing circumstance situation information may be replaced by its identification information.

### First Embodiment; Explanation of Configuration; Per-Process Influencing Circumstance Situation Information Input Reception Unit

The “per-process influencing circumstance situation information input reception unit” receives input of per-process influencing circumstance situation information, which is information in which the held influencing circumstance situation information and process identification information of the process for which the influencing circumstance indicated by the influencing circumstance situation information is recognized are associated with each other. The feature of the present embodiment is that the system is configured so that anyone can input information in a homogeneous manner. A concept of an individual form is used to allow for homogeneous input of information. The concept of the individual form is that there is an introduction to clearly guide the subject and predicate, for example, when inputting the necessary information, and that homogeneity is ensured by inputting the information according to the introduction. For example, when inputting new influencing circumstance situation information, an introduction should be provided, such as “Please enter the type of the influencing circumstance” to clarify the type of the influencing circumstance, not to mention the identification of a person who inputs the information. Furthermore, it is preferable that this type of input is configured to be made via a pull-down menu. If the influencing circumstance situation information is attributed to a person, the system guides a user to identify who the person is, or if the circumstance is attributed to a resource and is identified from the previous stage’s input, the system introduces the resource to be identified. In this way, it is preferable to dynamically switch the type of input items to be displayed next according to the input information, which enables detailed information to be obtained. Specifically, the term “individual form” is an information input format prepared for each unit of identifying information, and is not a term to be interpreted as limited to a single sheet on the screen. The input to an inputter, a title, an ID, a deadline, an accomplishment content, a group name, a budget, a delivery destination, and other items is illustrated in the form of free-format input for each blank field, but it can be in a format that allows selection by pull-down menus, or it can be in an input format that looks like free format but actually only accepts registered character strings. It is preferable that the input information is held in association with the input time based on time information from a separately installed timekeeping unit, and that measures are taken to prevent tampering with the input information. The measures to prevent tampering include holding the input information in a non-rewritable form, or obtaining a hash value of the input information to associate it with a project ID and hold it in a secure area. When inputting a project, the system may be configured to acquire the face image of the inputter from a camera installed in the input terminal and check the authority of the inputter in an authority database linked to the face recognition data. In this case, the system may be configured to determine whether a value entered in the text as the inputter matches the inputter associated with the authority database. Alternatively, the system may be configured so that the inputter is automatically input based on the determination result in the authority database.

### First Embodiment; Explanation of Configuration; Graphical Output Unit

The “graphical output unit” has a function to graphically output the per-process influencing circumstance situation information. In the case of a two-dimensional graph the graphical output unit can adopt a horizontal axis which is a time axis (the axis may be timing, period, phase, etc., rather than time itself), and a vertical axis which is various factors such as the recognized number of pieces of influencing circumstance situation information, the influence degree (it may be an instantaneous influence degree or a future influence degree), the number of project members involved, or the amount of additional resources required (resources can include human and material resources). Any other information related to the project that is countable may be used as the vertical axis. Furthermore, the graphical output can be a pie chart or a matrix diagram without using the time axis as the horizontal axis, and any type of graphical output is possible. In addition to graphically outputting these changes over time from the past to the present, future prediction can be made using extrapolated lines and graphical output can be performed over the future. This future line can be output based on the inputter’s prediction information, or can be output based on the actual results of the project so far. For example, the results can be predicted based on the past project execution history of the person or manager in charge of the influencing circumstance situation information, or they can be output using various statistical methods (team results, not just the person in charge, results for combinations of supervisors and subordinates, average statistical processing results within the company implementing the project, results considering seasonal factors, statistical processing results by project type, etc.). By mixing this with deep learning methods, even more precise predictions can be made. This is because information on ongoing projects allows for precise revision of future predictions. The content of the “influence degree” output here can be itemized by phase, task, issue, team, or the entire project.

### Variation; Prediction Function

Furthermore, the project management system may include a prediction function. Specifically, the system may include functions to predict the situation at a future point in time (by phase, task, issue, team, or the entire project) and to input the influence degree information for its own team (e.g., predict the influence degree on other teams, other phases, or the entire project).

### Hardware Configuration

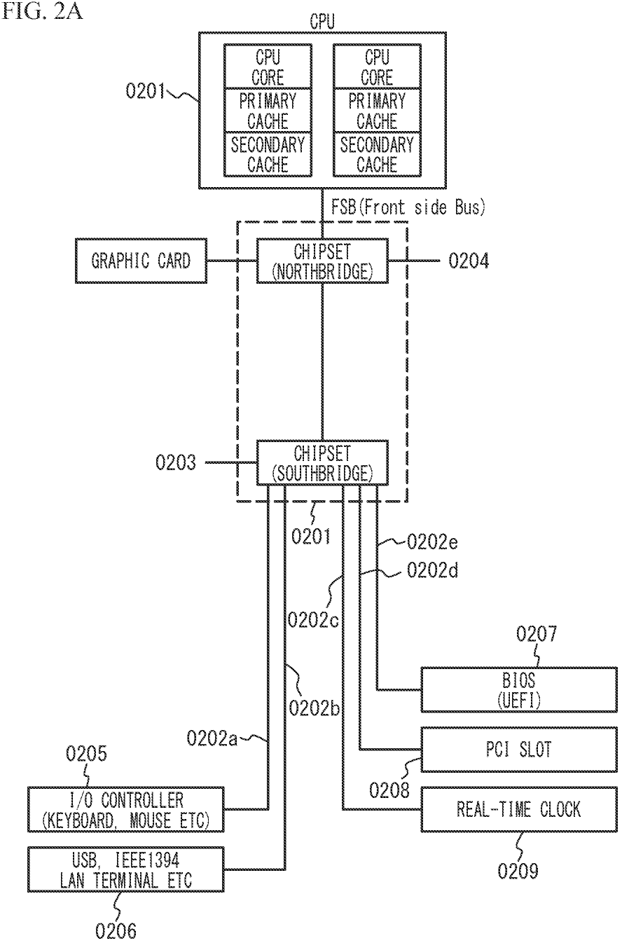

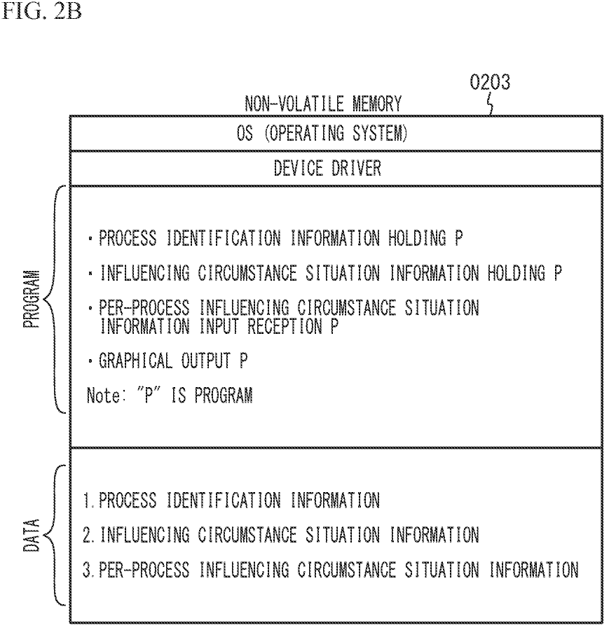

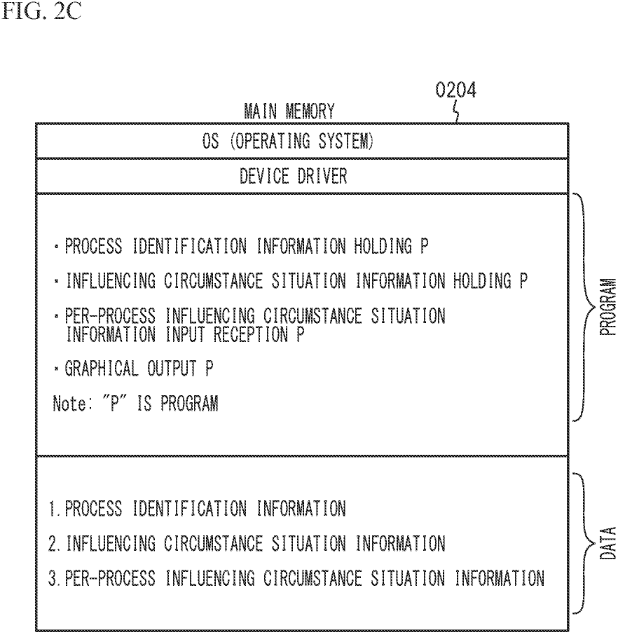

FIGS. 2A to 2C are diagrams illustrating a hardware configuration of the project management system according to the present embodiment. The hardware configuration of the project management system in the present embodiment will be described with reference to the figures.

As illustrated in FIGS. 2A to 2C, a computer includes a chipset (0210), a CPU (0201), a non-volatile memory (0203), a main memory (0204), various buses (0202a, 0202b, 0202c, 0202d, 0202e), a BIOS (0207), various interfaces (0205, 0206, 0208), a real-time clock (0209), and the like, which are configured on a motherboard. These work in conjunction with an operating system, device drivers, various programs, and so on. The various programs and various data constituting the present disclosure are configured to efficiently utilize these hardware resources to execute various processes.

### Chipset

A “chipset” is a set of large-scale integrated circuits (LSIs) that are mounted on the motherboard of the computer and integrate a communication function (that is, a bridge function) between an external bus of the CPU and a standard bus that connects the memory and the peripheral devices. There are cases where a two-chipset configuration is adopted and cases where a one-chipset configuration is adopted. A north bridge is provided on a position near the CPU and the main memory, and a south bridge is provided on a position near the interface with a relatively low-speed external I/O and far from the CPU and the main memory.

### North Bridge

The north bridge includes a CPU interface, a memory controller, and a graphic interface. The CPU may be responsible for most of the functions of the conventional north bridge. The north bridge is connected to a memory slot of the main memory via a memory bus, and is connected to a graphic card slot of a graphic card by a high-speed graphic bus (AGP, PCI Express).

### South Bridge

The South Bridge is connected to a PCI interface (PCI slot) via a PCI bus, and is responsible for I/O functions and sound functions with an ATA (SATA) interface, a USB interface, an Ethernet interface, and the like. Incorporating circuits that support a PS/2 port, a floppy disk drive, a serial port, a parallel port, and an ISA bus that do not require or cannot require high-speed operation will hinder the speeding up of the chipset itself. Therefore, they may be separated from the chip of the south bridge and assigned to another LSI called a super I/O chip. The buses are used to connect the CPU (MPU) to the peripheral devices and the various control units. The buses are connected to the chipset. A memory bus used for connection with the main memory may adopt a channel structure instead of the memory bus in order to increase the speed. As the bus, a serial bus or a parallel bus can be adopted. While the serial bus transfers data bit by bit, the parallel bus collects the original data itself or multiple bits cut out from the original data as a group and transmits them at the same time through multiple communication paths. A dedicated clock signal line is provided in parallel with the data line to synchronize data demodulation on the receiving side. It is also used as a bus that connects a CPU (chipset) and an external device, and includes GPIB, IDE/(parallel) ATA, SCSI, and PCI. Since there is a limit to the speedup, the data line may be the serial bus in the improved PCI Express of PCI or the improved serial ATA of parallel ATA.

### CPU

The CPU reads, interprets, and executes instruction sequences called programs in the main memory in order, and outputs information consisting of signals to the main memory. The CPU functions as a center portion for performing calculation within the computer. The CPU is composed of a CPU core part that mainly preform the calculation and a peripheral part thereof. A register, a cache memory, an internal bus connecting the cache memory and the CPU core, a DMA controller, a timer, an interface with the connection bus with the north bridge, and the like are included inside the CPU. A plurality of CPU cores may be provided in one CPU (chip). Further, in addition to the CPU, a process may be performed by a graphic interface (GPU) or an FPU.

### Non-Volatile Memory (HDD)

The basic structure of a hard disk drive as the non-volatile memory consists of a magnetic disk, a magnetic head, and an arm on which the magnetic head is mounted. An external interface can adopt SATA (ATA in the past). A high-performance controller supports communication between hard disk drives, using SCSI, for example. For example, when copying a file to another hard disk drive, the controller can read the sector and transfer and write it to another hard disk drive. At this time, the memory of the host CPU is not accessed. Therefore, it is not necessary to increase the load on the CPU.

### Main Memory

The CPU directly accesses the main memory and executes various programs on the main memory. The main memory is a volatile memory, and DRAM is used. The program on the main memory is developed from the non-volatile memory onto the main memory in response to a start command of the program. After that, the CPU executes the program according to various execution instructions and execution procedures in the program.

### Operating System

The operating system is used to manage the resources on the computer for the application to use, to manage various device drivers, and to manage the computer itself which is the hardware. Small computers may use a firmware as the operating system.

### BIOS

The BIOS causes the CPU to perform procedures for booting the computer hardware and running the operating system, and is most typically the hardware that the CPU first reads when it receives a boot command of the computer. An address of the operating system stored in the disk (non-volatile memory) is described in the BIOS, the operating system is sequentially developed to the main memory by the BIOS developed in the CPU, and the computer puts into an operating state. The BIOS also has a check function for checking the presence or absence of various devices connected to the bus. The result of the check is saved in the main memory and made available by the operating system as appropriate. The BIOS may be configured to check the external device or the like.

The above configuration is the same for other embodiments.

As illustrated in FIGS. 2A to 2C, the present system can basically be configured by a general-purpose computer program and various devices. In the operation of the computer, the program recorded in the non-volatile memory is basically loaded into the main memory, and the main memory, the CPU, and various devices execute the process. The communication with the device is done via the interface connected to the bus line. The interface may be a display interface, a keyboard, a communication buffer, or the like.

As illustrated in FIGS. 2A to 2C, the non-volatile memory includes a “process identification information holding program” that holds the process identification information identifying the process of the project, an “influencing circumstance situation information holding program” that holds a plurality of types of influencing circumstance situation information, each of which expresses an influencing circumstance which is a circumstance that influences the progress of the project recognized in the process of the project, a “per-process influencing circumstance situation information input reception program” that receives input of per-process influencing circumstance situation information that is information in which the held influencing circumstance situation information is associated with the process identification information of the process in which the influencing circumstance indicated in the influencing circumstance situation information is recognized, and a “graphical output program” that graphically outputs the per-process influencing circumstance situation information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Process Flow

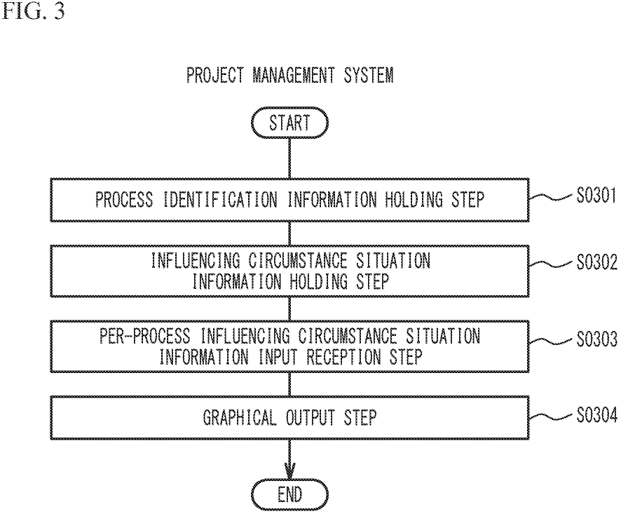

As illustrated in FIG. 3, the process flow of this embodiment is an operation method of the project management system which is a computer having a process identification information holding step, an influencing circumstance situation information holding step, a per-process influencing circumstance situation information input reception step, and a graphical output step. Hereinafter, each step will be described below.

The “process identification information holding step” holds the process identification information identifying the process of the project.

The “influencing circumstance situation information holding step” holds a plurality of types of influencing circumstance situation information, each of which expresses an influencing circumstance which is a circumstance that influences the progress of the project recognized in the process of the project.

The “per-process influencing circumstance situation information input reception step” receives input of per-process influencing circumstance situation information that is information in which the held influencing circumstance situation information is associated with the process identification information of the process in which the influencing circumstance indicated in the influencing circumstance situation information is recognized.

The “graphical output step” that graphically outputs the received per-process influencing circumstance situation information.

### Second Embodiment

### Second Embodiment; Summary; Mainly Relating to Claims 32, 41 and 50

In addition to the first embodiment described above, the second embodiment provides a project management system in which the graphical output unit has a function to graphically output the per-process influencing circumstance situation information with a matrix of the process and the influencing circumstance. This embodiment is based on the first embodiment.

### Second Embodiment; Functional Configuration

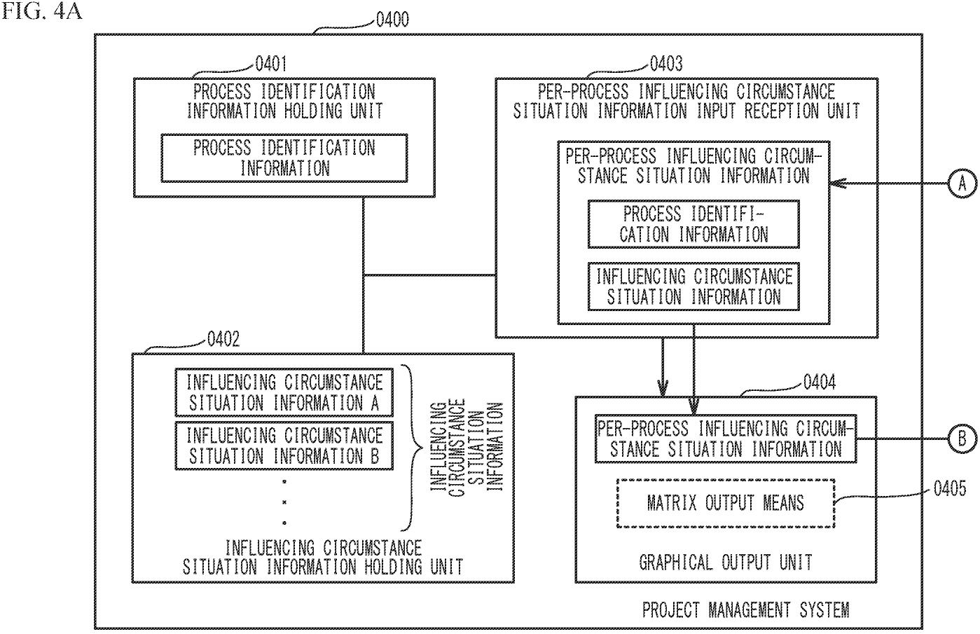

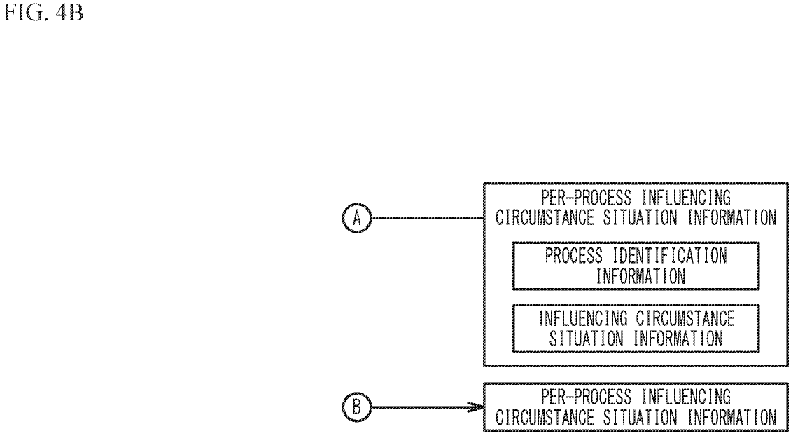

FIGS. 4A and 4B are diagrams illustrating a functional configuration of the present embodiment. The project management system (0400) of the present embodiment has a process identification information holding unit (0401), an influencing circumstance situation information holding unit (0402), a per-process influencing circumstance situation information input reception unit (0403), and a graphical output unit A (0404) as in the first embodiment. Further, the graphical output unit A (0404) is characterized by having a matrix output means (0405). Since the functions excluding the matrix output means have already been described in the first embodiment, only the matrix output means will be described below.

### Second Embodiment; Explanation of Configuration; Matrix Output Means

The “matrix output means” has a function of graphically outputting per-process influencing circumstance situation information with the matrix of the process and the influencing circumstance. The most typical example is the case where the influencing circumstance can be passed through a horizontal skewer for each process. That is, when there is a common influencing circumstance for each process, it is possible to grasp it at a glance by the matrix output means. For example, the matrix can be configured to display a ratio of issues resolved for each process, a ratio of To-Dos completed, and the number of risks incurred. This makes it possible to grasp which process is in a dangerous state for achieving the goal, or which process is progressing smoothly and has a margin. Therefore, it is possible to proceed with the project efficiently, for example, by flexibly allocating resources among processes based on this matrix. Note that such an allocation is possible only when the matrix is generated for simultaneous progress processes. On the other hand, with regard to future processes, it is possible to generate and output a matrix of future prediction in the same way between processes that are considered to be simultaneously progressing in the future. The future processes are also affected by processes that are currently in progress or processes that have already been completed, so the influencing circumstance may change from moment to moment. In such a case, it is conceivable to display the matrix using skewered elements for processes scheduled to proceed simultaneously in the future.

### Second Embodiment; Hardware Configuration

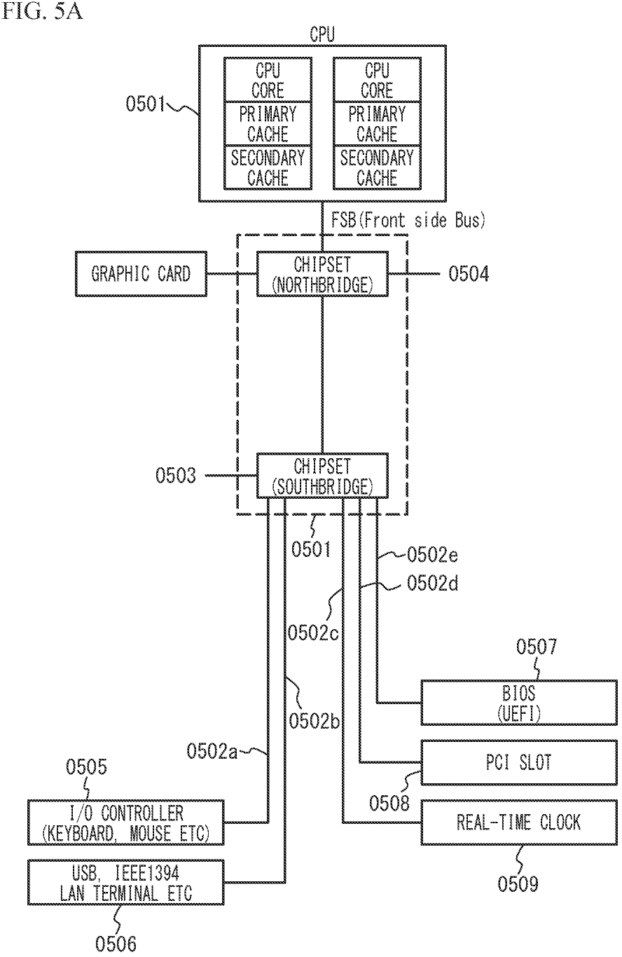

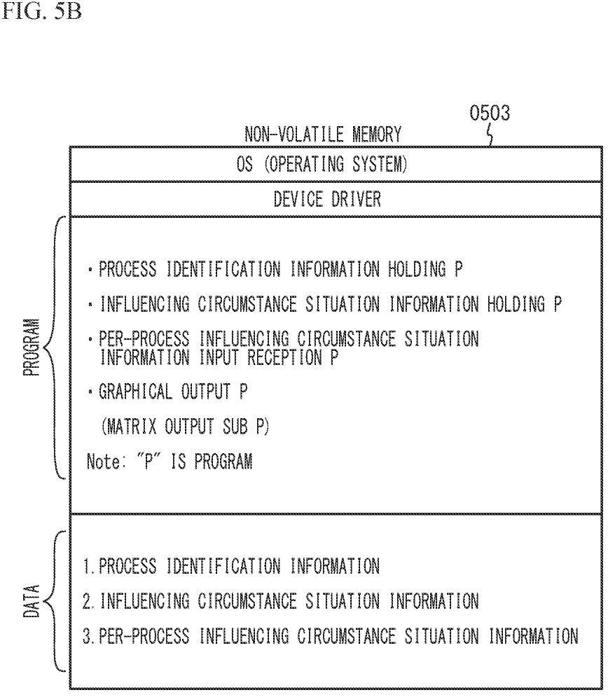

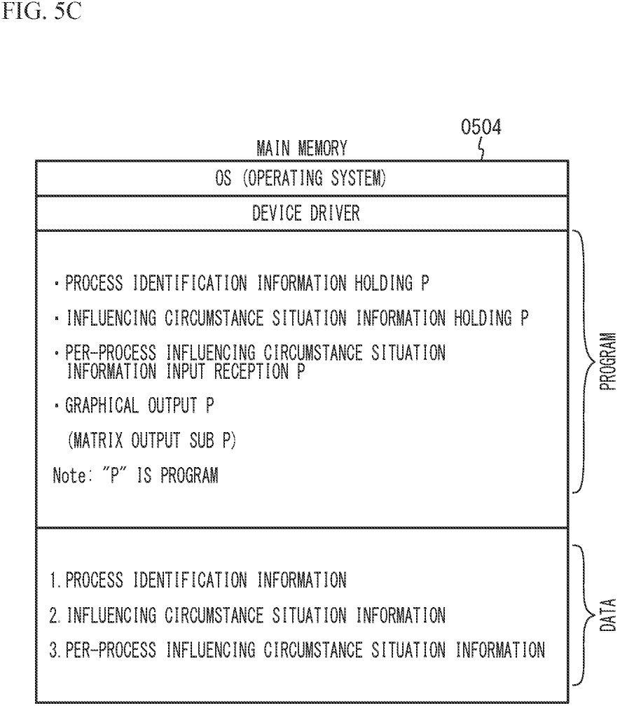

FIGS. 5A to 5C are diagrams illustrating a hardware configuration of the project management system according to the present embodiment. As illustrated in FIGS. 5A to 5C, the computer includes a chipset (0510), a CPU (0501), a non-volatile memory (0503), a main memory (0504), various buses (0502a, 0502b, 0502c, 0502d, 0502e), a BIOS (0507), various interfaces (0505, 0506, 0508), a real-time clock (0209), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 5A to 5C, the non-volatile memory includes the “process identification information holding program” that holds the process identification information identifying the process of the project, the “influencing circumstance situation information holding program” that holds a plurality of types of influencing circumstance situation information, each of which expresses an influencing circumstance which is a circumstance that influences the progress of the project recognized in the process of the project, the “per-process influencing circumstance situation information input reception program” that receives input of per-process influencing circumstance situation information that is information in which the held influencing circumstance situation information is associated with the process identification information of the process in which the influencing circumstance indicated in the influencing circumstance situation information is recognized, and the “graphical output program” that graphically outputs the per-process influencing circumstance situation information. The “graphical output program” includes a matrix output subprogram that graphically outputs the per-process influencing circumstance situation information with the matrix of the process and the influencing circumstance. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Second Embodiment; Process Flow

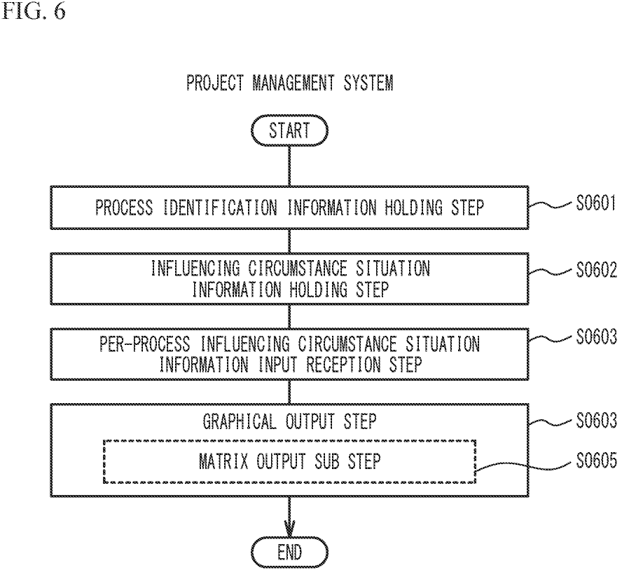

FIG. 6 is a flowchart illustrating the process when the project management system according to the present embodiment is used. The process flow of this embodiment is an operation method of the project management system which is a computer having a process identification information holding step (S0601), an influencing circumstance situation information holding step (S0602), a per-process influencing circumstance situation information input reception step (S0603), a graphical output step (S0604), and a matrix output substep (S0605). Each of these steps, except the matrix output substep, is the same as that in the first embodiment. Hereinafter, the matrix output substep will be described below.

The “the matrix output substep” graphically outputs the per-process influencing circumstance situation information with the matrix of the process and the influencing circumstance.

### Third Embodiment

### Third Embodiment; Summary; Mainly Relating to Claims 33, 42 and 51

In addition to the first embodiment described above, the third embodiment provides a project management system that has the functions of acquiring time information, further acquiring per-time process influencing situation circumstance information which is information that associates the acquired time information with the per-process influencing situation circumstance information, and indicating a change in the influencing situation on the time axis. This embodiment is based on the first embodiment or the second embodiment.

### Third Embodiment; Functional Configuration

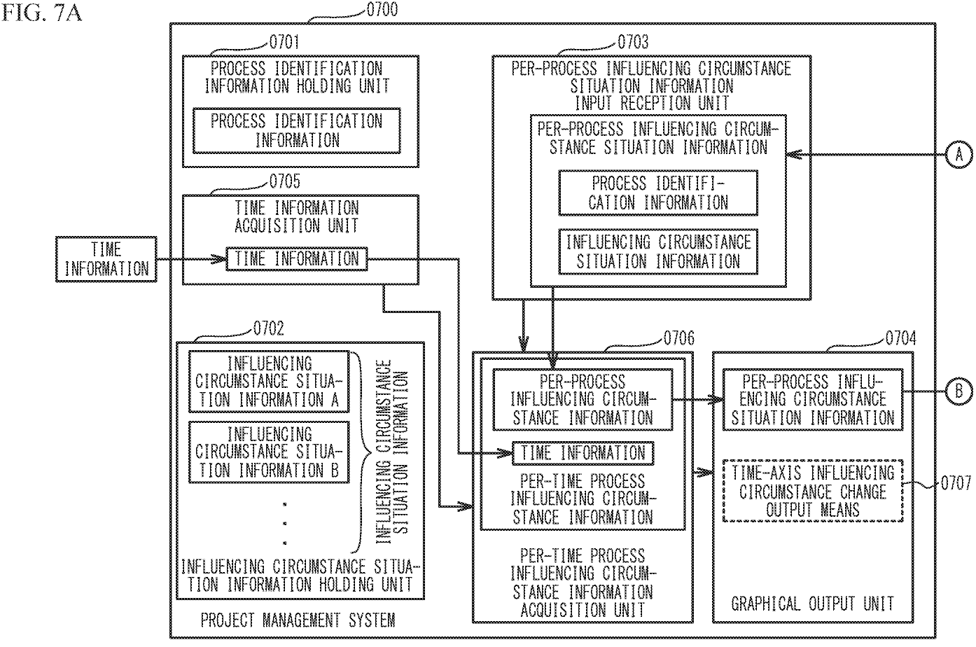

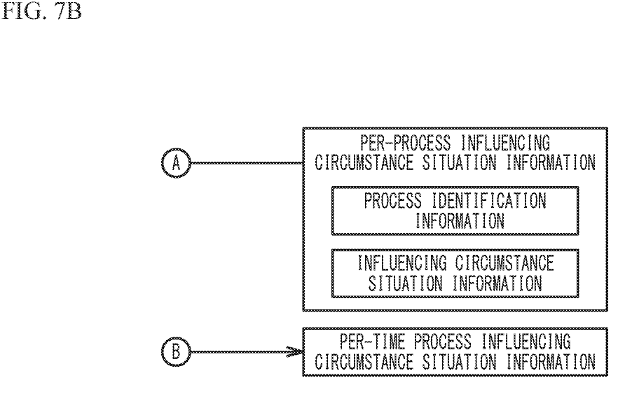

FIGS. 7A and 7B are diagrams illustrating a functional configuration of the present embodiment. The project management system (0700) of the present embodiment has a process identification information holding unit (0701), an influencing circumstance situation information holding unit (0702), a per-process influencing circumstance situation information input reception unit (0703), and a graphical output unit A (0704) as in the first embodiment. Further, the project management system (0700) is characterized by having a time information acquisition unit (0705), a per-time process influencing situation circumstance information acquisition unit (0706), and the graphical output unit A (0704) having a time-axis influencing circumstance change output means (0707). Since the functions excluding the time information acquisition unit, the per-time process influencing situation circumstance information acquisition unit, and the time-axis influencing circumstance change output means have already been described in the first embodiment, only the time information acquisition unit, the per-time process influencing situation circumstance information acquisition unit, and the time-axis influencing circumstance change output means will be described below.

### Third Embodiment; Explanation of Configuration; Time Information Acquisition Unit

The “time information acquisition unit” has a function of acquiring time information. The acquisition of the time information may be configured to be acquired from the timekeeping unit in this system, or may be configured to be acquired from the outside via the Internet. Further, when the time information is acquired from the timekeeping unit in the system, the time may be calibrated at a predetermined interval from an external time calibration device via the Internet. The time information to be acquired may be a date, a time, or a date and time. In the case of the time, a minimum unit may be any hour, minute, or second.

### Third Embodiment; Explanation of Configuration; Per-Time Process Influencing Situation Circumstance Information Acquisition Unit

The “per-time process influencing situation circumstance information acquisition unit” has a function of acquiring the per-time process influencing situation circumstance information which is information that associates the acquired time information with the per-process influencing situation circumstance information.

### Third Embodiment; Explanation of Configuration; Time-Axis Influencing Circumstance Change Output Means

The “time-axis influencing circumstance change output means” has a function of indicating the change in the influencing situation on the time axis.

### Third Embodiment; Hardware Configuration

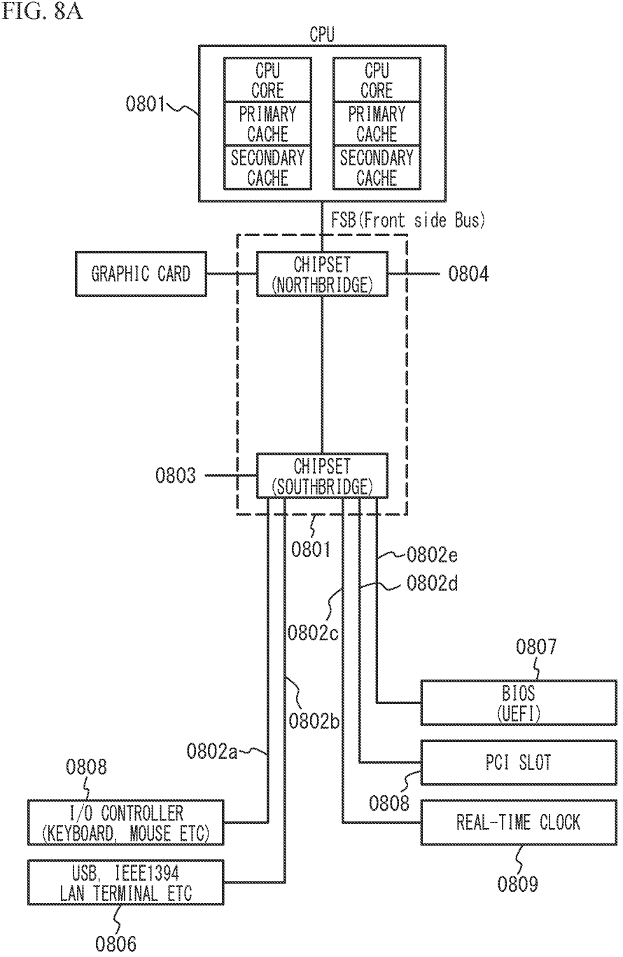

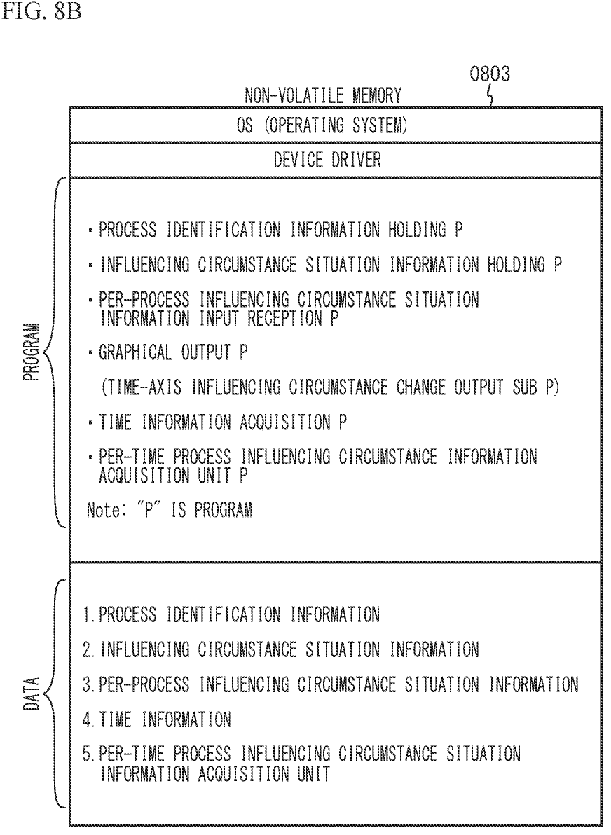

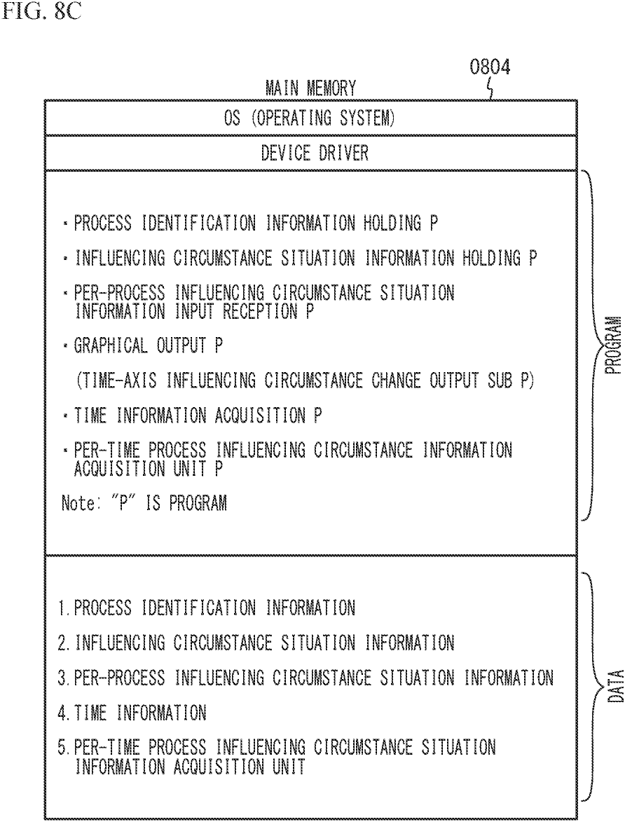

FIGS. 8A to 8C are diagrams illustrating a hardware configuration of the project management system according to the present embodiment. As illustrated in FIGS. 8A to 8C, the computer includes a chipset (0810), a CPU (0801), a non-volatile memory (0803), a main memory (0804), various buses (0802a, 0802b, 0802c, 0802d, 0802e), a BIOS (0807), various interfaces (0805, 0806, 0808), a real-time clock (0809), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 8A to 8C, the non-volatile memory includes the “process identification information holding program” that holds the process identification information identifying the process of the project, the “influencing circumstance situation information holding program” that holds a plurality of types of influencing circumstance situation information, each of which expresses the influencing circumstance which is a circumstance that influences the progress of the project recognized in the process of the project, the “per-process influencing circumstance situation information input reception program” that receives input of per-process influencing circumstance situation information that is information in which the held influencing circumstance situation information is associated with the process identification information of the process in which the influencing circumstance indicated in the influencing circumstance situation information is recognized, the “graphical output program” that graphically outputs the per-process influencing circumstance situation information, a “time information acquisition program” that acquires the time information, and a “per-time process influencing situation circumstance information acquisition program” that acquires the per-time process influencing situation circumstance information which is information that associates the acquired time information with the per-process influencing situation circumstance information. The “graphical output program” includes a “time-axis influencing circumstance change output subprogram” that indicates the change in the influencing situation on the time axis. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Third Embodiment; Process Flow

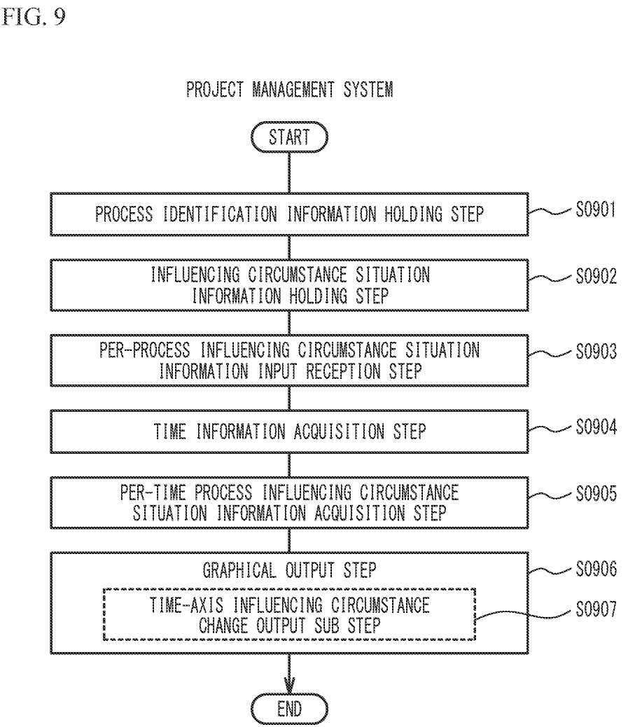

FIG. 9 is a flowchart illustrating the process when the project management system according to the present embodiment is used. The process flow of this embodiment is an operation method of the project management system which is a computer having a process identification information holding step (S0901), an influencing circumstance situation information holding step (S0902), a per-process influencing circumstance situation information input reception step (S0903), a graphical output step (S0904), and a time information acquisition step (S0905), a per-time process influencing situation circumstance information acquisition step (S0906), and a time-axis influencing circumstance change output substep (S0907). Each of these steps, except the time information acquisition step, the per-time process influencing situation circumstance information acquisition step, and the time-axis influencing circumstance change output substep, is the same as that in the first embodiment. Hereinafter, the time information acquisition step, the per-time process influencing situation circumstance information acquisition step, and the time-axis influencing circumstance change output substep will be described below.

The “time information acquisition step” acquires the time information.

The “per-time process influencing situation circumstance information acquisition step” acquires the per-time process influencing situation circumstance information which is information that associates the acquired time information with the per-process influencing situation circumstance information.

The “time-axis influencing circumstance change output substep” indicates the change in the influencing situation on the time axis in the graphical output step.

### Fourth Embodiment

### Fourth Embodiment; Summary; Mainly Relating to Claims 36, 45 and 54

In addition to the first embodiment described above, the fourth embodiment provides a project management system in which the influencing circumstance situation information holding unit has a function of holding issue information, which is information indicating an issue which hinders the complete execution of a process recognized in the process, as the influencing circumstance. This embodiment is based on any one of the first to third embodiments.

### Fourth Embodiment; Functional Configuration

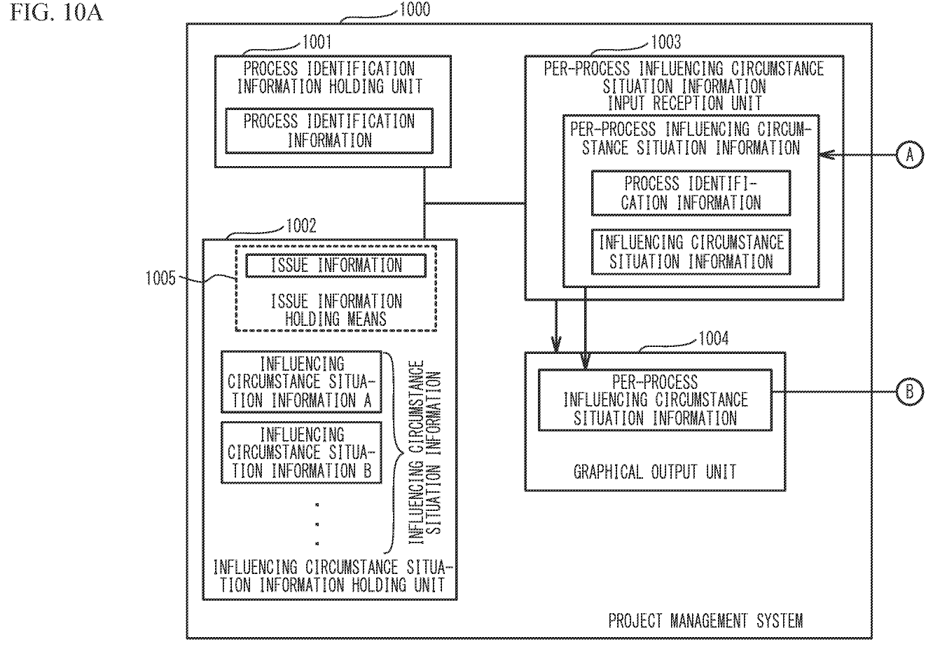

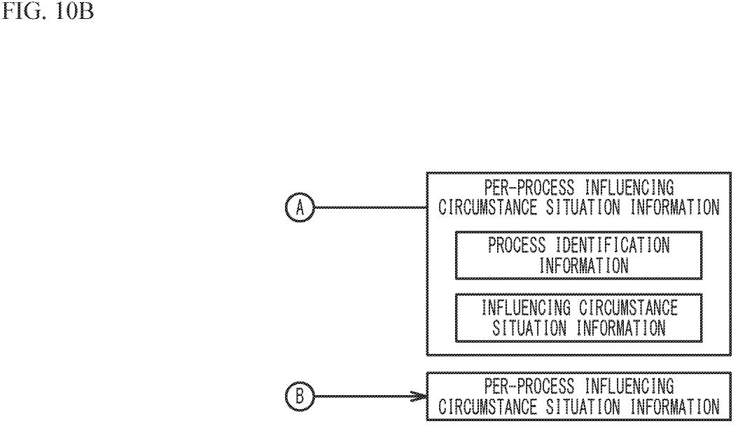

FIGS. 10A and 10B are diagrams illustrating a functional configuration of the present embodiment. The project management system (1000) of the present embodiment has a process identification information holding unit (1001), an influencing circumstance situation information holding unit (1002), a per-process influencing circumstance situation information input reception unit (1003), and a graphical output unit (1004) as in the first embodiment. Further, the influencing circumstance situation information holding unit is characterized by having an issue information holding means (1005) that holds issue information, which is information indicating an issue which hinders the complete execution of a process recognized in the process, as the influencing circumstance. Since the functions excluding the issue information holding means have already been described in the first embodiment, only the issue information holding means will be described below.

### Fourth Embodiment; Explanation of Configuration; Issue Information Holding Means

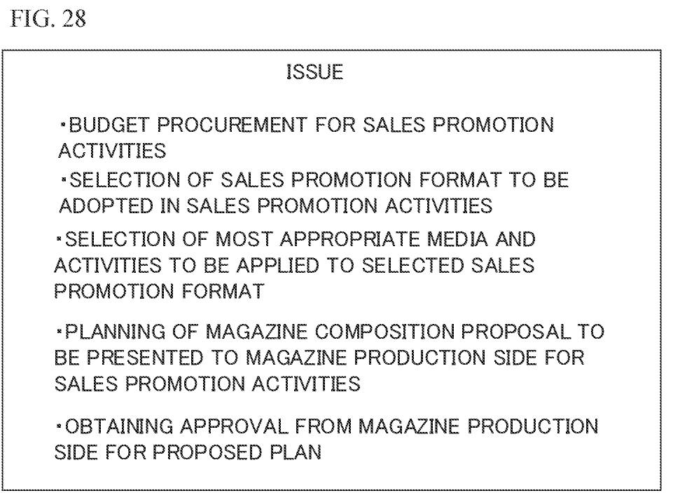

The “issue information holding means” has a function of holding issue information, which is information indicating an issue which hinders the complete execution of a process recognized in the process, as the influencing circumstance. FIG. 28 is a diagram illustrating an example of information related to “issue” in the influencing circumstance situation information. The information related to “issue” is elements that are considered to have to be resolved in order to achieve a purpose of the project. Conversely, the purpose of the project is automatically achieved by resolving all expected issues. Issues may be set for each phase or for the entire project, independent of the phase. The issues should thus be set by those who can grasp the project from a higher conceptual level, and this system should be designed so that issues are allowed to be set by those whose prescribed qualifications are authenticated by the input ID. It is also possible to design the system so that issues are preassociated with predetermined categories in the system and project attributes are set before the issue is entered to prompt the user to enter the required issue category. For example, if the project attribute is magazine sales promotion, the categories of issues include: budget procurement for sales promotion activities, selection of the sales promotion format to be adopted in sales promotion activities, selection of the most appropriate media and activities to be applied to the selected sales promotion format, planning of a magazine composition proposal to be presented to the magazine production side for sales promotion activities, and obtaining approval from the magazine production side for the proposed plan, and so on. Alternatively, if the project is to develop a new model car, the issues can include “increase the battery capacity to a specified level”, “increase the driving distance per charge to 600 km or more”, “reduce the full charge time to 15 minutes or less”, “enable automatic driving not only on expressways but also on ordinary roads”, “reduce the interior noise level to a specified level”, “increase the number of passengers to five or more”, and so forth. The issues may have a hierarchical structure. If a higher-level issue is “to increase the capacity of the battery above a predetermined capacity”, a lower-level issue may be “to make the optimal selection of electrodes for the all-solid-state battery” or “to select an appropriate electrolyte”. Alternatively, the project may be designed so that the theme of “increase the capacity of the battery above a predetermined capacity” is a task (To Do) rather than an issue, and the issue is to “make the optimal selection of electrodes for the all-solid-state battery” or “select an appropriate electrolyte”. It is preferable to design the system so that categories of issues can be prepared and the input person can input information in a fail-safe manner even if the input person does not notice. It is preferable to configure the input to be input using the aforementioned individual forms of a predetermined format.

### Fourth Embodiment; Hardware Configuration

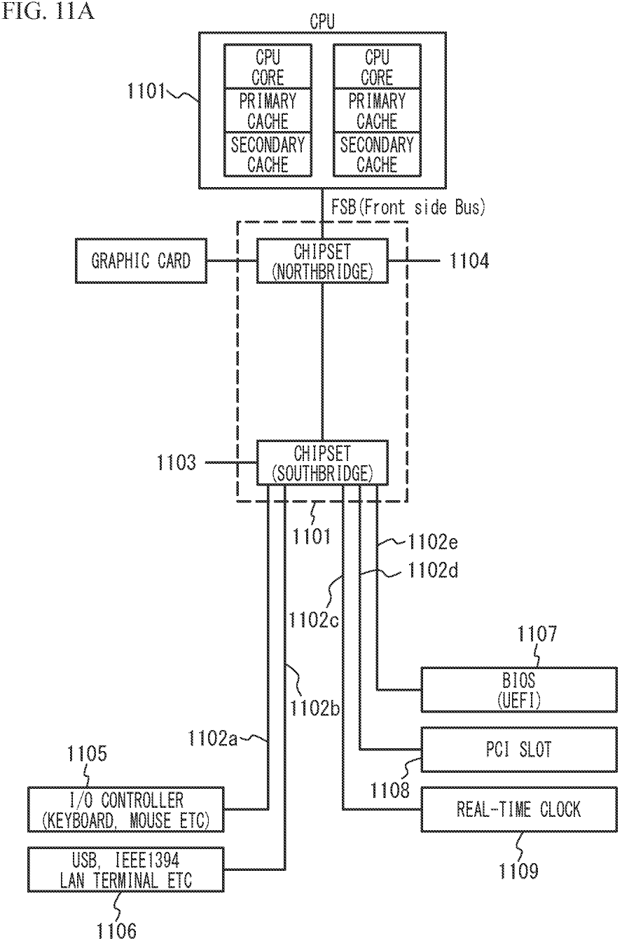

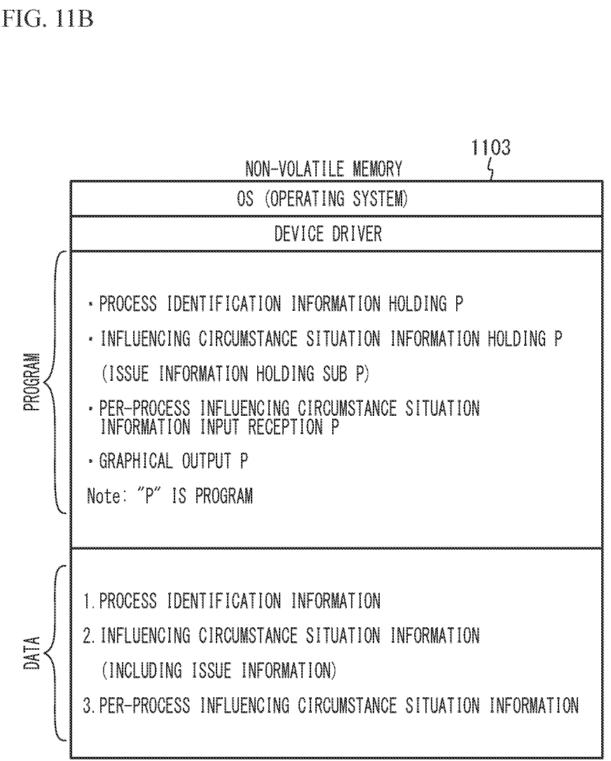

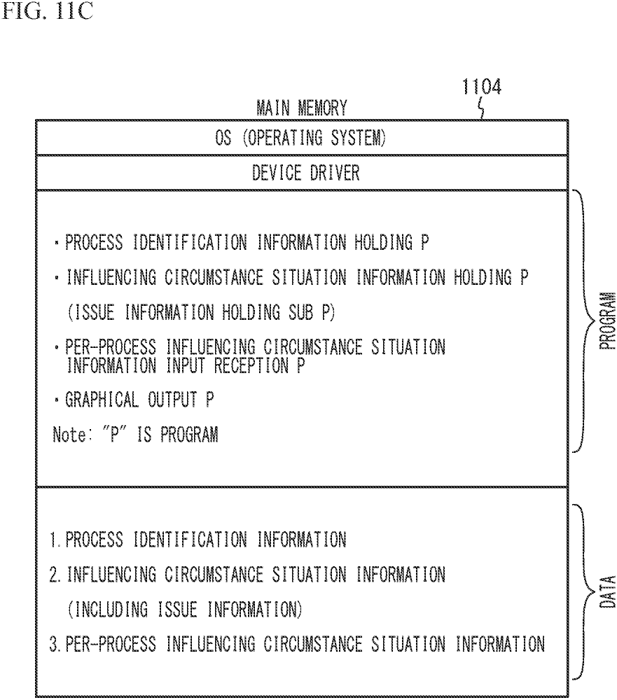

FIGS. 11A to 11C are diagrams illustrating a hardware configuration of the project management system according to the present embodiment. As illustrated in FIGS. 11A to 11C, the computer includes a chipset (1110), a CPU (1101), anon-volatile memory (1103), a main memory (1104), various buses (1102a, 1102b, 1102c, 1102d, 1102e), a BIOS (1107), various interfaces (1105, 1106, 1108), a real-time clock (1109), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 11A to 11C, the non-volatile memory includes the “process identification information holding program” that holds the process identification information identifying the process of the project, the “influencing circumstance situation information holding program” that holds a plurality of types of influencing circumstance situation information, each of which expresses the influencing circumstance which is a circumstance that influences the progress of the project recognized in the process of the project, the “per-process influencing circumstance situation information input reception program” that receives input of per-process influencing circumstance situation information that is information in which the held influencing circumstance situation information is associated with the process identification information of the process in which the influencing circumstance indicated in the influencing circumstance situation information is recognized, the “graphical output program” that graphically outputs the per-process influencing circumstance situation information. The “influencing circumstance situation information holding program” includes an issue information holding subprogram that holds issue information, which is information indicating an issue which hinders the complete execution of a process recognized in the process, as the influencing circumstance. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Fourth Embodiment; Process Flow

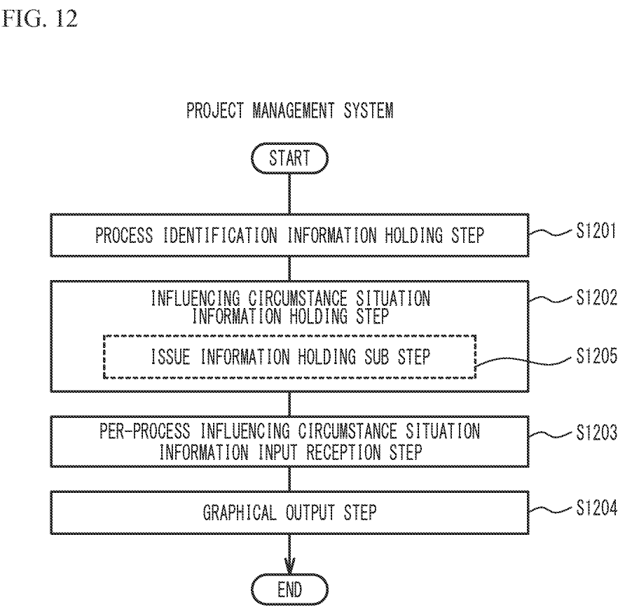

FIG. 12 is a flowchart illustrating the process when the project management system according to the preset embodiment is used. The process flow of this embodiment is an operation method of the project management system which is a computer having a process identification information holding step (S1201), an influencing circumstance situation information holding step (S1202), a per-process influencing circumstance situation information input reception step (S1203), a graphical output step (S1204), and an influencing circumstance holding substep (S1205). Each of these steps, except the influencing circumstance holding substep, is the same as that in the first embodiment. Hereinafter, the influencing circumstance holding substep will be described below.

The influencing circumstance holding substep holds the issue information, which is information indicating an issue which hinders the complete execution of a process recognized in the process, as the influencing circumstance.

### Fifth Embodiment

### Fifth Embodiment; Summary; Mainly Relating to Claims 37, 46 and 55

In addition to the first embodiment described above, the fifth embodiment provides a project management system in which the influencing circumstance situation information holding unit has a function of holding essential work information, which is information indicating a work that must be processed indispensably for the complete execution of a process recognized in the process, as the influencing circumstance. This embodiment is based on any one of the first to fourth embodiments.

### Fifth Embodiment; Functional Configuration

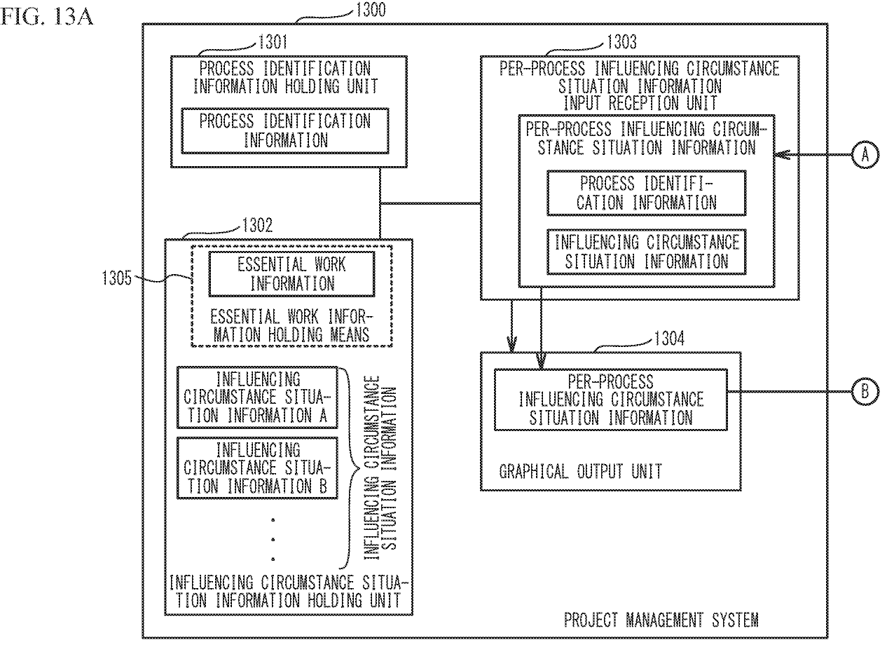

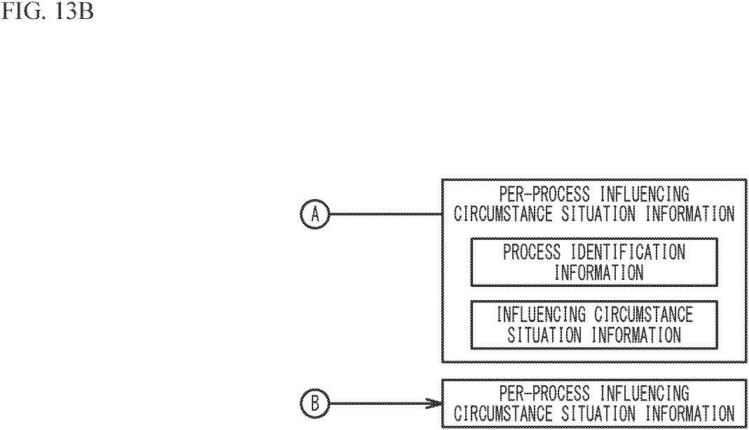

FIGS. 13A and 13B are diagrams illustrating a functional configuration of the present embodiment. The project management system (1300) of the present embodiment has a process identification information holding unit (1301), an influencing circumstance situation information holding unit (1302), a per-process influencing circumstance situation information input reception unit (1303), and a graphical output unit (1304) as in the first embodiment. Further, the influencing circumstance situation information holding unit is characterized by having an essential work information holding means (1305) that holds essential work information, which is information indicating a work that must be processed indispensably for the complete execution of a process recognized in the process, as the influencing circumstance. Since the functions excluding the essential work information holding means have already been described in the first embodiment, only the essential work information holding means will be described below.

### Fifth Embodiment; Explanation of Configuration; Essential Work Information Holding Means

The “essential work information holding means” has a function of holding essential work information, which is information indicating a work that must be processed indispensably for the complete execution of a process recognized in the process, as the influencing circumstance. This “essential work information” is mainly registered at a design stage of the project, and is registered by the agreement of the parties involved in the project. The essential work information may be registered in each phase (process) unit of the project, or it may be registered in a sub-process of the process. In addition, since the essential work is newly generated in response to the new occurrence of the issue or the change of the project, the essential work information is preferably configured to be newly registered while the project is in progress. It is preferable to configure the system so that all the information registered as the influencing circumstance situation information is generated, input, modified, and approved.

### Fifth Embodiment; Hardware Configuration

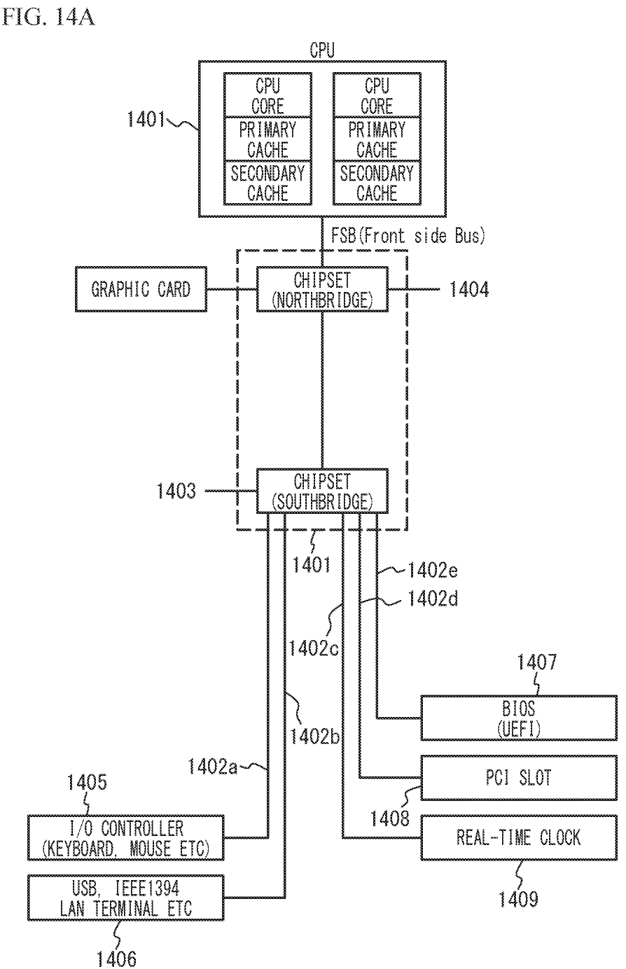

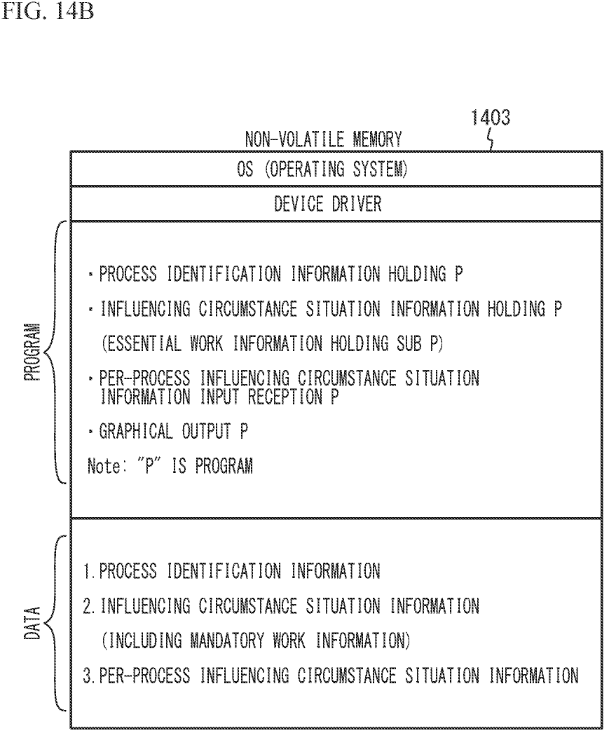

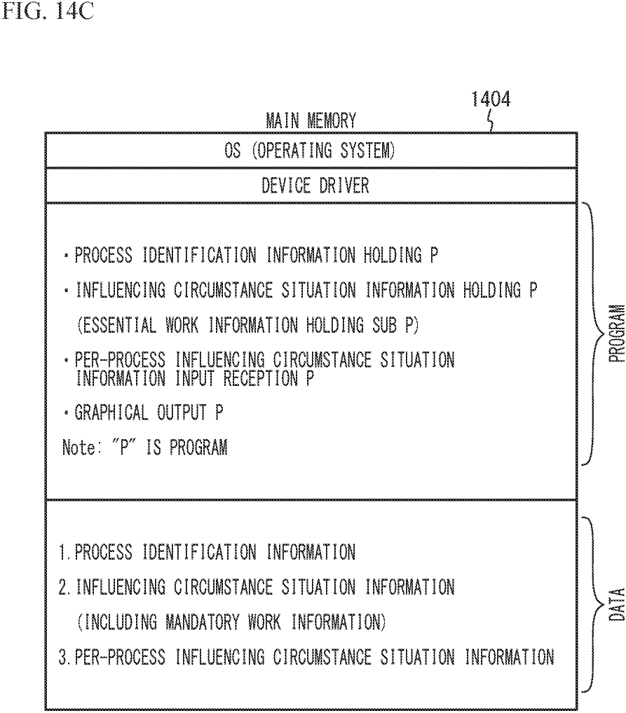

FIGS. 14A to 14C are diagrams illustrating a hardware configuration of the project management system according to the present embodiment. As illustrated in FIGS. 14A to 14C, the computer includes a chipset (1410), a CPU (1401), a non-volatile memory (1403), a main memory (1404), various buses (1402a, 1402b, 1402c, 1402d, 1402e), a BIOS (1407), various interfaces (1405, 1406, 1408), a real-time clock (1409), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 14A to 14C, the non-volatile memory includes the “process identification information holding program” that holds the process identification information identifying the process of the project, the “influencing circumstance situation information holding program” that holds a plurality of types of influencing circumstance situation information, each of which expresses the influencing circumstance which is a circumstance that influences the progress of the project recognized in the process of the project, the “per-process influencing circumstance situation information input reception program” that receives input of per-process influencing circumstance situation information that is information in which the held influencing circumstance situation information is associated with the process identification information of the process in which the influencing circumstance indicated in the influencing circumstance situation information is recognized, the “graphical output program” that graphically outputs the per-process influencing circumstance situation information. The “influencing circumstance situation information holding program” includes an “essential work information holding subprogram” that holds essential work information, which is information indicating a work that must be processed indispensably for the complete execution of a process recognized in the process, as the influencing circumstance. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Fifth Embodiment; Process Flow

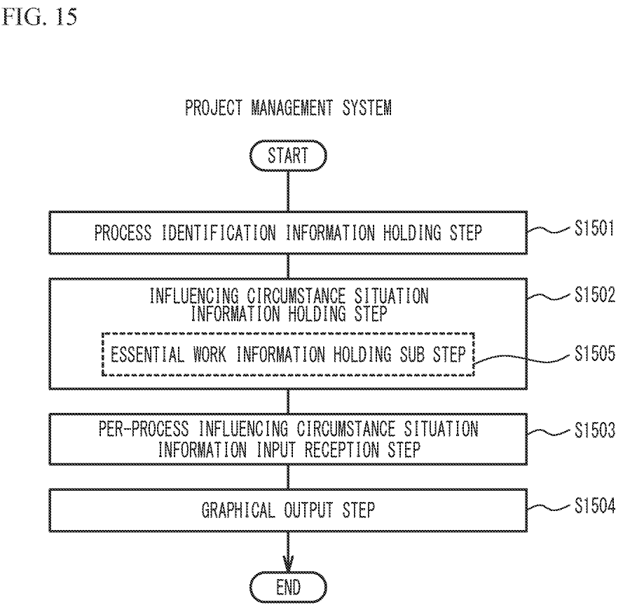

FIG. 15 is a flowchart illustrating the process when the project management system according to the present embodiment is used. The process flow of this embodiment is an operation method of the project management system which is a computer having a process identification information holding step (S1501), an influencing circumstance situation information holding step (S1502), a per-process influencing circumstance situation information input reception step (S1503), a graphical output step (S1504), and an essential work information holding substep (S1505). Each of these steps, except the essential work information holding substep, is the same as that in the first embodiment. Hereinafter, the essential work information holding substep will be described below.

The “essential work information holding substep” holds essential work information, which is information indicating a work that must be processed indispensably for the complete execution of a process recognized in the process, as the influencing circumstance.

### Sixth Embodiment

### Sixth Embodiment; Summary; Mainly Relating to Claims 38, 47 and 56

In addition to the first embodiment described above, the sixth embodiment provides a project management system in which the influencing circumstance situation information holding unit has a function of holding change request information, which is information indicating a matter that is required to be changed for the complete execution of a process recognized in the process, as the influencing circumstance. This embodiment is based on any one of the first to fifth embodiments.

### Sixth Embodiment; Functional Configuration

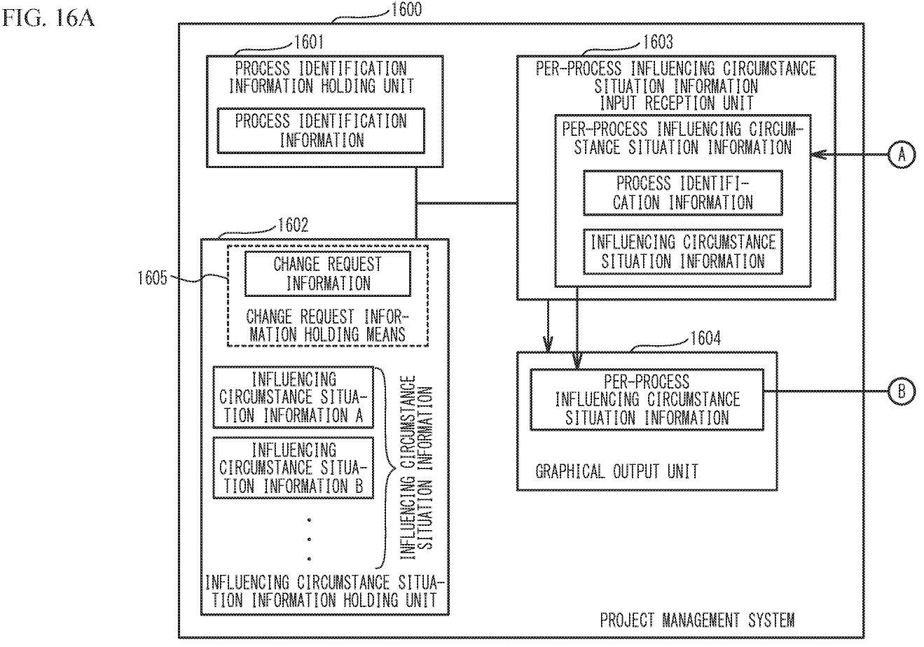

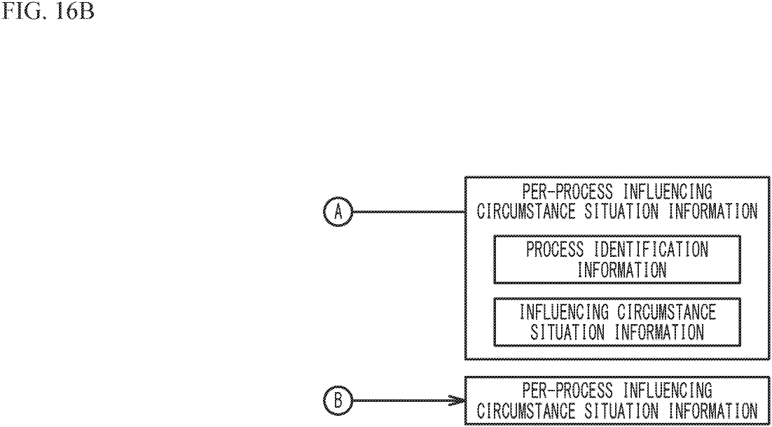

FIGS. 16A and 16B are diagrams illustrating a functional configuration of the present embodiment. The project management system (1600) of the present embodiment has a process identification information holding unit (1601), an influencing circumstance situation information holding unit (1602), a per-process influencing circumstance situation information input reception unit (1603), and a graphical output unit (1604) as in the first embodiment. Further, the influencing circumstance situation information holding unit is characterized by having a change request information holding means (1605) that holds change request information, which is information indicating a matter that is required to be changed for the complete execution of a process recognized in the process, as the influencing circumstance. Since the functions excluding the change request information holding means have already been described in the first embodiment, only the change request information holding means will be described below.

### Sixth Embodiment; Explanation of Configuration; Change Request Information Holding Means

The “change request information holding means” has a function of holding change request information, which is information indicating a matter that is required to be changed for the complete execution of a process recognized in the process, as the influencing circumstance. The change request information is typically a change in the To Do, a change in the issue, and a change in the risk, but is not limited to them. For example, various changes such as a change in the completion time of the project and a change in the project execution members may be included.

### Sixth Embodiment; Hardware Configuration

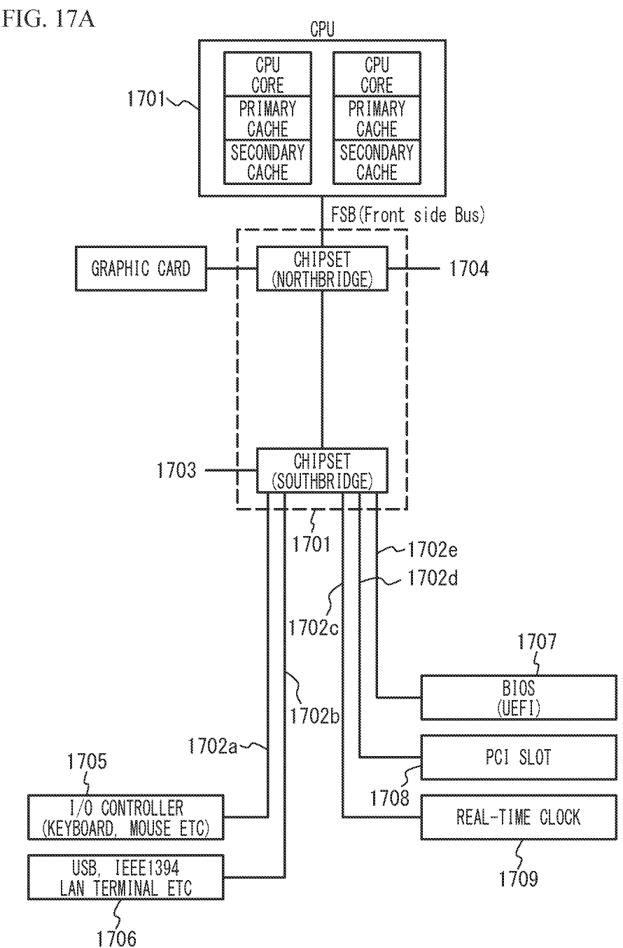

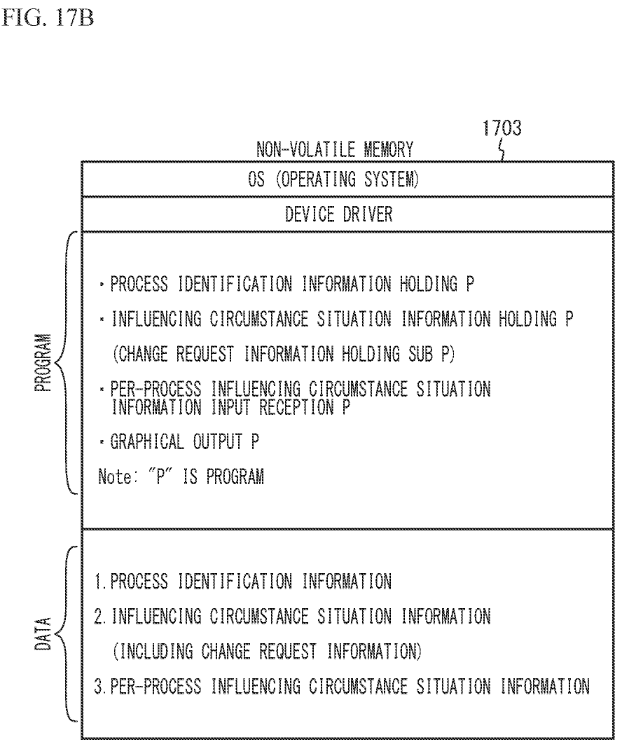

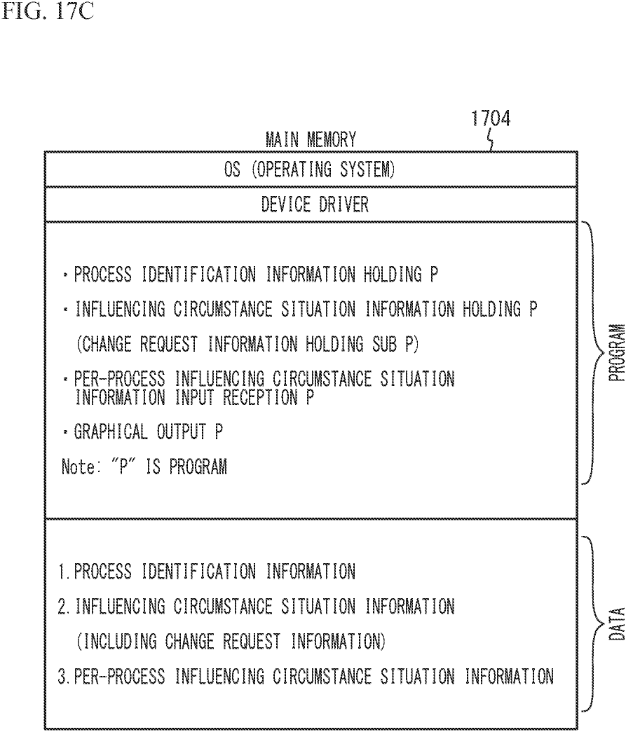

FIGS. 17A to 17C are diagrams illustrating a hardware configuration of the project management system according to the present embodiment. As illustrated in FIGS. 17A to 17C, the computer includes a chipset (1710), a CPU (1701), a non-volatile memory (1703), a main memory (1704), various buses (1702a, 1702b, 1702c, 1702d, 1702e), a BIOS (1707), various interfaces (1705, 1706, 1708), areal-time clock (1709), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 17A to 17C, the non-volatile memory includes the “process identification information holding program” that holds the process identification information identifying the process of the project, the “influencing circumstance situation information holding program” that holds a plurality of types of influencing circumstance situation information, each of which expresses the influencing circumstance which is a circumstance that influences the progress of the project recognized in the process of the project, the “per-process influencing circumstance situation information input reception program” that receives input of per-process influencing circumstance situation information that is information in which the held influencing circumstance situation information is associated with the process identification information of the process in which the influencing circumstance indicated in the influencing circumstance situation information is recognized, the “graphical output program” that graphically outputs the per-process influencing circumstance situation information. The “influencing circumstance situation information holding program” includes a “change request information holding subprogram” that holds the change request information, which is information indicating a matter that is required to be changed for the complete execution of a process recognized in the process, as the influencing circumstance. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Sixth Embodiment; Process Flow

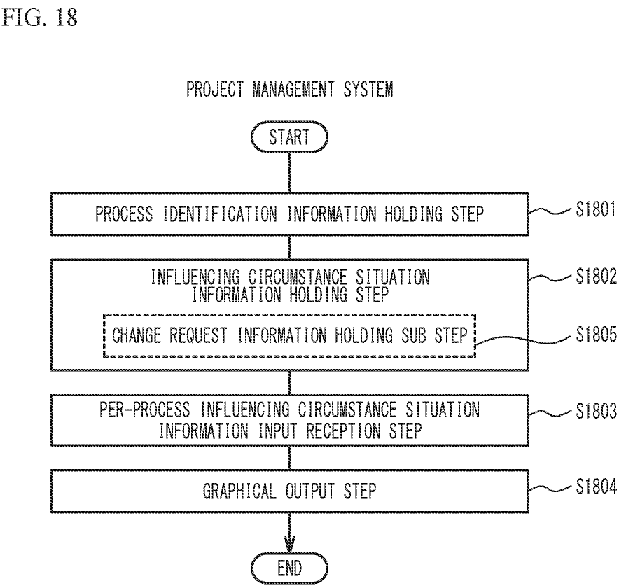

FIG. 18 is a flowchart illustrating the process when the project management system according to the present embodiment is used. The process flow of this embodiment is an operation method of the project management system which is a computer having a process identification information holding step (S1801), an influencing circumstance situation information holding step (S1802), a per-process influencing circumstance situation information input reception step (S1803), a graphical output step (S1804), and a change request information holding substep (S1805). Each of these steps, except the change request information holding substep, is the same as that in the first embodiment. Hereinafter, the change request information holding substep will be described below.

The “change request information holding substep” holds the change request information, which is information indicating a matter that is required to be changed for the complete execution of a process recognized in the process, as the influencing circumstance.

### Seventh Embodiment

### Seventh Embodiment; Summary; Mainly Relating to Claims 39, 48 and 57

In addition to the first embodiment described above, the seventh embodiment provides a project management system in which the influencing circumstance situation information holding unit has a function of holding risk information, which is information indicating a risk recognized in the process, as the influencing circumstance. This embodiment is based on any one of the first to sixth embodiments.

### Seventh Embodiment; Functional Configuration

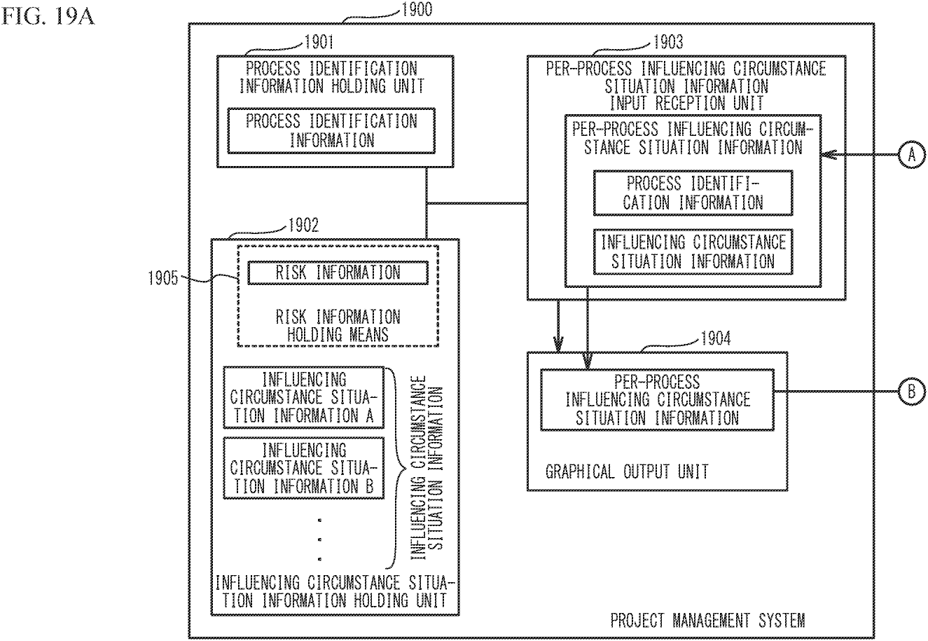

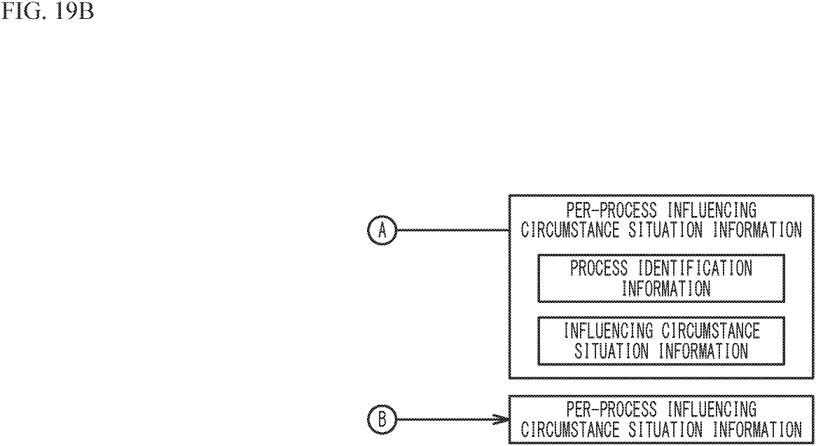

FIGS. 19A and 19B are diagrams illustrating a functional configuration of the present embodiment. The project management system (1900) of the present embodiment has a process identification information holding unit (1901), an influencing circumstance situation information holding unit (1902), a per-process influencing circumstance situation information input reception unit (1903), and a graphical output unit (1904) as in the first embodiment. Further, the influencing circumstance situation information holding unit is characterized by having a risk information holding means (1905) that holds the risk information, which is information indicating a risk recognized in the process, as the influencing circumstance. Since the functions excluding the risk information holding means have already been described in the first embodiment, only the risk information holding means will be described below.

### Seventh Embodiment; Explanation of Configuration; Risk Information Holding Means

The “risk information holding means” holds the risk information, which is information indicating a risk recognized in the process, as the influencing circumstance.

### Seventh Embodiment; Hardware Configuration

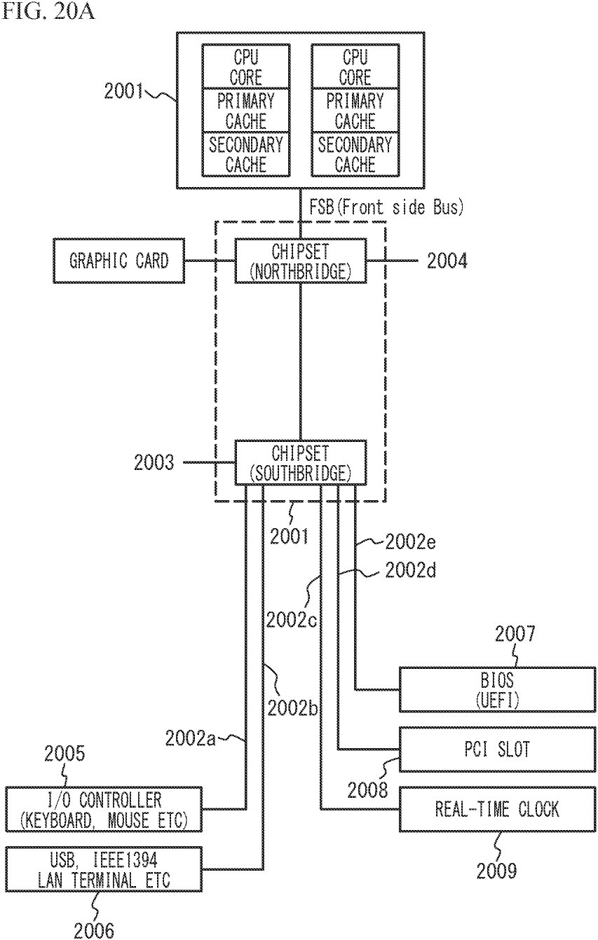

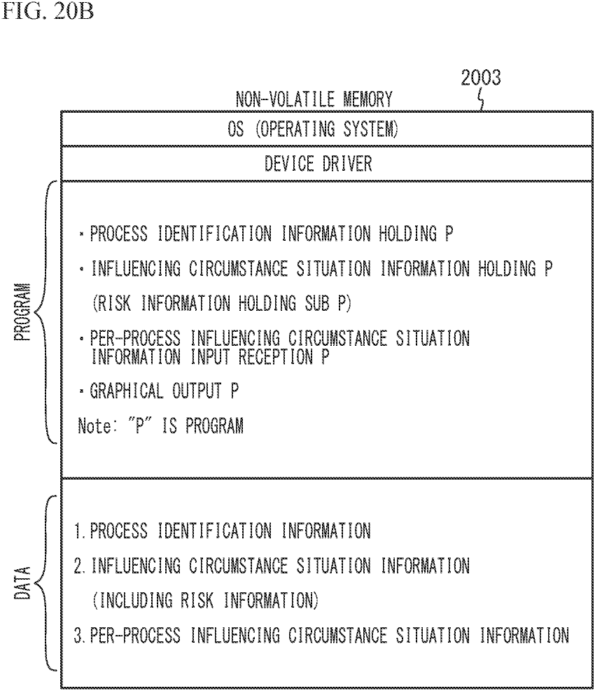

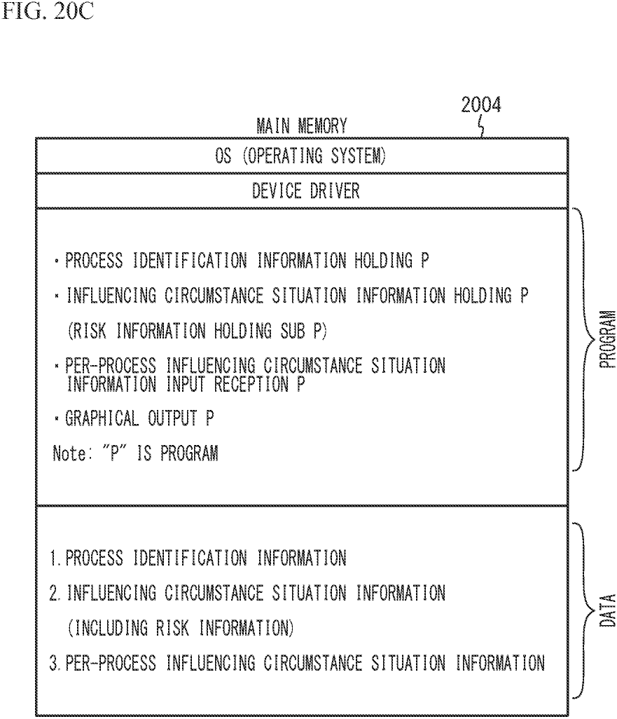

FIGS. 20A to 20C are diagrams illustrating a hardware configuration of the project management system according to the present embodiment. As illustrated in FIGS. 20A to 20C, the computer includes a chipset (2010), a CPU (2001), a non-volatile memory (2003), a main memory (2004), various buses (2002a, 2002b, 2002c, 2002d, 2002e), a BIOS (2007), various interfaces (2005, 2006, 2008), a real-time clock (2009), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 20A to 20C, the non-volatile memory includes the “process identification information holding program” that holds the process identification information identifying the process of the project, the “influencing circumstance situation information holding program” that holds a plurality of types of influencing circumstance situation information, each of which expresses the influencing circumstance which is a circumstance that influences the progress of the project recognized in the process of the project, the “per-process influencing circumstance situation information input reception program” that receives input of per-process influencing circumstance situation information that is information in which the held influencing circumstance situation information is associated with the process identification information of the process in which the influencing circumstance indicated in the influencing circumstance situation information is recognized, the “graphical output program” that graphically outputs the per-process influencing circumstance situation information. The “influencing circumstance situation information holding program” includes a “risk information holding program” that holds the risk information, which is information indicating a risk recognized in the process, as the influencing circumstance. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Seventh Embodiment; Process Flow

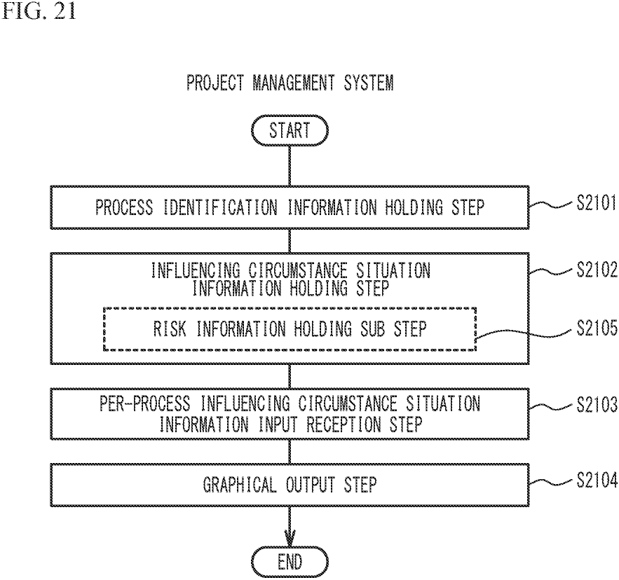

FIG. 21 is a flowchart illustrating the process when the project management system according to the present embodiment is used. The process flow of this embodiment is an operation method of the project management system which is a computer having a process identification information holding step (S2101), an influencing circumstance situation information holding step (S2102), a per-process influencing circumstance situation information input reception step (S2103), a graphical output step (S2104), and a risk information holding substep (S2105). Each of these steps, except the change request information holding substep, is the same as that in the first embodiment. Hereinafter, the change request information holding substep will be described below.

The “risk information holding substep” holds the risk information, which is information indicating a risk recognized in the process, as the influencing circumstance.

### Eighth Embodiment

### Eighth Embodiment; Summary; Mainly Relating to Claims 1, 11 and 21

The present embodiment provides a project management system including a memory; and a processor coupled to the memory and the processor configured to: hold status identification information that identifies a status, and executor identification information that identifies an executor of a project; hold a plurality of types of influencing circumstance identification information that identifies an influencing circumstance which is a circumstance that influences the progress of the project recognized in a phase of the project; hold execution manager identification information that identifies an execution manager as an executor who is responsible for executing a workaround to avoid an adverse influence on the project due to the influencing circumstance, and phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); receive an input of the influencing circumstance situation information which is information that associates, with each other, the held influencing circumstance identification information, the phase identification information of a phase in which the influencing circumstance identified by the influencing circumstance identification information is recognized, recognized timing thereof, the execution manager identification information that identifies the execution manager as the executor who is responsible for executing the workaround, an influence degree to which the influencing circumstance influences the project, the status identification information of the status which is information indicating the status of resolution to the influencing circumstance situation information; hold the received influencing circumstance situation information; output the held influencing circumstance situation information; and graphically output a graph (a line graph or a bar graph) with one axis as the timing and another axis as the recognized number of pieces of influencing circumstance situation information using the held influencing circumstance situation information.

Hereinafter, the functional configuration, the hardware configuration, and the process flow of the project management system in the present embodiment will be described in order.

### Eighth Embodiment; Functional Configuration

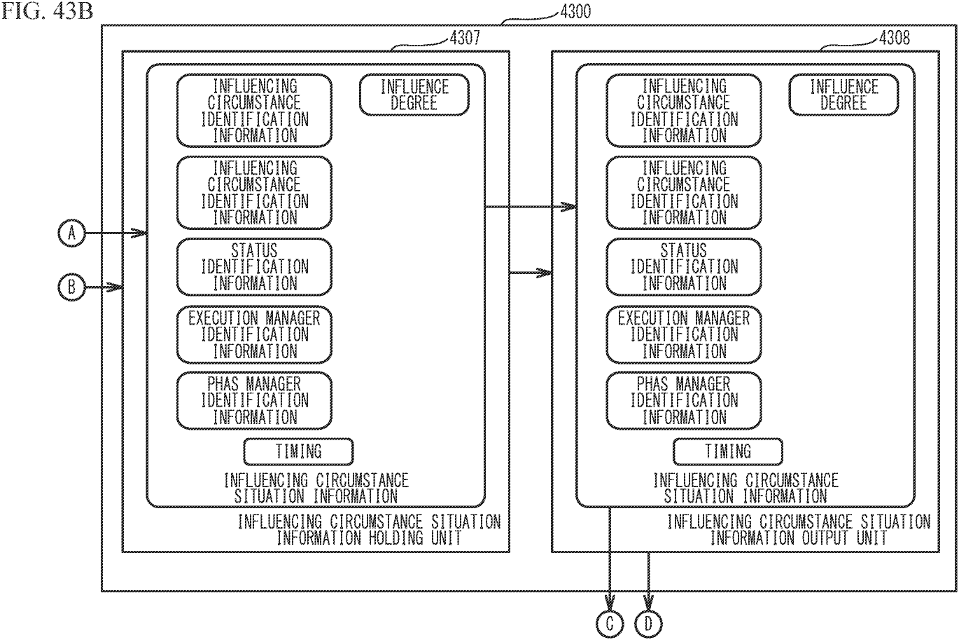

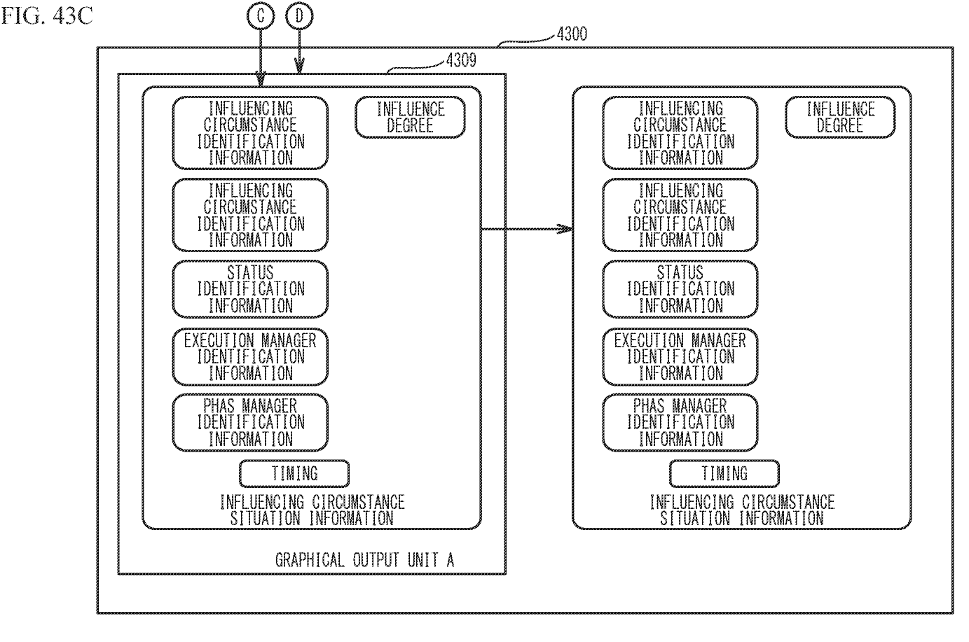

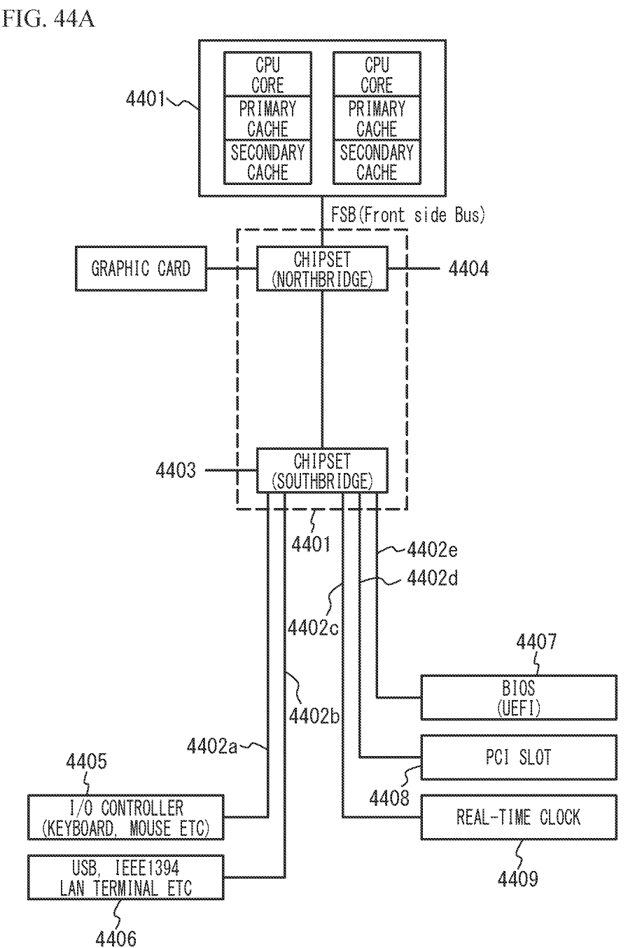

FIGS. 43A to 43C are diagrams illustrating a functional configuration of the present embodiment. The project management system (4300) of the present embodiment has an executor identification information holding unit (4301), an influencing circumstance identification information holding unit (4302), a status identification information holding unit (4303), an execution manager identification information holding unit (4304), a phase identification information holding unit (4305), an influencing circumstance situation information input reception unit (4306), an influencing circumstance situation information holding unit (4307), an influencing circumstance situation information output unit (4308), and a graphical output unit A (4309).

### Eighth Embodiment; Overall Explanation

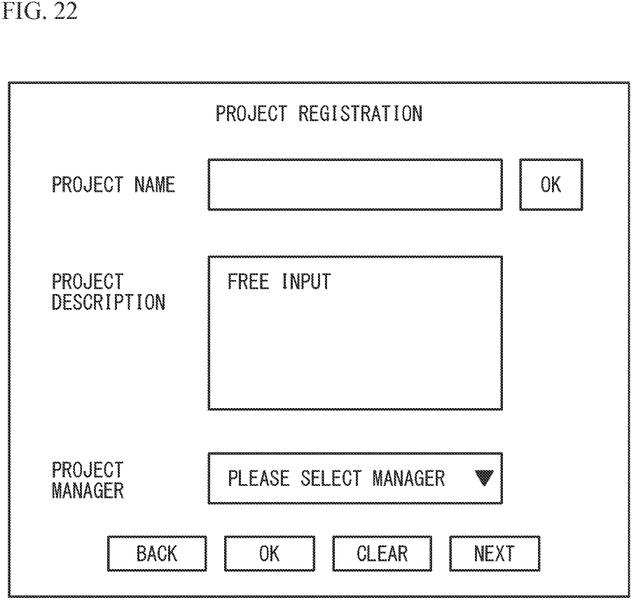

FIG. 22 is a diagram illustrating an example of a screen for “project registration”, which is a prerequisite for project management. For example, it is conceivable to input “project name”, “project description”, “project manager”, and so on. Among them, it is conceivable to prepare candidates in advance for the project manager and select the project manager from the candidates in a pull-down format. On the other hand, in the project description, the content varies from project to project, so it is preferable to use the free input format instead of pull-down.

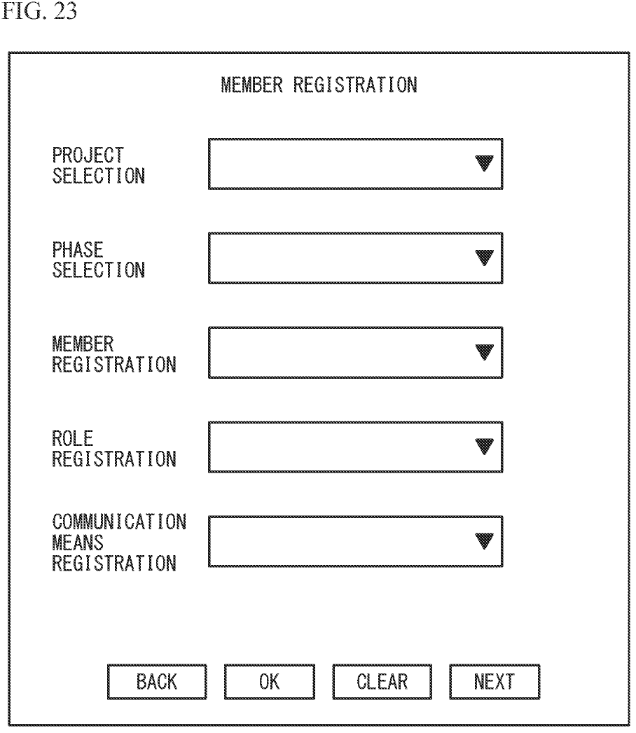

FIG. 23 is a diagram illustrating an example of the registration screen of members participating in the project. For example, the user may be asked to select “project selection”, “phase selection”, “member registration”, “role registration”, “communication means registration” and so on. Since selection candidates can be prepared for any of the items, a pull-down selection method can be considered.

The system may include a project member registration unit that registers candidates for the project members for each team, such as “Team A”, “Team B”, “Team C”, and a per-team registration method that registers the execution manager from the candidates in each team.

### Eighth Embodiment; Explanation of Configuration; Executor Identification Information Holding Unit

The “executor identification information holding unit” has a function of holding executor identification information that identifies an executor of the project.

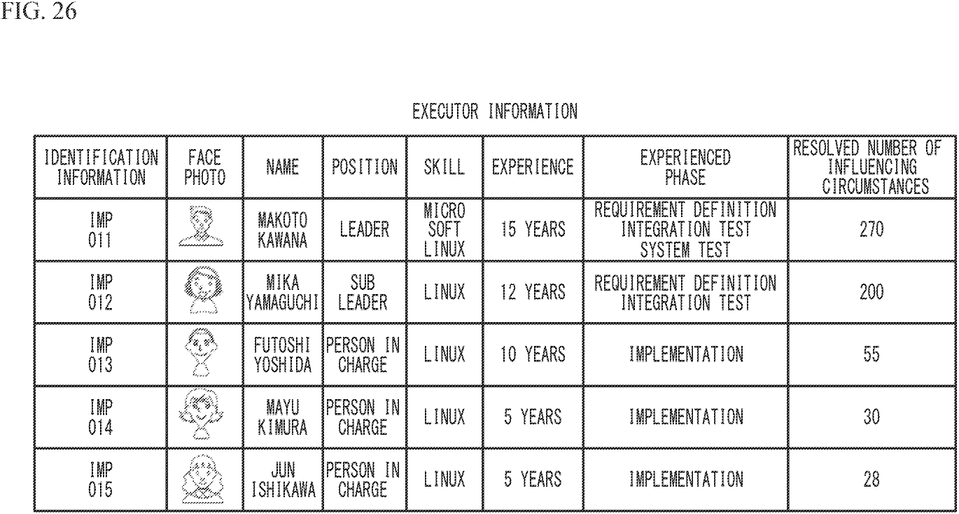

FIG. 26 is a diagram illustrating an example of information on the executors (database of the executors). As illustrated in FIG. 26, for example, it is conceivable to provide items such as “identification number” (executor identification information), “face photo”, “name”, “position”, “skill”, “experience”, “experienced phase”, and “resolved number of influencing circumstances”. Then, “Makoto Kawana” whose “identification number” (executor identification information) is “IMP011” is associated with the position “leader”, the skill “MICROSOFT, LINUX”, the experience “15 years”, the experienced phase “requirements definition, integrated test, system test”, and the resolved number of influencing circumstances “270”. Further, “Mika Yamaguchi” whose “identification number” is “IMP012” is associated with the position “sub leader”, the skill “LINUX”, the experience “12 years”, the experienced phase “requirements definition, integration test”, and the resolved number of influencing circumstances “200”. Next, “Futoshi Yoshida” whose “identification number” is “IMP013” is associated with the position “person in charge”, the skill “LINUX”, the experience “10 years”, the experienced phase “implementation”, and the resolved number of influencing circumstances “55”. Next, “Mayu Kimura” whose “identification number” is “IMP014” is associated with the position “person in charge”, the skill “LINUX”, the experience “5 years”, the experienced phase “implementation”, and the resolved number of influencing circumstances “30”. Next, “Jun Ishikawa” whose “identification number” is “IMP015” is associated with the position “person in charge”, the skill “LINUX”, the experience “5 years”, the experienced phase “implementation”, and the resolved number of influencing circumstances “28”. Such an executor database may be regarded as an executor identification information holding unit. In addition to such an executor database, an executor identification information holding unit that holds only the executor identification information may be provided. The system can be configured to include a project member candidate identification information holding unit as a database of people who are a population for selecting an executor. The project member candidate identification information holding unit may be configured to be selected and registered from a project design information server provided separately from the project management system That is, the project design information server can be configured to include the project member candidate identification information holding unit and a project member candidate database. When selecting the executor, it can be configured so that a member can be selected from the project member candidate identification information held in the project member candidate identification information holding unit. This function can be configured to be available by an executor registration unit that can be provided in this system. That is, the executor registration unit can be configured to select and register the executor of each phase in association with the phase identification information. In addition, the executor registration unit may be configured to automatically select and register the executor according to a project attribute held in a project attribute holding unit (preferably provided in this system) that inputs and holds the project attributes. After the executor is automatically selected once, the leader or the manager in the executors may be configured to edit the registration of the executors, so that the process up to the determination of the first executor can be executed with a relatively low load.

### Eighth Embodiment; Explanation of Configuration; Status Identification Information Holding Unit

The “status identification information holding unit” has a function of holding the status identification information (for example, new, registration approval waiting, workaround measures being taken, mitigation measures being taken, pass-through measures being taken, acceptance measures being taken, corrections being made, just before completion, completion approval waiting, completion, and so on) that identifies the status. The “status identification information” is information indicating a status of resolution to the influencing circumstance that has occurred.

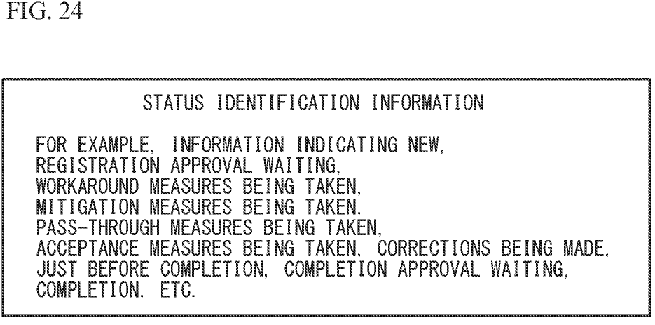

FIG. 24 is a diagram illustrating an example of status identification information (or status identified by status identification information). As illustrated in FIG. 24, the status identification information is information indicating, for example, new, registration approval waiting, workaround measures being taken, mitigation measures being taken, pass-through measures being taken, acceptance measures being taken, corrections being made, just before completion, completion approval waiting, completion, and so on.

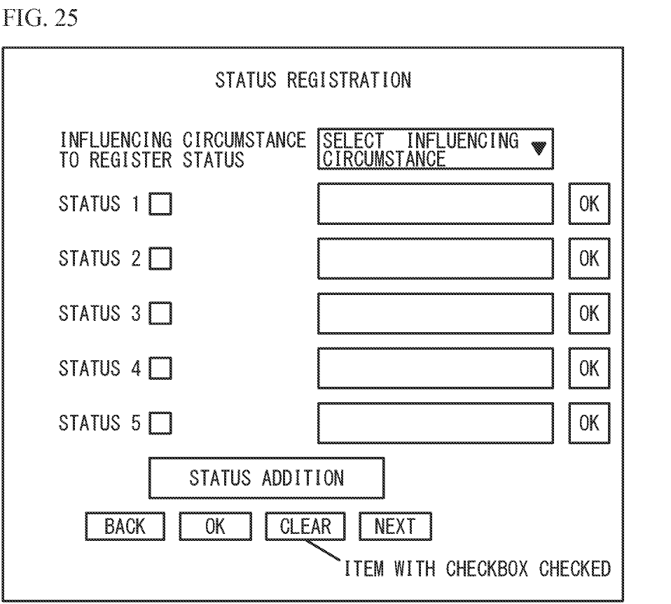

FIG. 25 is a diagram illustrating an example of a screen of the status registration. For example, the screen has a field for selecting and inputting “influencing circumstance to register status” by pull-down or the like, and various status input fields such as “status 1”, “status 2”, “status 3”, “status 4” and “status 5” (further, status can be added). Since the status is progressing in stages, it is desirable to hold the date at the same time so that it is possible to grasp the speed of progress, etc. The status identified by the status identification information may be common or unique depending on each influencing circumstance situation information. Basically, the status is configured to be registered at the design stage of the project. The status identified by this status identification information may be configured to be selected and registered from the project design information server provided separately from the project management system. The status registration unit of the project management system can be connected to the status database of the project design information server, and the statuses registered in the status database can be selected by clicking the buttons on the pull-down menu in the figure. By selecting one of the statuses, the status and the status identification information that identifies the status can be obtained, registered, and held in this system In this case, the status information holding unit in the system can be configured to hold the information associated with the status identification information and the status. The associated information held in the status information holding unit may be configured to be editable by the status information editing unit. In addition, explanatory information about the status and definition information may be held in association with the status identification information. Further, when the system is configured so that the status can be automatically selected (status automatic selection unit), the condition to be satisfied for the status to be selected may be associated with the status identification information. As the condition to be satisfied, various information input to this system can be used. For example, a report or e-mail from the execution manager related to the relevant influencing circumstance situation information is automatically parsed and the text contained therein is parsed, and the result may be the condition to be satisfied.

### Eighth Embodiment; Explanation of Configuration; Execution Manager Identification Information Holding Unit

The “execution manager identification information holding unit” has a function of holding execution manager identification information that identifies an execution manager as an executor who is responsible for executing a workaround to avoid an adverse influence on the project due to the influencing circumstance. The “execution manager” is included in the “executors”, which can be either the leader or someone who works with the support of the leader, as long as he or she is responsible for implementing the workaround. The execution manager is, in principle, also the executor. Therefore, the information that identifies the executor is the executor identification information, and the identification information selected from the executor identification information held in the executor identification information holding unit becomes the execution manager identification information that identifies the execution manager. The execution manager identification information does not necessarily have to be registered and held from the beginning of the project, and can be configured to be newly registered and held according to the held influencing circumstance situation information. This means that the execution manager identification information is registered and held when the influencing circumstance is recognized. Of course, it is also possible to register and held the execution manager identification information from the beginning with an eye on the future.

### Eighth Embodiment; Explanation of Configuration; Influencing Circumstance Identification Information Holding Unit

The “influencing circumstance identification information holding unit” hold a plurality of types of influencing circumstance identification information that identifies an influencing circumstance which is a circumstance that influences the progress of the project recognized in a phase of the project.

FIG. 27 is a diagram illustrating an example of the influencing circumstance situation information. The contents of the influencing circumstance situation information include, for example, information such as issue, To Do, risk, and project change. Here, the “issue” means a matter that must be overcome in order to complete the project. The issue is often identified by a goal and a specification of the project. In the case of a technical project, if the technical system of the deliverable (It may be a technical system prepared in advance or a technical system prepared at the start of a project. For example, when the deliverable is an automobile, information indicating the connection between the technologies constituting the automobile corresponds to the technical system.) is prepared, it can be configured so that the issue is automatically acquired and held by inputting the specifications required for the deliverable.

The “To Do” is an essential item that must be performed in order to carry out the project, even if it is not always recognized as an unsolved issue. The “To Do” corresponds to, for example, the concept of work. The “To Do” is a kind of processing that is inevitably achieved by preparing time, people and money.

The “risk” is an event that may adversely influence the execution of the project and has not yet become apparent at least at the time of risk registration. When the risk is defmed by a quantified variable, it is registered in a state where the variable has already been filled with a certain value but has not yet reached a level that adversely influences the project.

The “project change” is an event that changes a part or all of the components of an originally designed project, and the project components are the influencing circumstances identified by the influencing circumstance identification information.

It is preferable that the influencing circumstance identification information is configured to be associated with the influencing circumstance situation information and held in the influencing circumstance situation information holding unit. In addition, the influencing circumstance situation information is held in the above-mentioned project design information server, and this influencing circumstance situation information may be registered by the influencing circumstance situation information registration unit of this project management system. As a result of the registration, the influencing circumstance identification information may be automatically acquired and the acquired influencing circumstance identification information may be held in the influencing circumstance identification information holding unit. Here, the selection of the influencing circumstance identification information does not necessarily have to be made by the selection of a person, and when the phase of the project is registered, the influencing circumstance identification information can be configured to be automatically selected according to the registered phase. It can also be configured so that the influencing circumstance identification information is automatically selected once, and then corrected appropriately by a person. By configuring the system in this way, the trouble of registration can be saved, and the registration time of the project can be shortened.

FIG. 28 is a diagram illustrating an example of information related to “issue” in the influencing circumstance situation information. The information related to “issue” is elements that are considered to have to be resolved in order to achieve a purpose of the project. Conversely, the purpose of the project is automatically achieved by resolving all expected issues. The issues should thus be set by those who can grasp the project from a higher conceptual level, and this system should be designed so that issues are allowed to be set by those whose prescribed qualifications are authenticated by the input ID. It is also possible to design the system so that issues are preassociated with predetermined categories in the system and project attributes are set before the issue is entered to prompt the user to enter the required issue category. For example, if the project attribute is magazine sales promotion, the categories of issues include: budget procurement for sales promotion activities, selection of the sales promotion format to be adopted in sales promotion activities, selection of the optimal media and activities to be applied to the selected sales promotion format, planning of a magazine composition proposal to be presented to the magazine production side for sales promotion activities, and obtaining approval from the magazine production side for the proposed plan, and so on. Alternatively, if the project is the development of a new model vehicle, it is preferable to prepare categories of issues corresponding to the project and design a system so that the inputter can input information with failsafe even if the inputter does not notice. It is preferable to configure the input to be input using the aforementioned individual forms of a predetermined format.

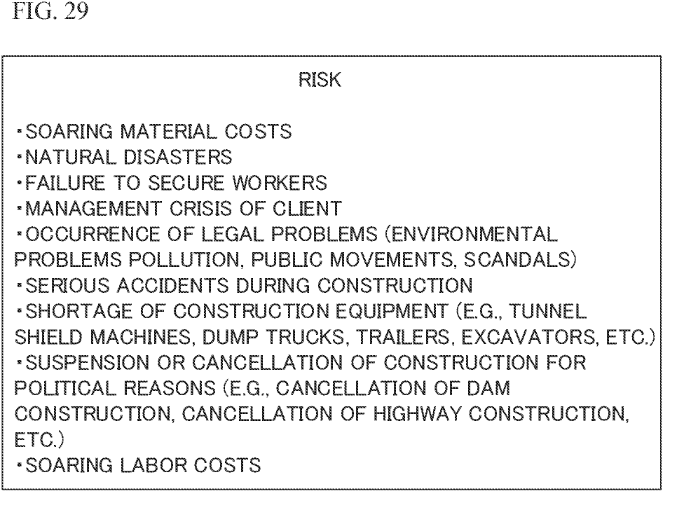

FIG. 29 is a diagram illustrating an example of information related to “risk” in the influencing circumstance situation information. The information related to “risk” is an event that does not affect the progress of the project unless it becomes apparent, but that will affect the project in some way if it becomes apparent. For example, in the case of construction of large facilities, the “risk” may be soaring material costs, natural disasters, failure to secure workers, management crisis of the client, occurrence of legal problems (environmental problems, pollution, public movements, scandals), serious accidents during construction, shortage of construction equipment (e.g., tunnel shield machines, dump trucks, trailers, excavators, etc.), suspension or cancellation of construction for political reasons (e.g., cancellation of dam construction, cancellation of highway construction, etc.), soaring labor costs, etc, large fluctuations in foreign exchange rates in the case of projects affected by exchange rates.

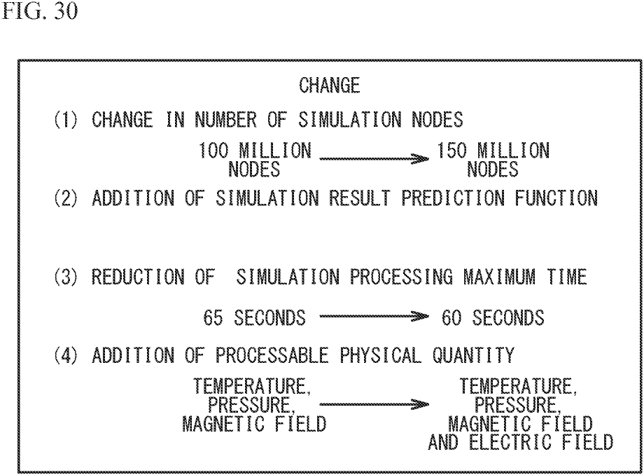

FIG. 30 is a diagram illustrating an example of information related to “project change” in the influencing circumstance situation information. The contents of the change include (1) change in the number of simulation nodes from “100 million nodes” to “150 million nodes”, (2) addition of a simulation result prediction function, (3) reduction of the maximum simulation processing time from “65 seconds” to “60 seconds,” and (4) addition of the processable physical quantities from “temperature, pressure, and magnetic field” to “temperature, pressure, magnetic field, and electric field”.

### Eighth Embodiment; Explanation of Configuration; Phase Identification Information Holding Unit

The phase identification information holding unit has a function of holding the phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on. The phase may indicate a concept lower than this, that is, a process that is an element constituting each phase. The process may be layered into multiple layers. When exercising the rights pertaining to this application, the name does not matter. The same shall apply throughout this application.).

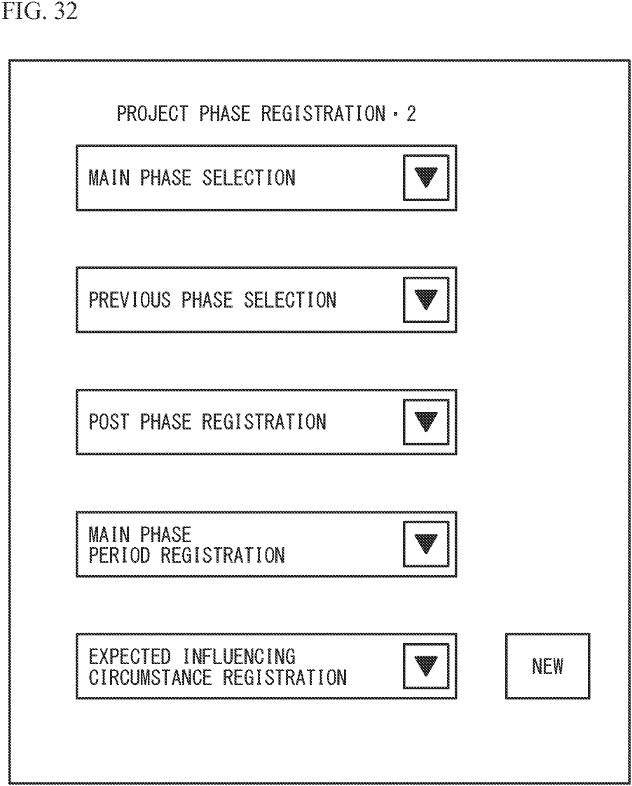

FIG. 32 is a diagram illustrating an example of a screen of the project phase registration. The phase of the project can be freely input or input by pull-down, but the contents of the selection and input include “main phase selection”, “previous phase registration”, “post phase registration”, “main phase period registration”, and “expected influencing circumstance registration”.

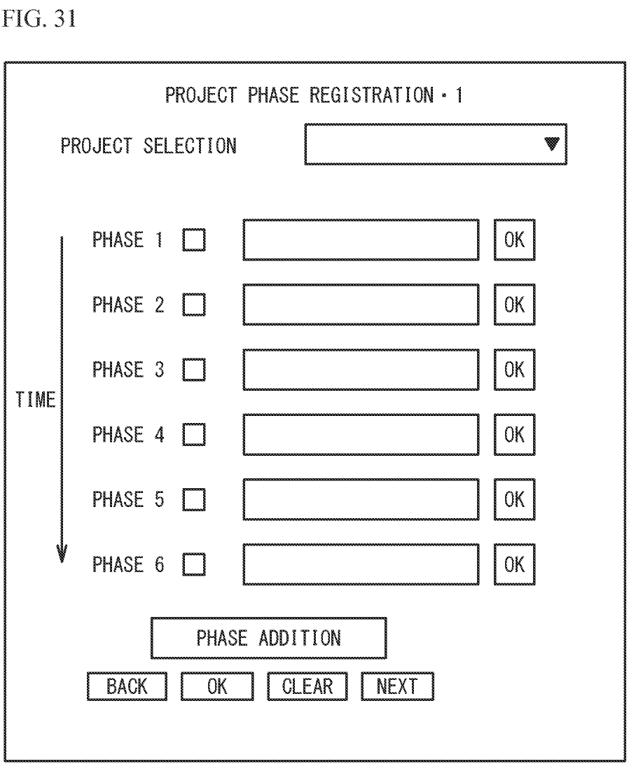

FIG. 31 is a diagram illustrating an example of a screen of the project phase registration. For example, this screen has a selection field for “each project selection” and various phase input fields such as “phase 1”, “phase 2”, “phase 3”, “phase 4”, “phase 5” and “phase 6” (further phases can be added). The input of the “each project selection” is selected by the pull-down, and the phase is input to each phase input field. Since the status is progressing in stages, it is desirable to hold the date at the same time so that it is possible to grasp the speed of progress, etc. The input content here may go through “definition registration”, “edit”, “approval”, “ correction request”, or the like.

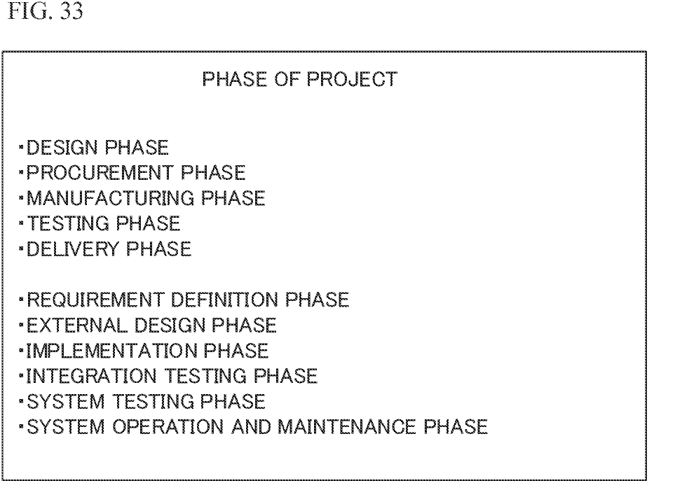

FIG. 33 is a diagram illustrating an example of information related to the phase of the project. As illustrated in FIG. 33, the phase includes, for example, “design phase, procurement phase, manufacturing phase, testing phase, delivery phase”, “requirement definition phase, external design phase, implementation phase, integration testing phase, system testing phase, system operation and maintenance phase”, and so on.

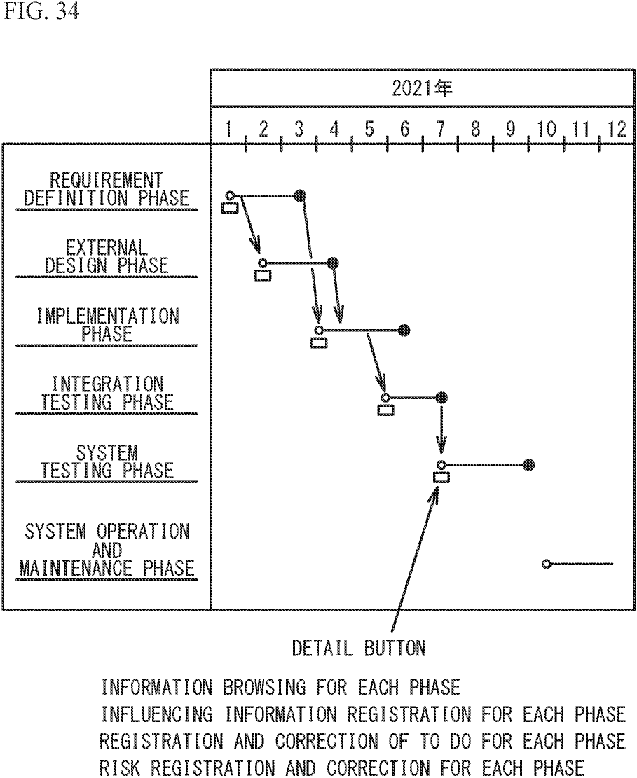

FIG. 34 is a diagram illustrating a relationship between phases. The phase indicates a process when viewed as a whole project. Generally, the phases such as “requirement definition phase”, “external design phase”, “implementation phase”, “integration testing phase”, “system testing phase”, and “system operation and maintenance phase” are organized hierarchically. And, the respective phases may be partially executed in parallel. For example, if a problem is found in the “implementation phase”, it is possible to return to the “requirements definition phase” that should have already been completed at that stage. In addition, a button for “detail confirmation” may be provided in each phase. The “detail confirmation” may include menus such as “information browsing for each phase”, “influencing information registration for each phase”, “registration and correction of To Do for each phase”, and “risk registration and correction for each phase”. The phase can be registered by selecting one of the phases held in the project design information server. As an example, the project design information server has a phase database that registers and holds various phases, and a phase registration unit in the project management system connects to the project design information server to select the phase applicable to the project from the various phases. The phase identification information is automatically obtained according to the selection and can be held in the phase identification information holding unit. In addition, an organic linkage between the phases may be configured so that linkage information (linkage identification information) indicating the linkage may be registered and held in association with a plurality of phase identification information by a phase linkage program prepared in advance. The linkage information can be held by providing a phase linkage information holding unit in the project management system The linkage information can be used to calculate an influence degree on other phases of the project or the project as a whole depending on the status of issues, risks, or To-Dos, and can be used to predict or output the future project status by the graphic output unit.

### Eighth Embodiment; Explanation of Configuration; Influencing Circumstance Situation Information Input Reception Unit

The “influencing circumstance situation information input reception unit” has a function of receiving an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information.

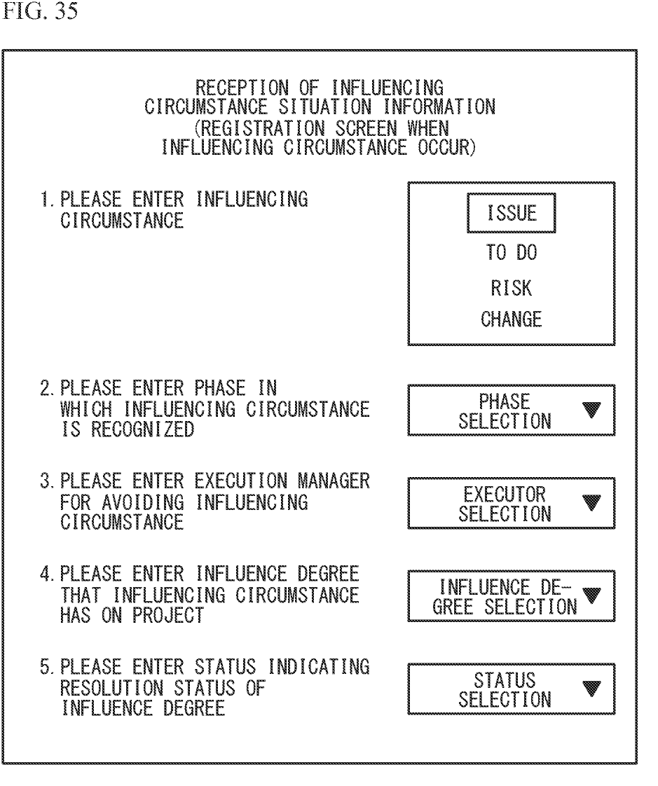

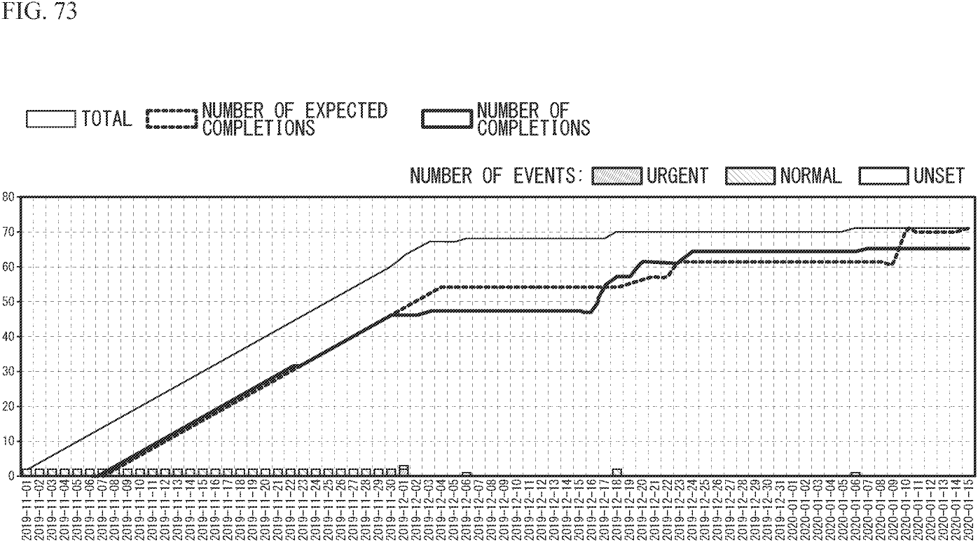

FIG. 35 is a diagram illustrating an example of reception of the influencing circumstance situation information (a registration screen when the influencing circumstance occurs). As illustrated in FIG. 35, the “influencing circumstance” is input, the “phase in which influencing circumstance is recognized” is input, the “execution manager for avoiding influencing circumstance” is input, the “influence degree that influencing circumstance has on project” is input, and then the “status indicating resolution status of influence degree” is input. These fields can be either free-form input or pull-down selection, but as illustrated in FIG. 15, the pull-down selection is more convenient because it facilitates retrieval of the registered contents and calculation of linkage among the information. These inputs can be made not only by a person but also automatically by a program. The executor can also input a daily report to the project management system to manage the progress of the project, and other information can be automatically generated from this daily report. The daily report can be provided as a function of a daily report unit. The input here may go through “definition registration”, “edit”, “approval”, “correction request” and so on. In addition, it can be configured to input here an expected period until the problem of the influencing circumstance can be resolved, that is, some adverse influence on the project can be eliminated. For example, the system will ask the user to input 3 days, 1 week, or 2 weeks until the problem is resolved, or to input the expected date of resolution, such as March 21, 202/3, or to input 30 hours of actual work or 4 days of actual work. This allows the graphical output unit A to indicate how much the problem due to the influencing circumstance will be eliminated in the future. For example, as illustrated in FIG. 73, the horizontal axis is a time axis such as the date, and the number of influencing circumstances that have occurred on each day is displayed as a bar graph illustrating the number of cases on each day, the cumulative number of influencing circumstances that have occurred is displayed as a line graph, and the line graph of the cumulative number of problems resolved on each day due to the influencing circumstance is superimposed thereon and displayed. This allows the user to read that a difference between the line graph of influencing circumstances and the line graph of the cumulative number of problems resolved is the number of remaining unresolved influencing circumstances. In addition, a line graph of the cumulative number of problems resolved in future influencing circumstances is displayed and superimposed on a line graph of the cumulative number of remaining influencing circumstances in the future, allowing the user to determine when and to what extent the influencing circumstances will be resolved in the future. This can be useful information for future projections. The line graph of the cumulative number of future influencing circumstances may be displayed as a horizontal line reflecting the current cumulative number of influencing circumstances, or it may be configured so that the line graph illustrating the cumulative number of influencing circumstances and the line graph of the cumulative number of resolved influencing circumstances are superimposed by assuming the occurrence of estimated new influencing circumstances based on statistical information on the actual results until now and past results, and by using the number of days required to resolve problems in the influencing circumstances using the same technique. The above explanation describes an example in which the line graph illustrating the cumulative number of influencing circumstances and the line graph illustrating the cumulative number of resolved influencing circumstances are superimposed, but the graph output is not limited to this. A line graph of the cumulative number of unresolved influencing circumstances may be displayed by subtracting the cumulative number of resolved influencing circumstances from the cumulative number of influencing circumstances that have occurred during the same period. Further, for the past influencing circumstances, a line graph illustrating the cumulative number of expected resolutions of influencing circumstances may be superimposed on the above graphs and displayed, so that the discrepancy between the expected resolutions and the actual number of resolutions can be grasped.

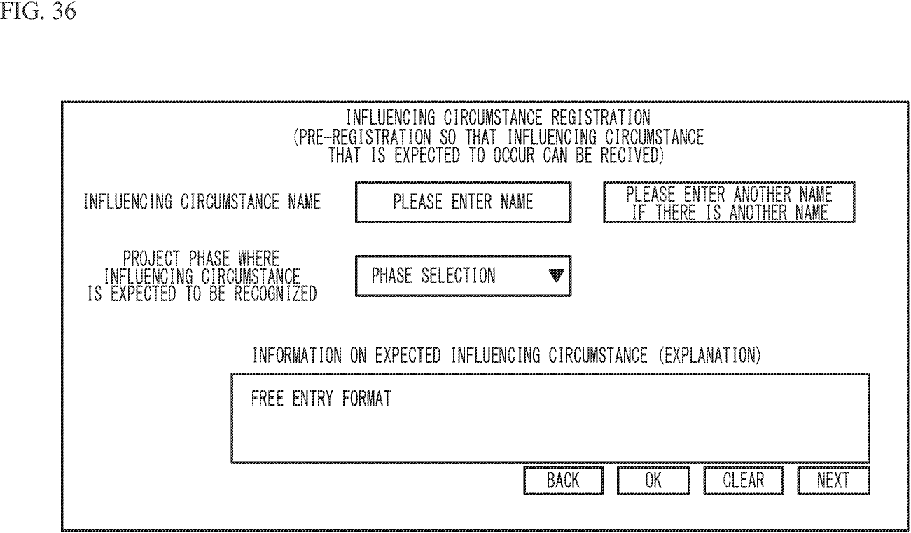

FIG. 36 is a diagram illustrating an example of a screen for “pre-registration so that the influencing circumstance that is expected to occur can be received” in the case of the method of selection by pull-down in the influencing circumstance registration. For example, a name is input to a field “influencing circumstance name” and if there is another name, the another name is also input. Then, the user is asked to select the project phase in which the influencing circumstance is expected to be recognized, using a pull-down menu, and to input information on the expected influencing circumstance in the free-input format.

### Eighth Embodiment; Explanation of Configuration; Influencing Circumstance Situation Information Holding Unit

The “influencing circumstance situation information holding unit” has a function of holding the received influencing circumstance situation information. It is preferable that the influencing circumstance situation information holding unit is configured so that the held influencing circumstance situation information is stored in a database, and is sortable and searchable by the various information itself contained and by the types of information. This configuration allows the graphic output unit to output graphics in various forms for various parameters. Examples of the parameters include one or more of the phase of the project, the execution manager, the influence degree on the project of the influencing circumstance, the status of resolution, and the like, but are not limited to these. The influencing circumstance situation information may be sorted and searchable by words in various reports, daily reports, and various e-mails that are associated with the influencing circumstance situation information, as well as text, data, or keywords exchanged between the executor, the execution manager, and the project leader via communication boards, SNS, and other means. For example, the keywords such as “danger”, “delay”, “irrecoverable”, “failure”, and “apology” may be selected. These can be selected from the keywords (with synonyms organized) in the keyword dictionary holding unit that holds a keyword dictionary provided with this system, and can be configured to allow sorting and searching of the influencing circumstance situation information using these keywords.

### Eighth Embodiment; Explanation of Configuration; Influencing Circumstance Situation Information Output Unit

The “influencing circumstance situation information output unit” has a function of outputting the held influencing circumstance situation information. The destination of the output may be a display, a printer, a multifunction printer, or other terminal connected by a network, a project design information server, or the like. The project design information server can also be configured to update its own database based on the received influencing circumstance situation information, or to deep-learn by artificial intelligence to brush up a future prediction program and a future prediction unit. The future prediction program and the future prediction unit are preferably capable of predicting changes in the future influencing circumstance situation information and transmitting them to the project management system. The project design information server also holds a project executor support program, which is sent to the project management system. Thereby, the project management system can be configured to provide an appropriate advice to the executor according to the held influencing circumstance situation information. In this way, the present system is excellent in being able to output support information.

### Eighth Embodiment; Explanation of Configuration; Graphical Output Unit A

The graphical output unit A has a function of graphically outputting a graph (line graph or bar graph) with one axis as the timing and another axis as the number of recognitions of influencing circumstance situation information, using the held influencing circumstance situation information. If the horizontal axis is the timing (time) axis, the vertical axis may include one or more of the number of newly recognized and/or accumulated influencing circumstance situation information recognized until now, the number of influencing circumstance situation information with a specific influence degree, the number of influencing circumstance situation information related to a specific group or team in the project, the number of influencing circumstance situation information related to a specific execution manager, the number of influencing circumstance situation information in a specific phase, the number of influencing circumstance situation information in a specific resolution term (i.e., a period of time after the influencing circumstance situation is recognized or avoidance measures are developed and avoidance activities are initiated until resolution is effectively made or resolution is certified. It may have been already determined or may be scheduled in the future. The same applies hereinafter.), the number of per-status influencing circumstance situation information, the number of influencing circumstance situation information where the number of members executing avoidance measures is within a predetermined range, and the number of influencing circumstance situation information where the resolution term exceeds the expected resolution term.

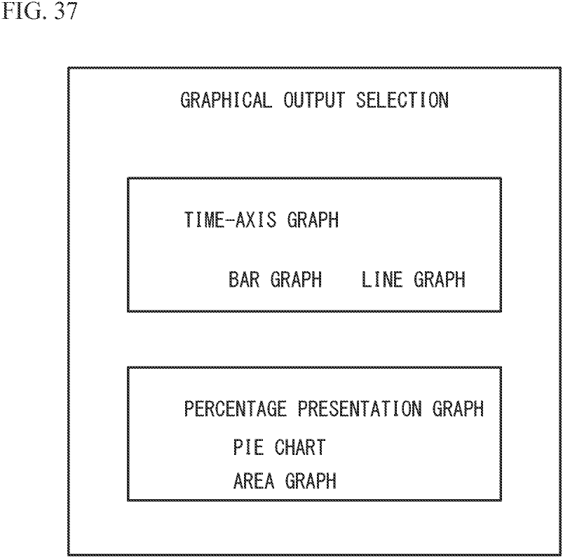

FIG. 37 is a diagram illustrating an example of a screen for selecting a mode of graphical output. For example, the graphical output includes two types of “time-axis graph” and “percentage presentation graph”. A concrete example of the “time-axis graph” includes “bar graph” and “line graph”. A concrete example of the “percentage presentation graph” includes “pie chart” and “area graph”.

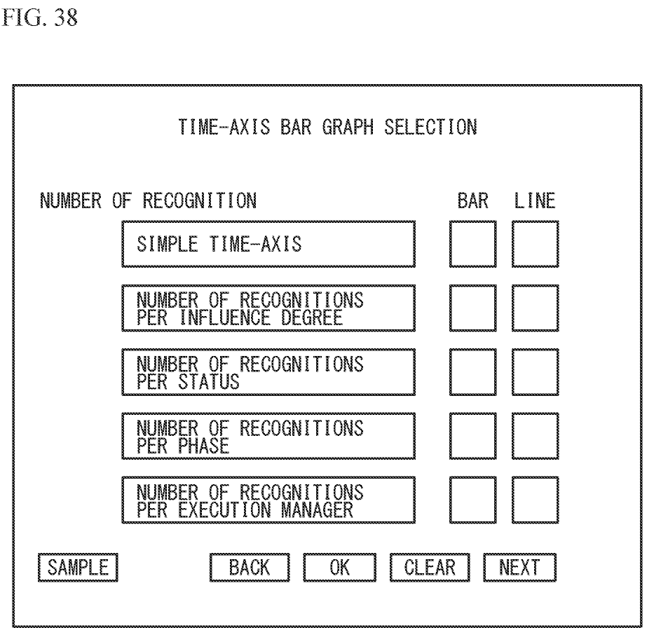

FIG. 38 is a diagram illustrating an example of a screen for selecting a time-axis bar graph. As illustrated in FIG. 38, “simple time-axis”, “number of recognitions of per-influence degree”, “number of recognitions of per-status”, “number of recognitions of per-phase” and “number of recognitions of per-execution manager” are considered as selection targets, and output formats such as “bar graph” and “line graph” are selected for them.

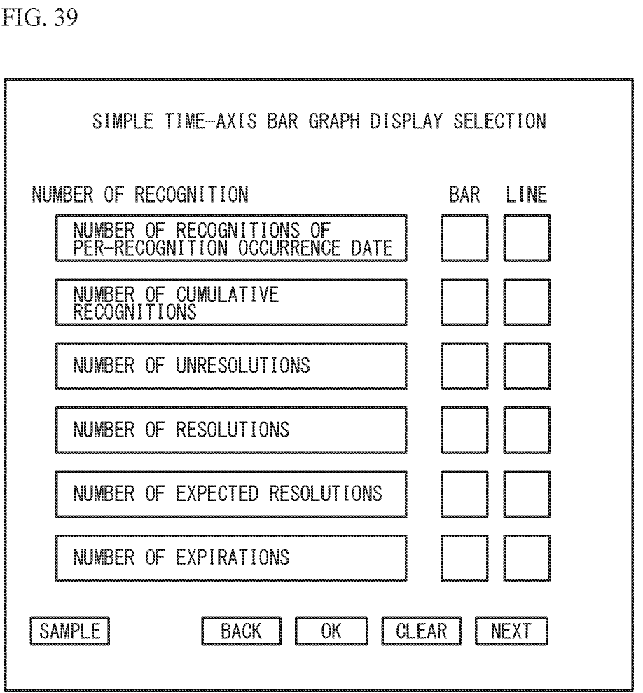

FIG. 39 is a diagram illustrating an example of a screen for selecting a simple time-axis graph display. As illustrated in FIG. 39, “number of recognitions of per-recognition occurrence date”, “number of cumulative recognitions”, “number of unresolutions”, “number of resolutions”, “number of expected resolutions”, and “number of expirations” are considered as selection targets, and output formats such as “bar graph” and “line graph” are selected for them.

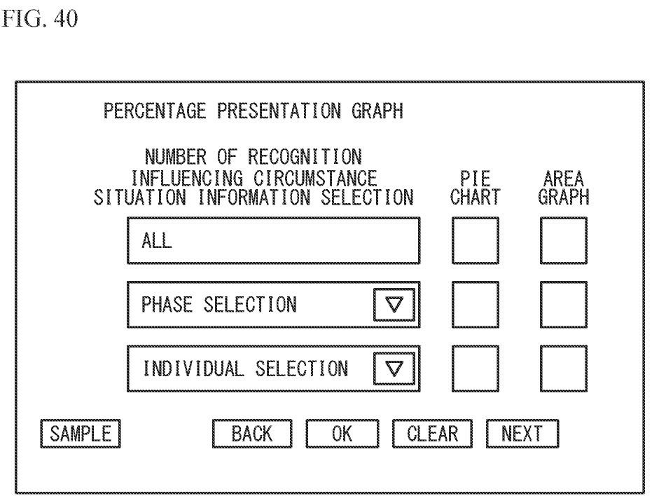

FIG. 40 is a diagram illustrating an example of a screen for selecting the percentage presentation graph. For example, “ALL”, “phase selection” and “individual selection” can be considered as “population selection/influencing circumstance situation information selection” output formats such as “bar graph” and “line graph” are selected for them. And in this example, options of each of “phase selection” and “individual selection” have been registered in advance and each option may input in a pull-down format.

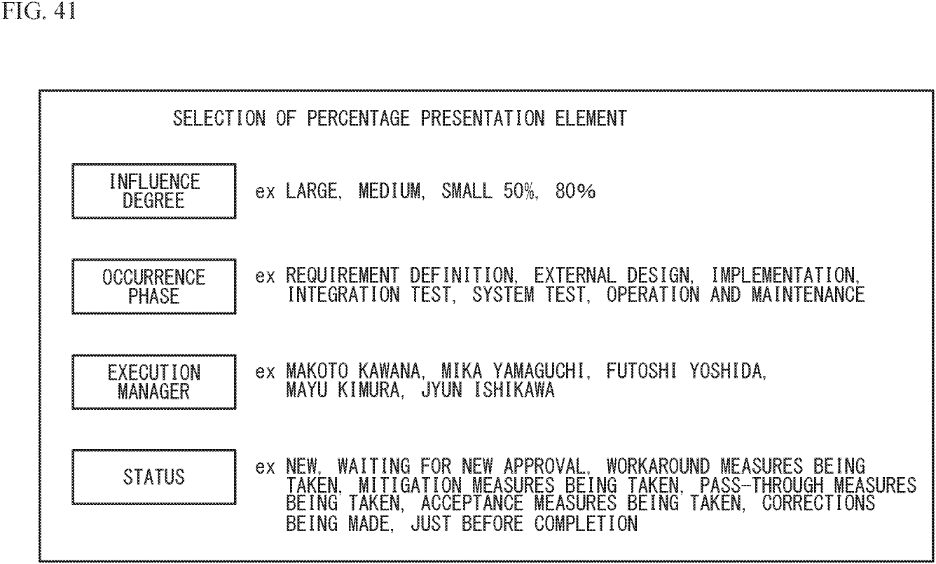

FIG. 41 is a diagram illustrating a screen for selecting a percentage presentation element when the percentage presentation graph is selected. For example, this screen includes selection targets such as “influence degree”, “occurrence phase”, “execution manager” and “status”. The “influence degree” may be indicated as large, medium, small, or indicated by “percentage” such as 50% and 80%. The “occurrence phase” may include requirement definition, external design, implementation, integration test, system test, operation and maintenance, and so on. The “execution manager” may be selected from among those registered in advance. The “status” may include options such as new, waiting for new approval, workaround measures being taken, mitigation measures being taken, pass-through measures being taken, acceptance measures being taken, corrections being made, and just before completion.

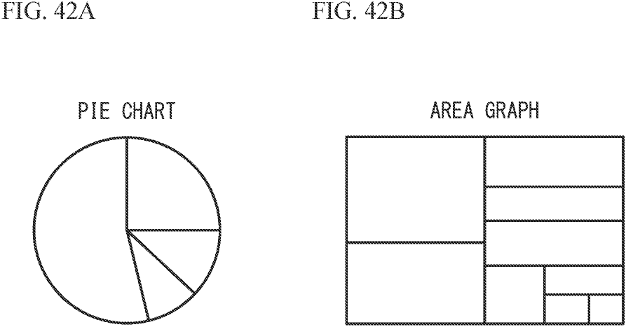

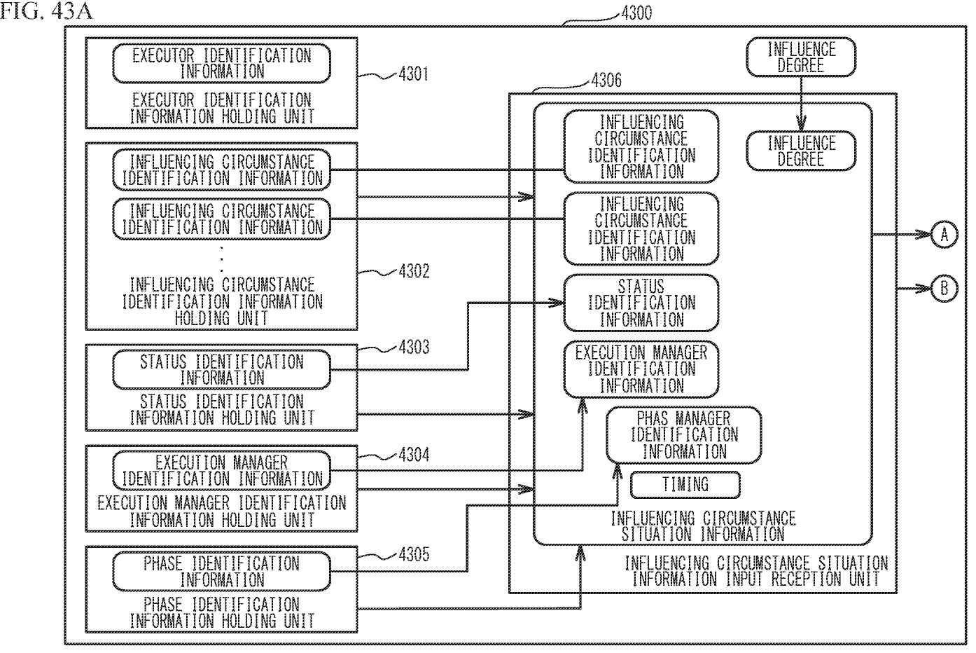

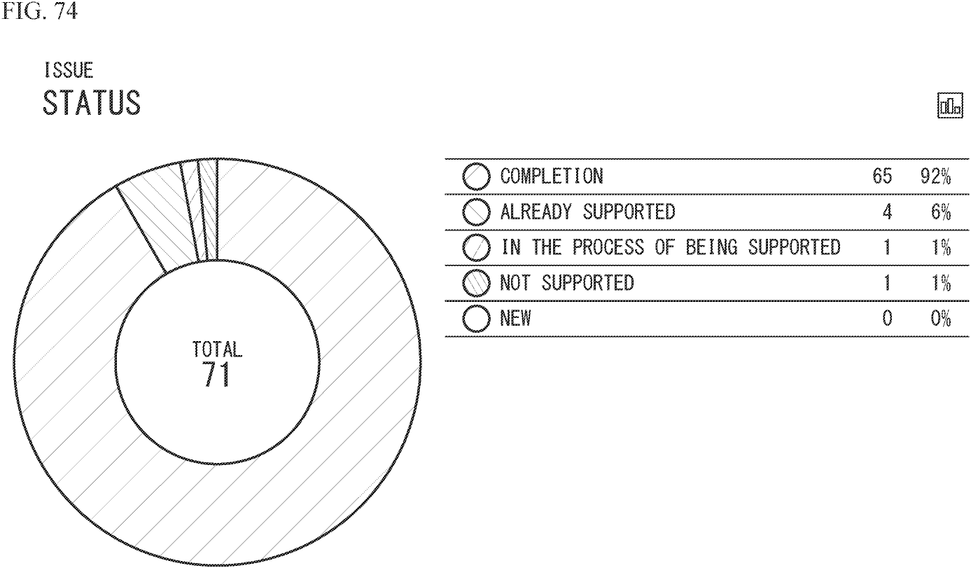

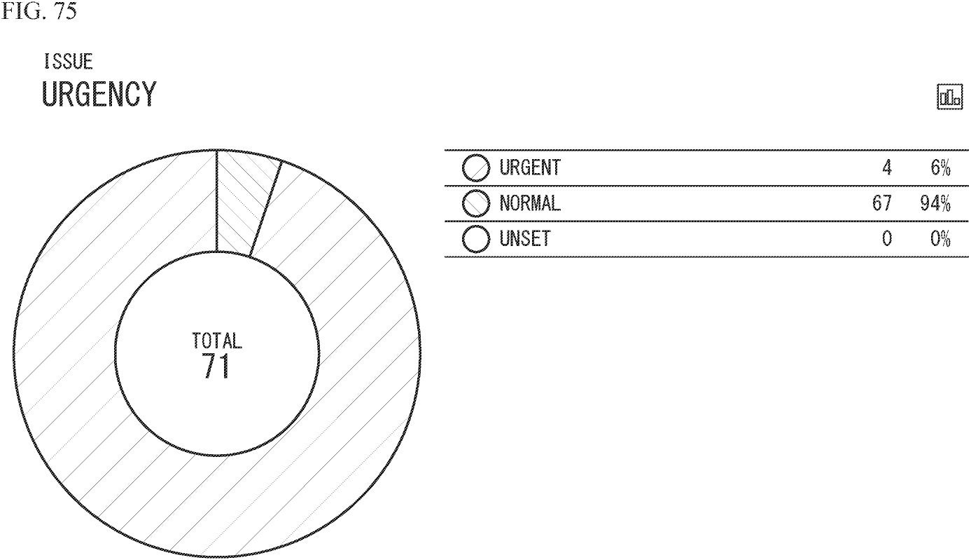

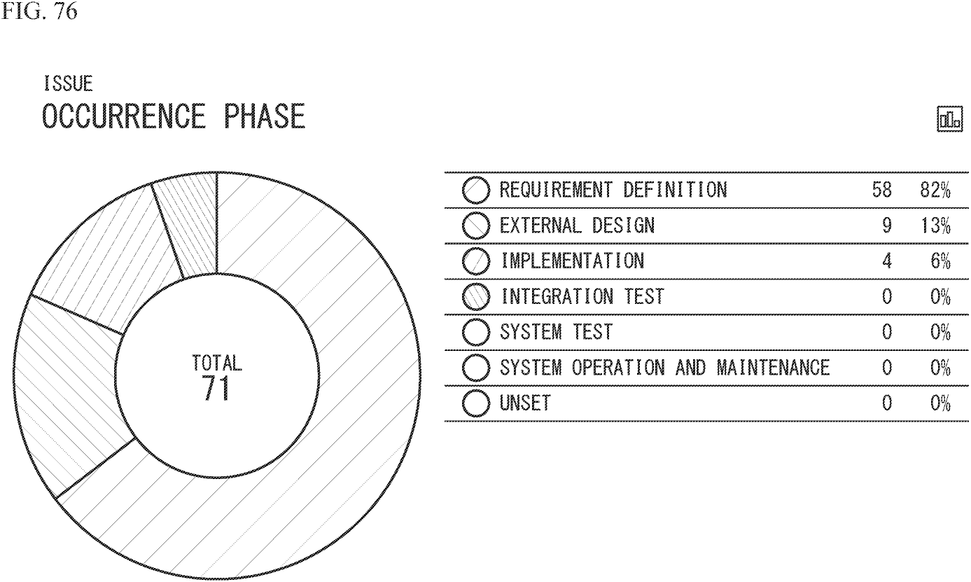

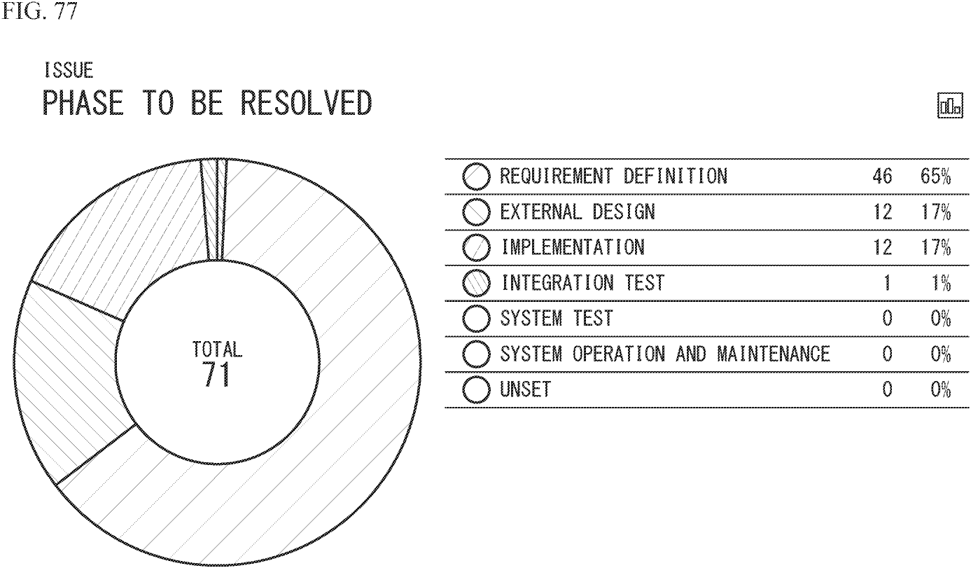

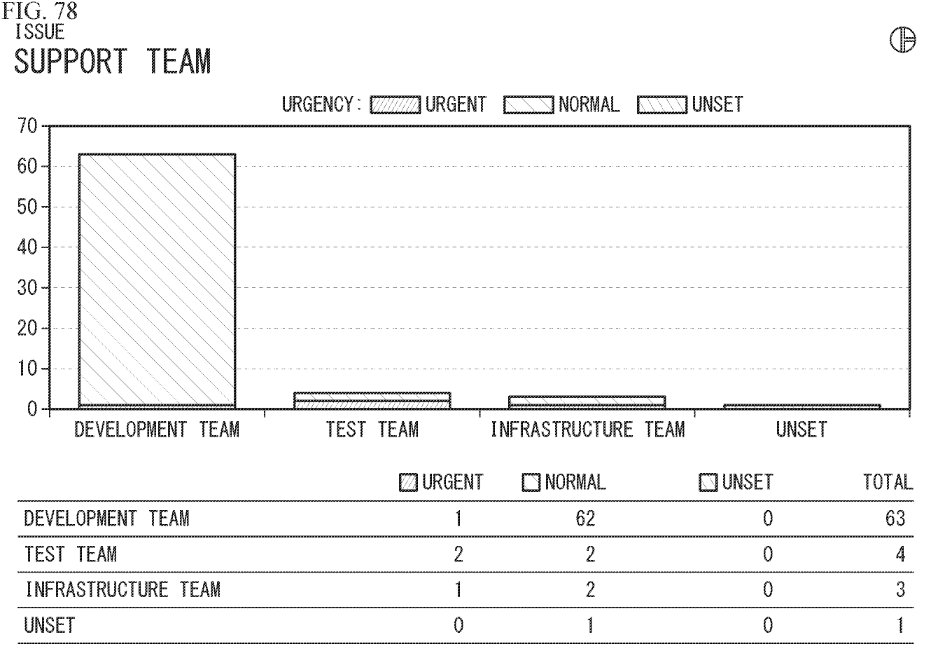

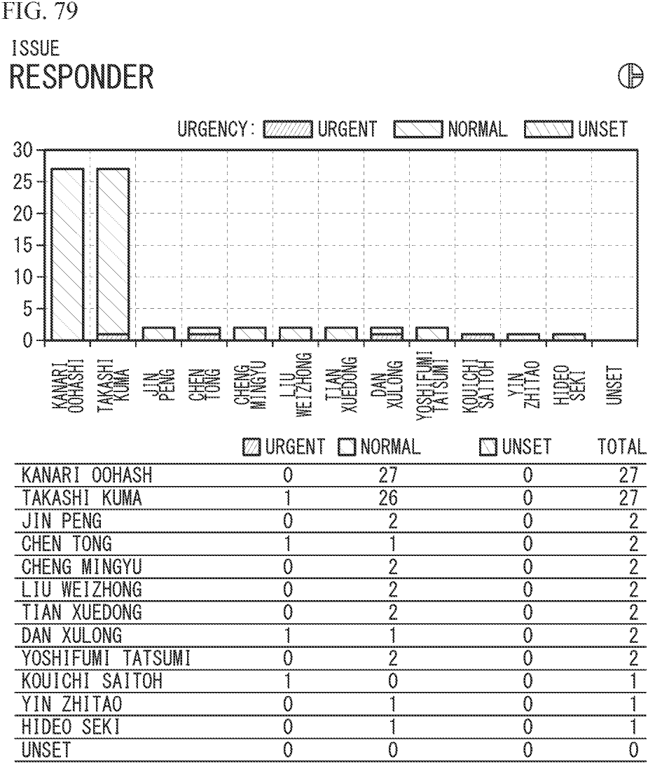

FIG. 42A is a diagram illustrating an example of the pie chart, and FIG. 42B is a diagram illustrating an example of the area graph. In the case of area graphs, it is possible to visually grasp what elements are large, rather than the exact differences between elements. FIGS. 74 to 77 are diagrams illustrating examples of the pie chart output by the graphical output unit A, and FIGS. 78 and 79 are diagrams illustrating examples of the bar graph output by the graphical output unit A.

Furthermore, the project management system may have a timing information acquisition unit. The “timing information acquisition unit” has a function of acquiring timing information related to timing such as the influencing circumstances and the phases.

### Eighth Embodiment; Hardware Configuration

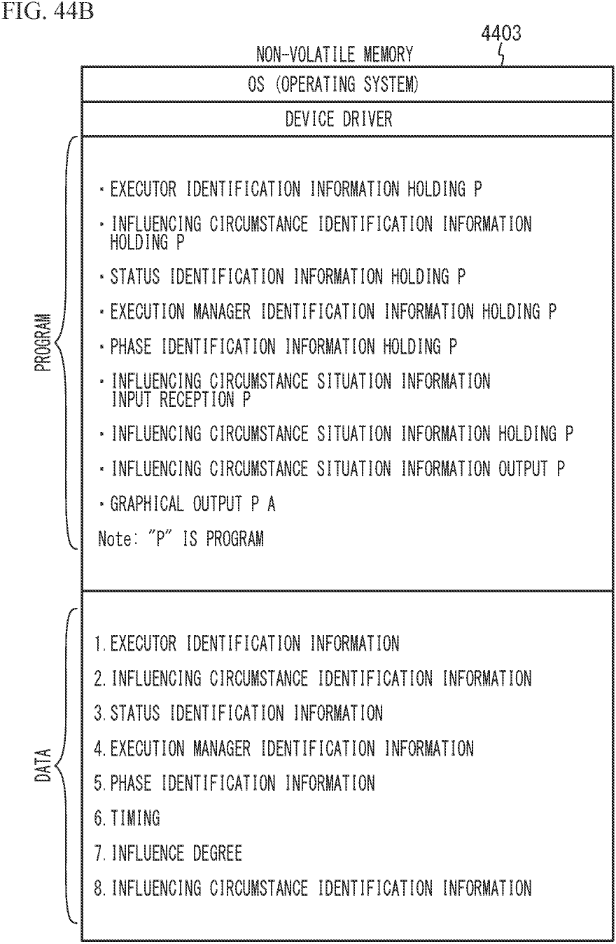

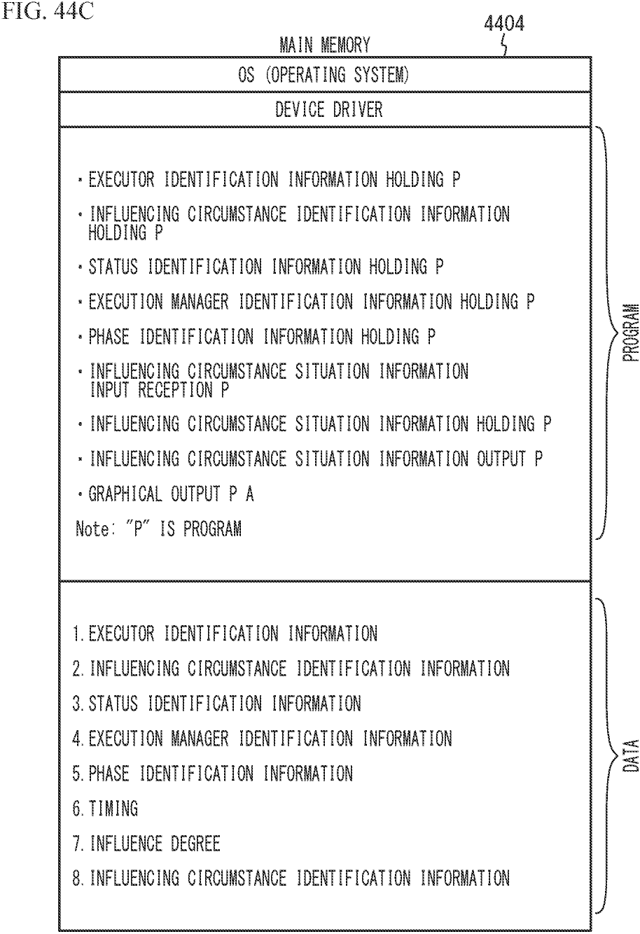

FIGS. 44A to 44C are diagrams illustrating an example of the hardware configuration of the project management system according to the eighth embodiment. The hardware configuration of the project management system in the present embodiment will be described with reference to FIGS. 44A to 44C.

As illustrated in FIGS. 44A to 44C, a computer includes a chipset (4410), a CPU (4401), a non-volatile memory (4403), a main memory (4404), various buses (4402a, 4402b, 4402c, 4402d, 4402e), a BIOS (4407), various interfaces (4405, 4406, 4408), a real-time clock (4409), and the like, which are configured on a motherboard. These work in conjunction with an operating system, device drivers, various programs, and so on. The various programs and various data constituting the present disclosure are configured to efficiently utilize these hardware resources to execute various processes.

As illustrated in FIGS. 44A to 44C, the non-volatile memory includes: a “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); an “executor identification information holding program” that holds executor identification information that identifies an executor of the project; an “influencing circumstance situation information holding program” that holds a plurality of types of influencing circumstance situation information that expresses the influencing circumstance that is a circumstance that influences the progress of the project recognized in the phase of the project; an “execution manager identification information holding program” that holds execution manager identification information that identifies an execution manager as an executor who is responsible for executing a workaround to avoid an adverse influence on the project due to the influencing circumstance; a “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); an “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; an “influencing circumstance situation information holding program” that holds the received influencing circumstance situation information; an “influencing circumstance situation information output program” that outputs the held influencing circumstance situation information; and a “graphical output program A” that graphically outputs a graph (line graph or bar graph) with one axis as the timing and another axis as the number of recognitions of the influencing circumstance situation information, using the held influencing circumstance situation information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Eighth Embodiment; Process Flow

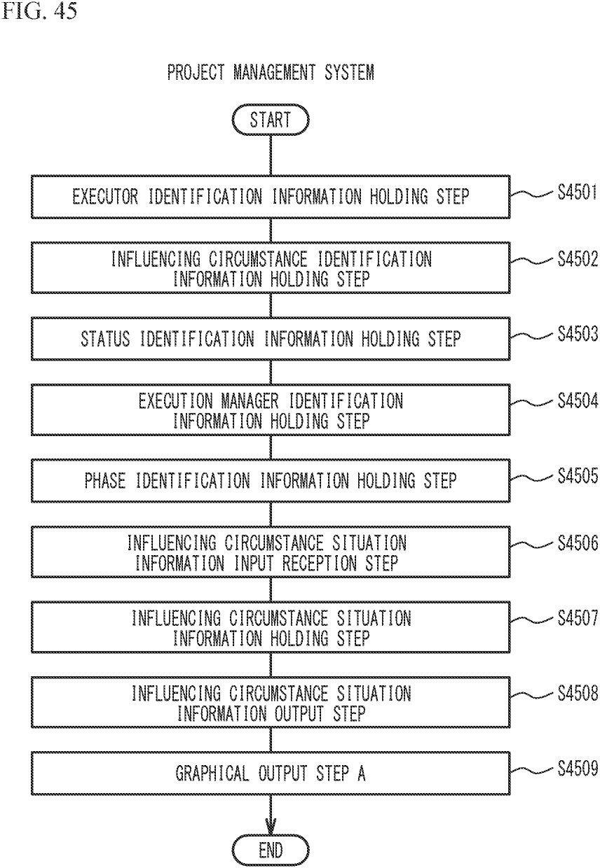

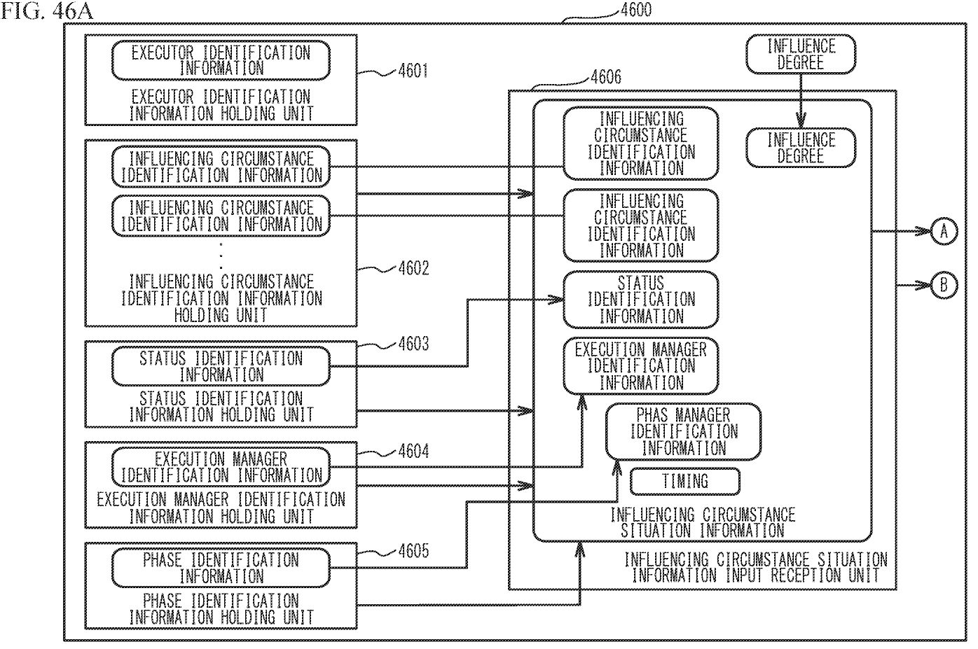

FIG. 45 is a flowchart illustrating the process when the project management system according to the present embodiment is used. The process flow of this embodiment is an operation method of the project management system which is a computer having a status identification information holding step (S4501), an executor identification information holding step (S4502), an influencing circumstance situation information holding step (S4503), an execution manager identification information holding step (S4504), a phase identification information holding step (S4505), an influencing circumstance situation information input reception step (S4506), an influencing circumstance situation information holding step (S4507), an influencing circumstance situation information output step (S4508), and a graphical output step A (S4509). Hereinafter, each step will be described below.

The “status identification information holding step” holds the status identification information that identifies the status (e.g., the information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.).

The “executor identification information holding step” holds executor identification information that identifies an executor of the project.

The “influencing circumstance situation information holding step” holds a plurality of types of influencing circumstance situation information that expresses the influencing circumstance that is a circumstance that influences the progress of the project recognized in the phase of the project.

The “execution manager identification information holding step” holds the execution manager identification information that identifies an execution manager as an executor who is responsible for executing a workaround to avoid an adverse influence on the project due to the influencing circumstance.

The “phase identification information holding step” holds the phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on).

The “influencing circumstance situation information input reception step” receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information.

The “influencing circumstance situation information holding step” holds the received influencing circumstance situation information.

The “influencing circumstance situation information output step” outputs the held influencing circumstance situation information.

The “graphical output step A” graphically outputs a graph (line graph or bar graph) with one axis as the timing and another axis as the number of recognitions of the influencing circumstance situation information, using the held influencing circumstance situation information.

### Ninth Embodiment

### Ninth Embodiment; Summary; Mainly Relating to Claims 2, 12 and 22

In addition to the eighth embodiment described above, the ninth embodiment provides a project management system in which the graphical output unit A has a function of graphically outputting a graph (line graph or bar graph) with one axis as the timing and another axis as the number of recognitions per influence degree of the influencing circumstance situation information, using the received per-phase influencing circumstance situation information.

### Ninth Embodiment; Functional Configuration

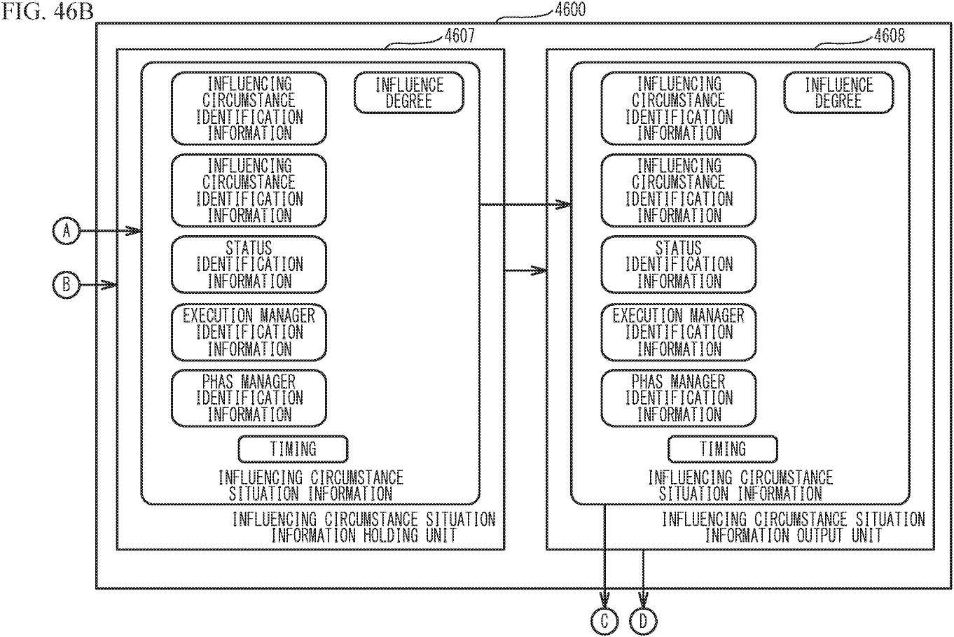

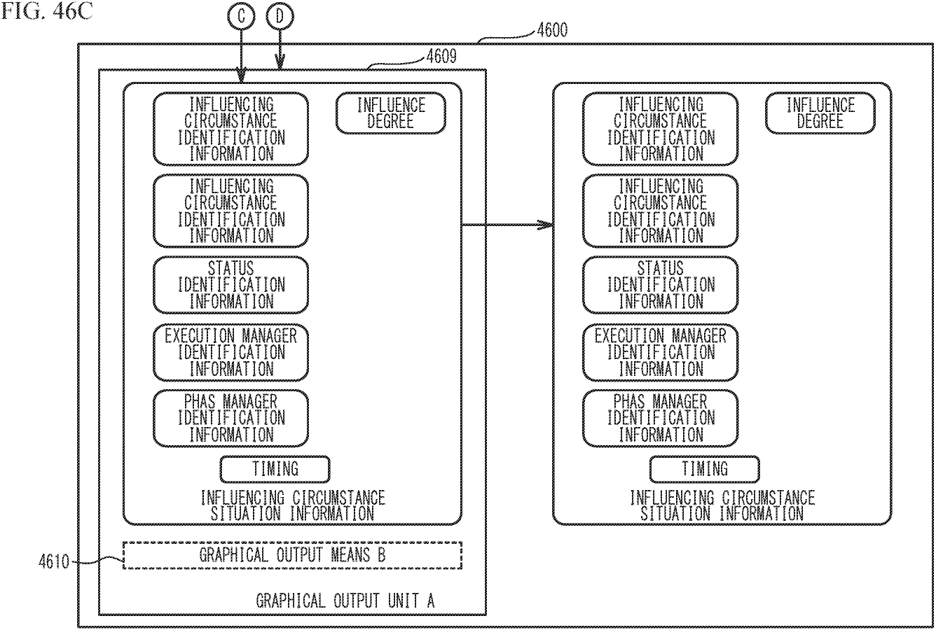

FIGS. 46A to 46C are diagrams illustrating a functional configuration of the present embodiment. The project management system (4600) of the present embodiment has a status identification information holding unit (4601), an executor identification information holding unit (4602), an influencing circumstance situation information holding unit (4603), an execution manager identification information holding unit (4604), a phase identification information holding unit (4605), an influencing circumstance situation information input reception unit (4606), an influencing circumstance situation information holding unit (4607), an influencing circumstance situation information output unit (4608), and a graphical output unit A (4609) having a graphical output means B (4610). Since the functions excluding the graphical output means B have already been described in the eighth embodiment, only the graphical output means B will be described below.

### Ninth Embodiment; Explanation of Configuration; Graphical Output Means B

The “graphical output means B” has a function of graphically outputting a graph (line graph or bar graph) with one axis as the timing and another axis as the number of recognitions per influence degree of the influencing circumstance situation information, using the received per-phase influencing circumstance situation information.

### Ninth Embodiment; Hardware Configuration

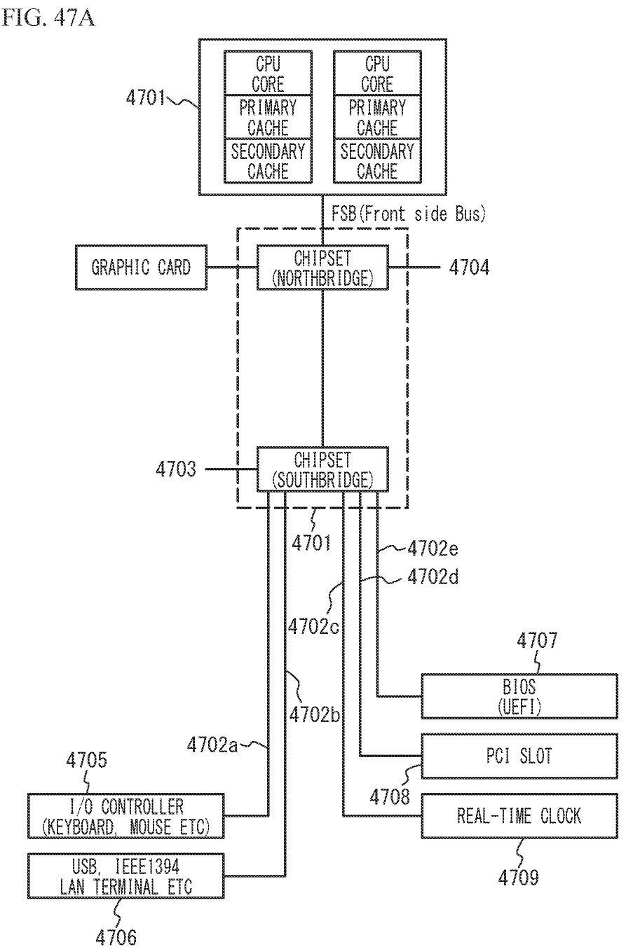

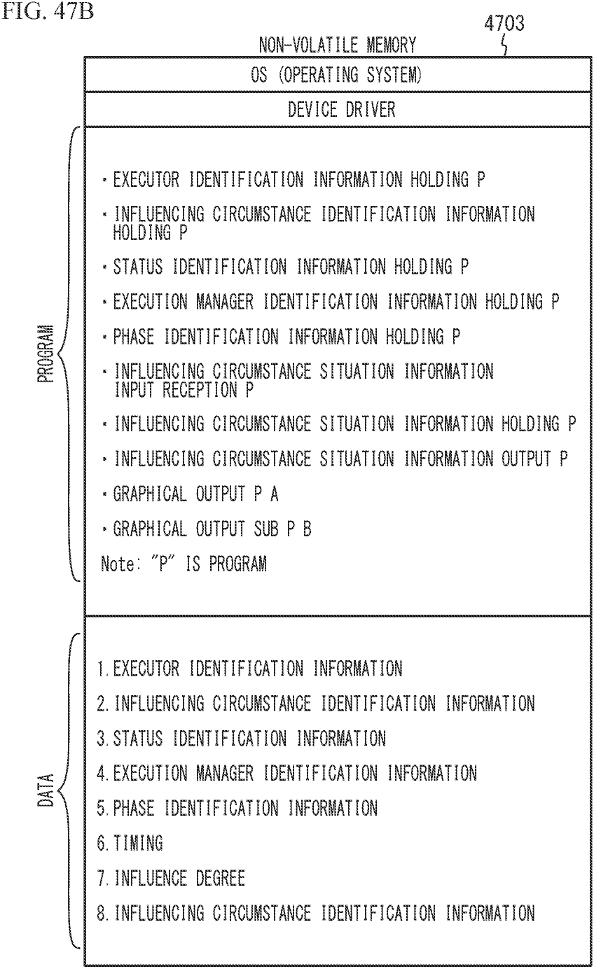

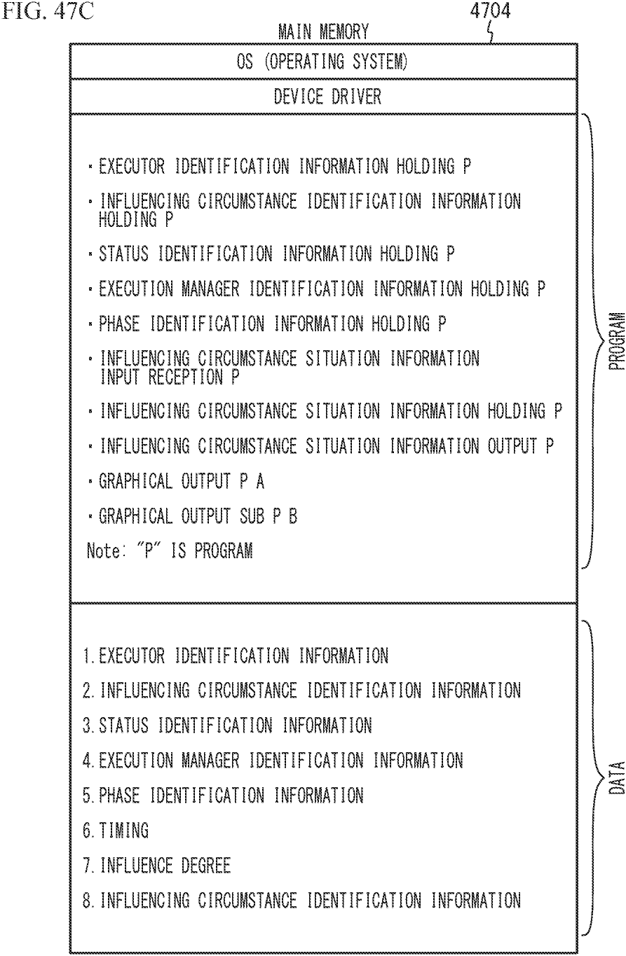

FIGS. 47A to 47C are diagrams illustrating a hardware configuration of the project management system according to the present embodiment. As illustrated in FIGS. 47A to 47C, the computer includes a chipset (4710), a CPU (4701), a non-volatile memory (4703), a main memory (4704), various buses (4702a, 4702b, 4702c, 4702d, 4702e), a BIOS (4707), various interfaces (4705, 4706, 4708), a real-time clock (4709), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 47A to 47C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; the “graphical output program A” that graphically outputs a graph (line graph or bar graph) with one axis as the timing and another axis as the number of recognitions of the influencing circumstance situation information, using the held influencing circumstance situation information; and a “graphical output subprogram B” that graphically outputs a graph (line graph or bar graph) with one axis as the timing and another axis as the number of recognitions per influence degree of the influencing circumstance situation information, using the received per-phase influencing circumstance situation information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Ninth Embodiment; Process Flow

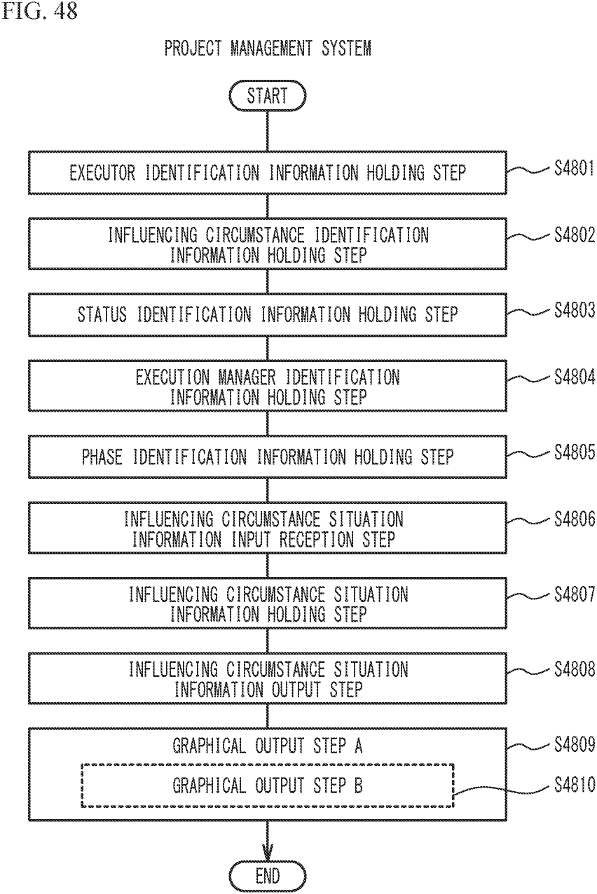

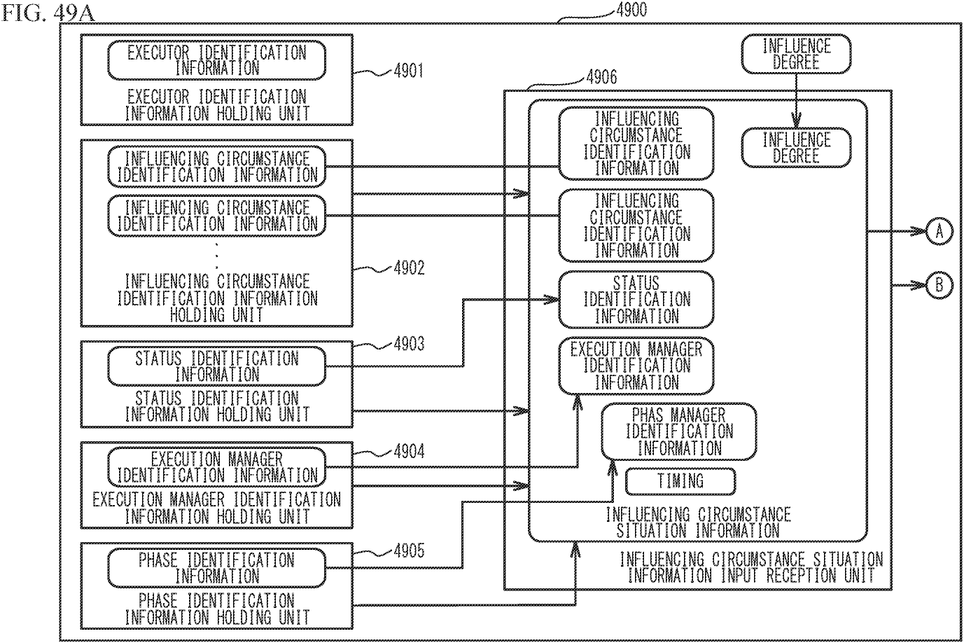

FIG. 48 is a flowchart illustrating the process when the project management system according to the present embodiment is used. The process flow of this embodiment is an operation method of the project management system which is a computer having a status identification information holding step (S4801), an executor identification information holding step (S4802), an influencing circumstance situation information holding step (S4803), an execution manager identification information holding step (S4804), a phase identification information holding step (S4805), an influencing circumstance situation information input reception step (S4806), an influencing circumstance situation information holding step (S4807), an influencing circumstance situation information output step (S4808), a graphical output step A (S4809), and a graphical output substep B (S4810). Each of these steps, except the graphical output substep B, is the same as that in the eighth embodiment. Hereinafter, the graphical output substep B will be described below.

The “graphical output substep B” graphically outputs a graph (line graph or bar graph) with one axis as the timing and another axis as the number of recognitions per influence degree of the influencing circumstance situation information, using the received per-phase influencing circumstance situation information.

### Tenth Embodiment

### Tenth Embodiment; Summary; Mainly Relating to Claims 3, 13 and 33

In addition to the eighth embodiment described above, a tenth embodiment provides a project management system in which the graphical output unit A has a function of graphically outputting a graph (line graph or bar graph) with one axis as the timing and another axis as the number of cases per status of the influencing circumstance situation information, using the received per-phase influencing circumstance situation information.

### Tenth Embodiment; Functional Configuration

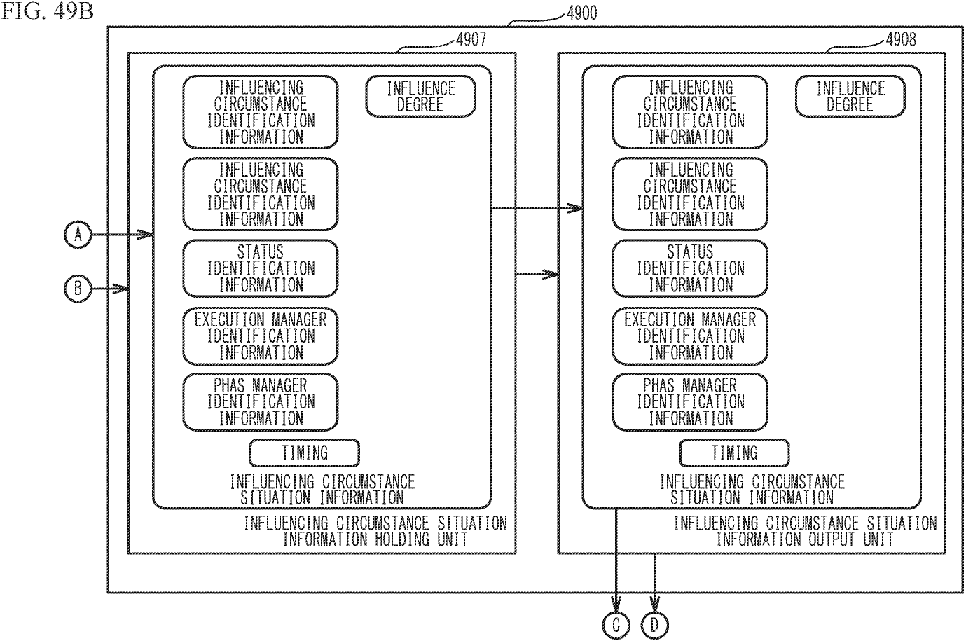

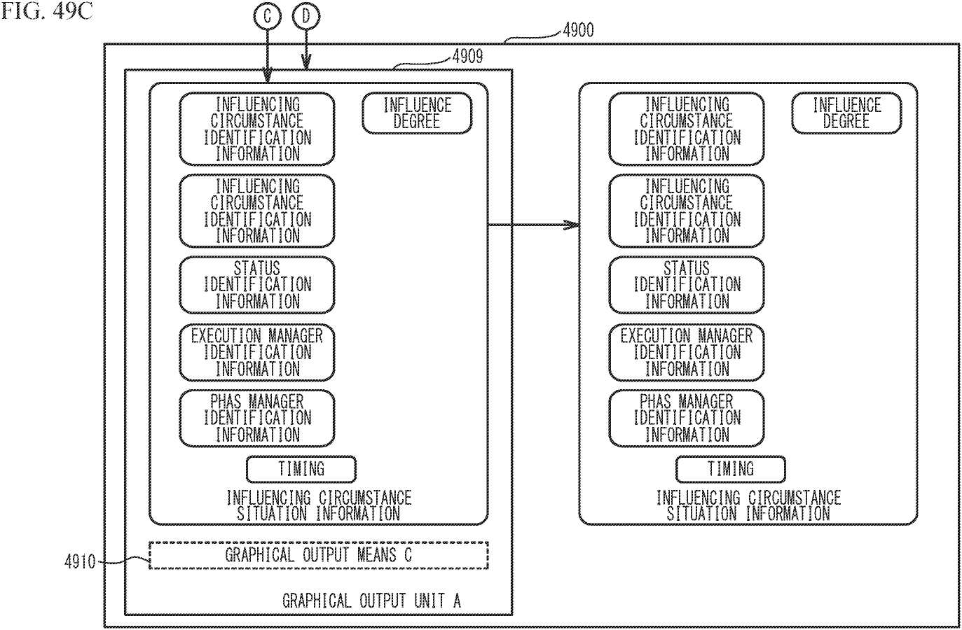

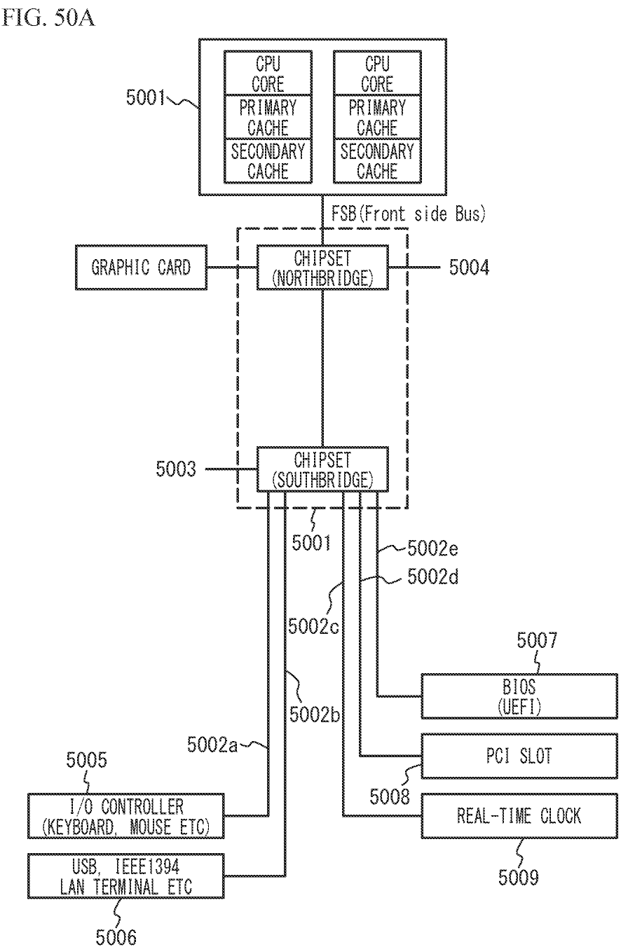

FIGS. 49A to 49C are diagrams illustrating a functional configuration of the present embodiment. The project management system (4900) of the present embodiment has a status identification information holding unit (4901), an executor identification information holding unit (4902), an influencing circumstance situation information holding unit (4903), an execution manager identification information holding unit (4904), a phase identification information holding unit (4905), an influencing circumstance situation information input reception unit (4906), an influencing circumstance situation information holding unit (4907), an influencing circumstance situation information output unit (4908), and a graphical output unit A (4909) having a graphical output means C (4910). Since the functions excluding the graphical output means C have already been described in the eighth embodiment, only the graphical output means C will be described below.

### Tenth Embodiment; Explanation of Configuration; Graphical Output Means C

The “graphical output means C” has a function of graphically outputting a graph (line graph or bar graph) with one axis as the timing and another axis as the number of cases per status of the influencing circumstance situation information, using the received per-phase influencing circumstance situation information.

### Tenth Embodiment; Hardware Configuration

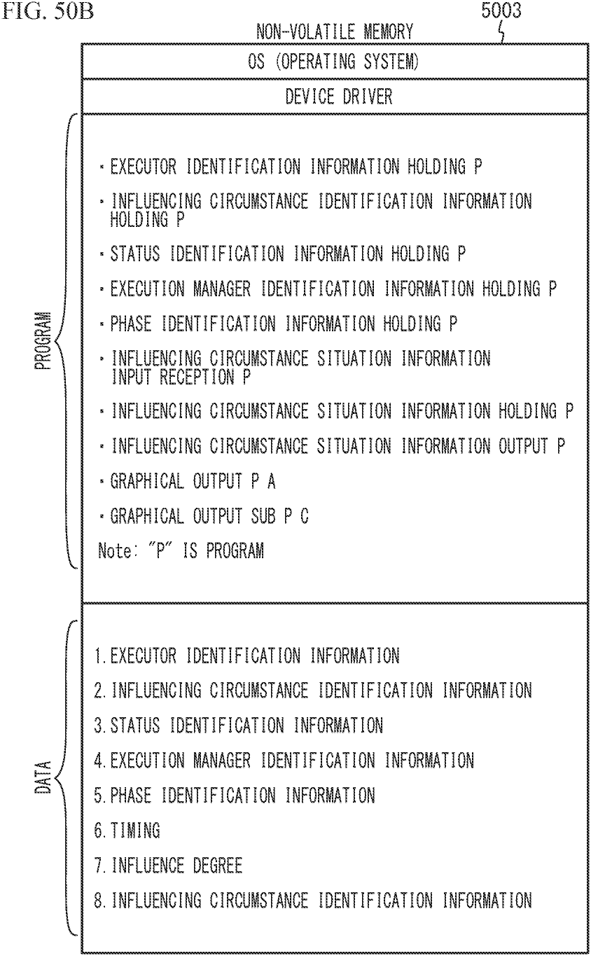

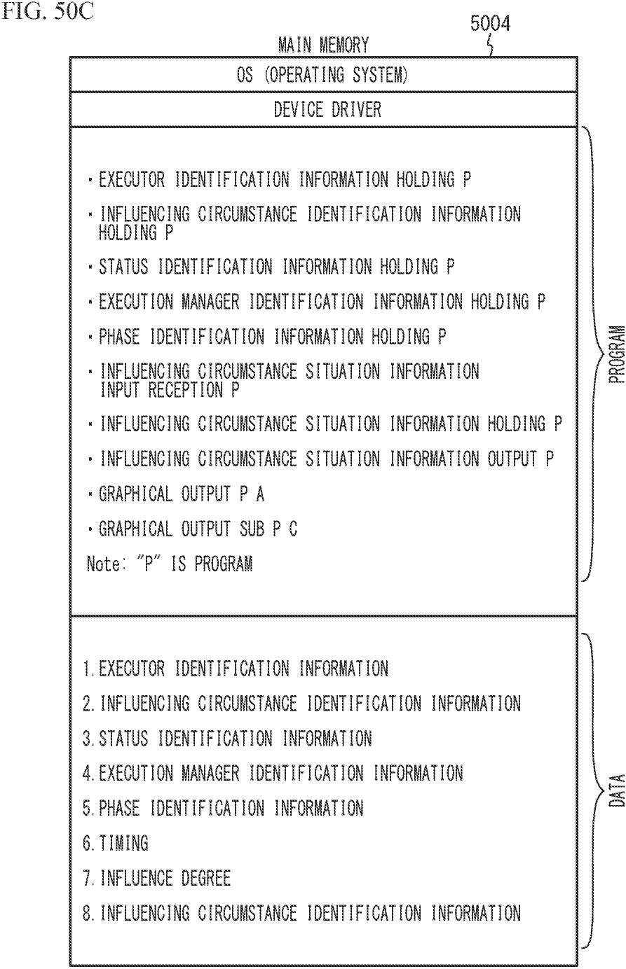

FIGS. 50A to 50C are diagrams illustrating a hardware configuration of the project management system according to the present embodiment. As illustrated in FIGS. 50A to 50C, the computer includes a chipset (5010), a CPU (5001), a non-volatile memory (5003), a main memory (5004), various buses (5002a, 5002b, 5002c, 5002d, 5002e), a BIOS (5007), various interfaces (5005, 5006, 5008), a real-time clock (5009), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 50A to 50C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; the “graphical output program A” that graphically outputs a graph (line graph or bar graph) with one axis as the timing and another axis as the number of recognitions of the influencing circumstance situation information, using the held influencing circumstance situation information; and a “graphical output subprogram C” that graphically outputs a graph (line graph or bar graph) with one axis as the timing and another axis as the number of cases per status of the influencing circumstance situation information, using the received per-phase influencing circumstance situation information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Tenth Embodiment; Process Flow

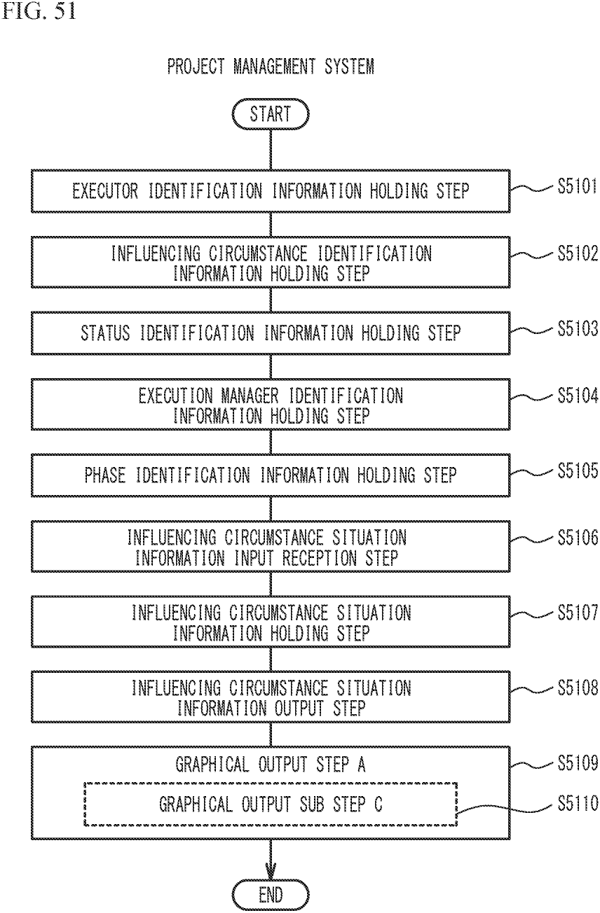

FIG. 51 is a flowchart illustrating the process when the project management system according to the present embodiment is used. The process flow of this embodiment is an operation method of the project management system which is a computer having a status identification information holding step (S5101), an executor identification information holding step (S5102), an influencing circumstance situation information holding step (S5103), an execution manager identification information holding step (S5104), a phase identification information holding step (S5105), an influencing circumstance situation information input reception step (S5106), an influencing circumstance situation information holding step (S5107), an influencing circumstance situation information output step (S5108), a graphical output step A (S5109), and a graphical output substep C (S5110). Each of these steps, except the graphical output substep C, is the same as that in the eighth embodiment. Hereinafter, the graphical output substep C will be described below.

The “graphical output substep C” graphically outputs a graph (line graph or bar graph) with one axis as the timing and another axis as the number of cases per status of the influencing circumstance situation information, using the received per-phase influencing circumstance situation information.

### Eleventh Embodiment

### Eleventh Embodiment; Summary; Mainly Relating to Claims 4, 14 and 34

In addition to the eighth embodiment described above, an eleventh embodiment provides a project management system in which the graphical output unit A has a function of displaying the graphical output per phase identified by the phase identification information included in the influencing circumstance situation information.

### Eleventh Embodiment; Functional Configuration

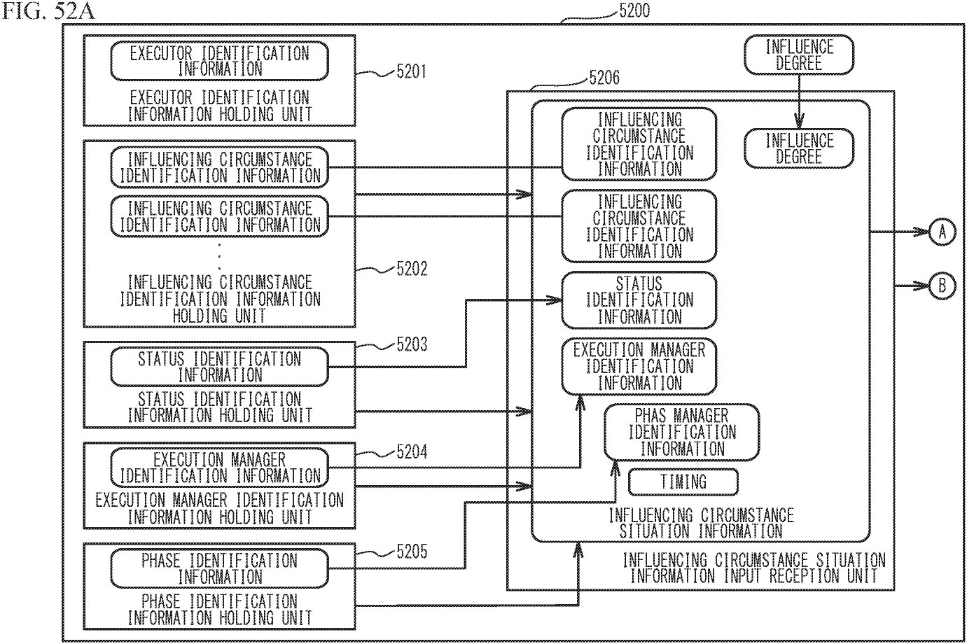

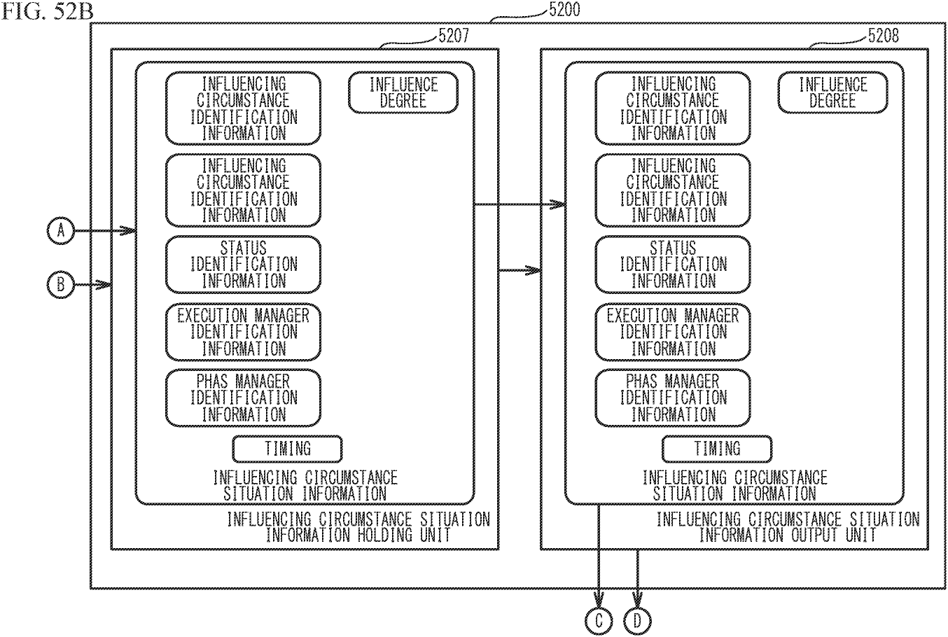

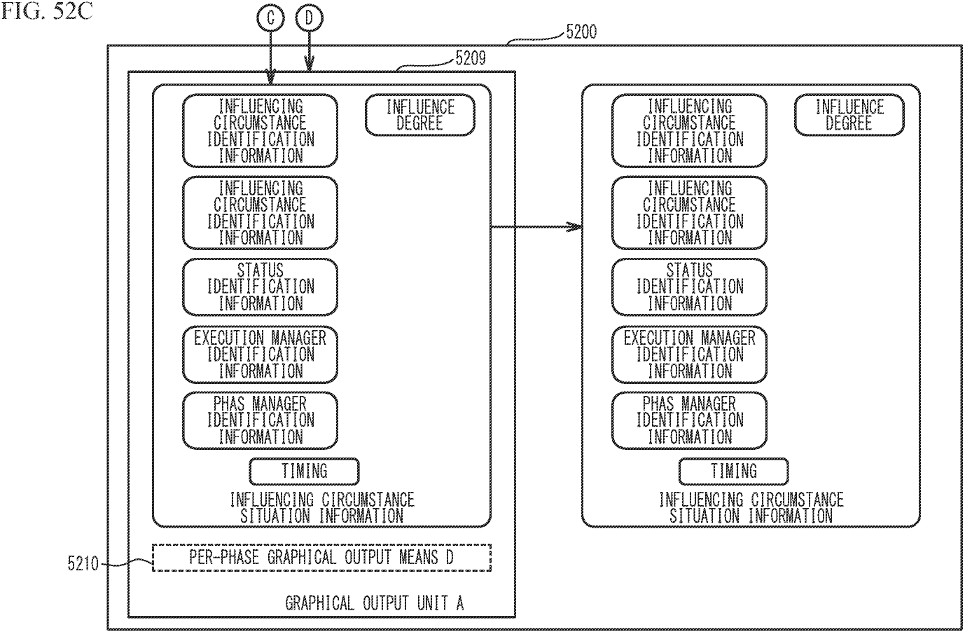

FIGS. 52A to 52C are diagrams illustrating a functional configuration of the present embodiment. The project management system (5200) of the present embodiment has a status identification information holding unit (5201), an executor identification information holding unit (5202), an influencing circumstance situation information holding unit (5203), an execution manager identification information holding unit (5204), a phase identification information holding unit (5205), an influencing circumstance situation information input reception unit (5206), an influencing circumstance situation information holding unit (5207), an influencing circumstance situation information output unit (5208), and a graphical output unit A (5209) having a per-phase graphical output means D (5210). Since the functions excluding the per-phase graphical output means D have already been described in the eighth embodiment, only the per-phase graphical output means D will be described below.

### Eleventh Embodiment; Explanation of Configuration; Per-Phase Graphical Output Means D

The “per-phase graphical output means D” has, in the graphical output unit, a function of displaying the graphical output per phase identified by the phase identification information included in the influencing circumstance situation information.

### Eleventh Embodiment; Hardware Configuration

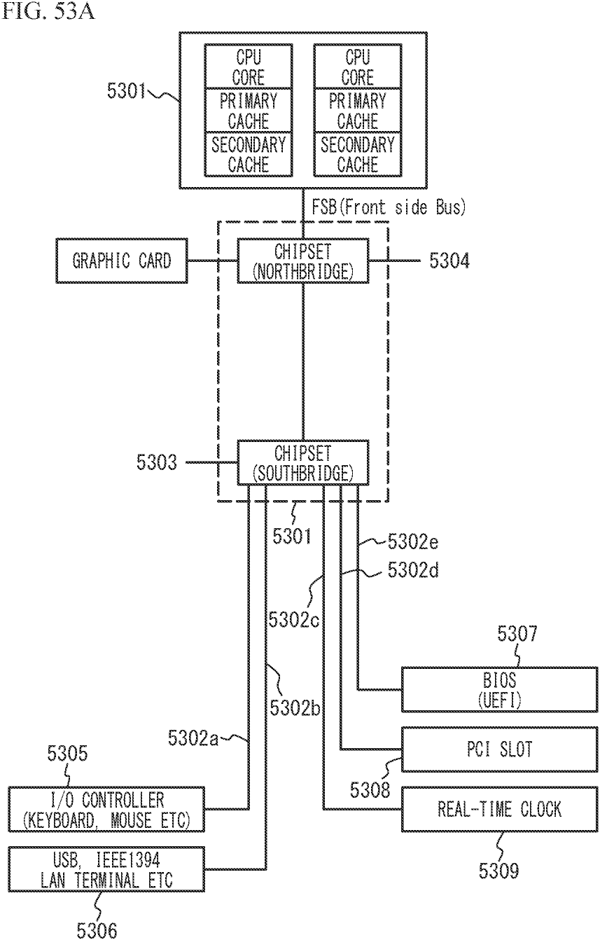

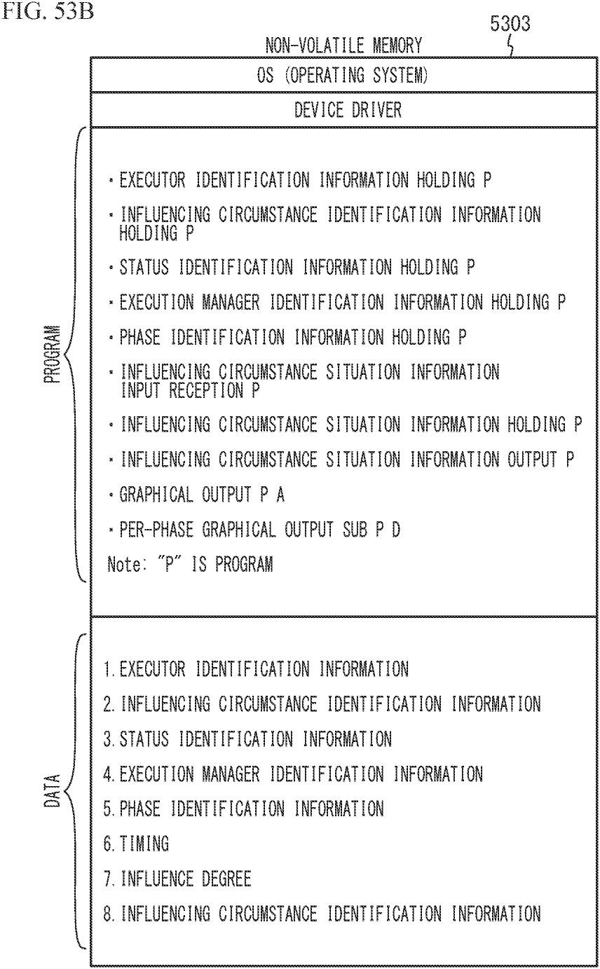

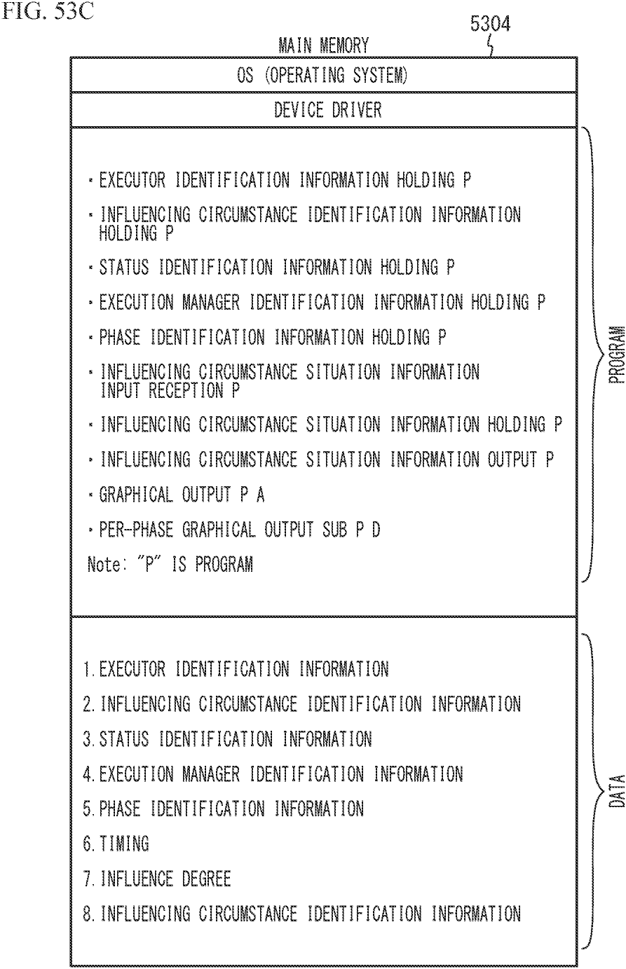

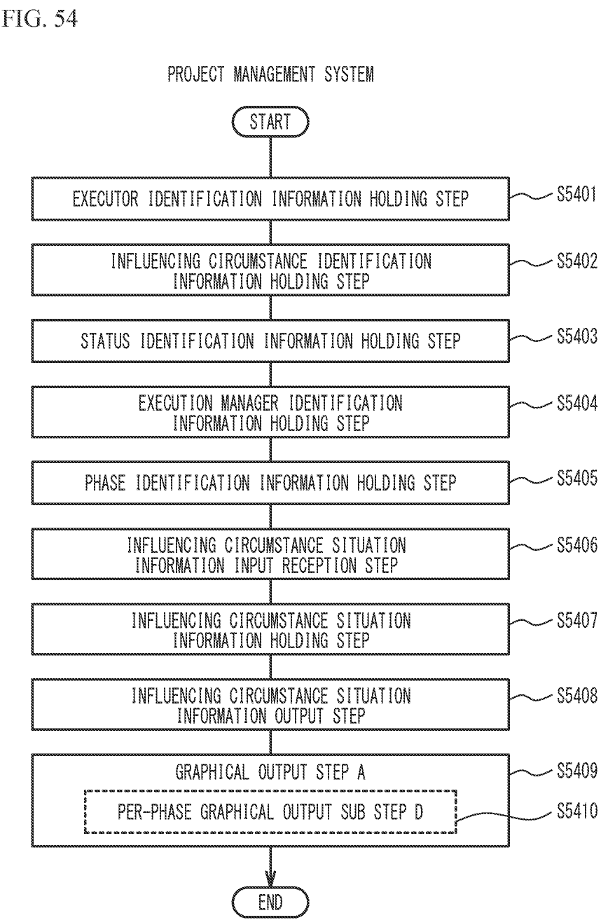

FIGS. 53A to 53C are diagrams illustrating a hardware configuration of the project management system according to the present embodiment. As illustrated in FIGS. 53A to 53C, the computer includes a chipset (5310), a CPU (5301), a non-volatile memory (5303), a main memory (5304), various buses (5302a, 5302b, 5302c, 5302d, 5302e), a BIOS (5307), various interfaces (5305, 5306, 5308), a real-time clock (5309), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 53A to 53C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; the “graphical output program A” that graphically outputs a graph (line graph or bar graph) with one axis as the timing and another axis as the number of recognitions of the influencing circumstance situation information, using the held influencing circumstance situation information; and a “per-phase graphical output subprogram D” that displays the graphical output per phase identified by the phase identification information included in the influencing circumstance situation information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Eleventh Embodiment; Process Flow

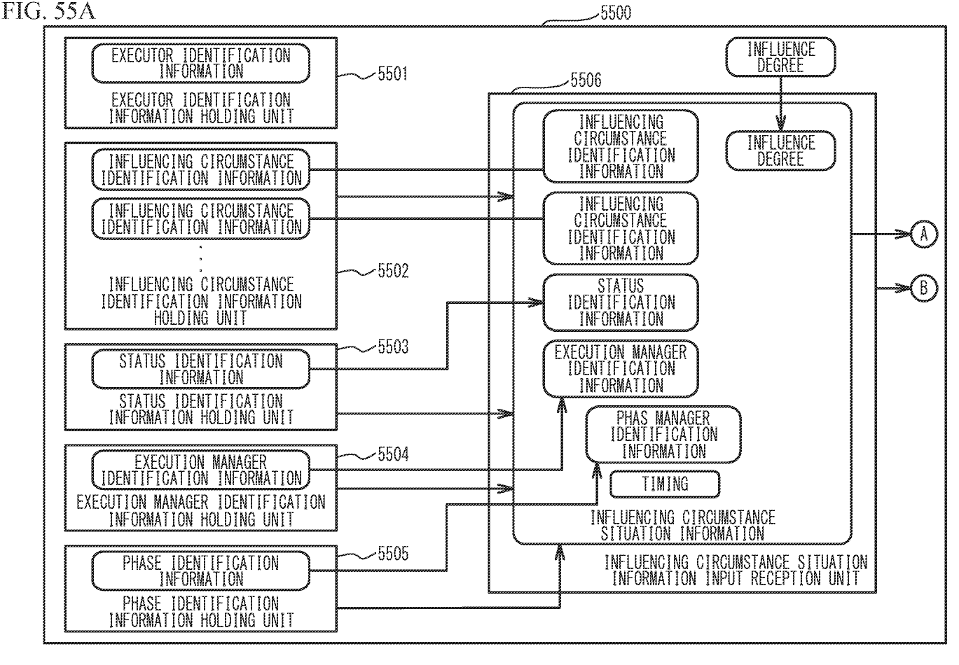

FIG. 54 is a flowchart illustrating the process when the project management system according to the present embodiment is used. The process flow of this embodiment is an operation method of the project management system which is a computer having a status identification information holding step (S5401), an executor identification information holding step (S5402), an influencing circumstance situation information holding step (S5403), an execution manager identification information holding step (S5404), a phase identification information holding step (S5405), an influencing circumstance situation information input reception step (S5406), an influencing circumstance situation information holding step (S5407), an influencing circumstance situation information output step (S5408), a graphical output step A (S5409), and a per-phase graphical output substep D (S5410). Each of these steps, except the per-phase graphical output substep D, is the same as that in the eighth embodiment. Hereinafter, the per-phase graphical output substep D will be described below.

The “per-phase graphical output substep D” displays the graphical output by the graphical output step per phase identified by the phase identification information included in the influencing circumstance situation information.

### Twelfth Embodiment

### Twelfth Embodiment; Summary; Mainly Relating to Claims 5, 15 and 35

In addition to the eighth embodiment described above, a twelfth embodiment provides a project management system in which the graphical output unit A has a function of displaying the graphical output per execution manager identified by the execution manager identification information included in the influencing circumstance situation information.

### Twelfth Embodiment; Functional Configuration

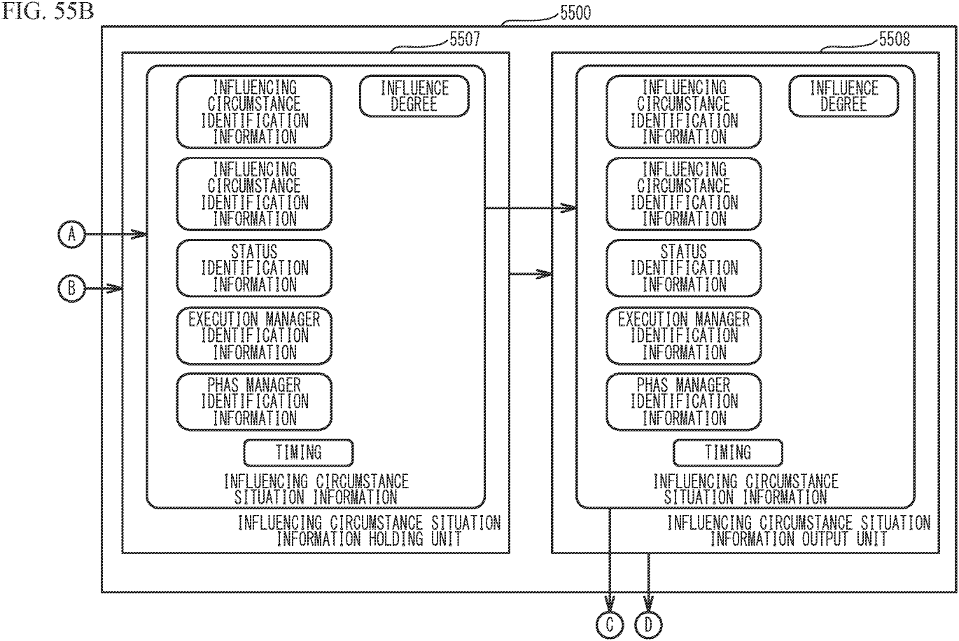

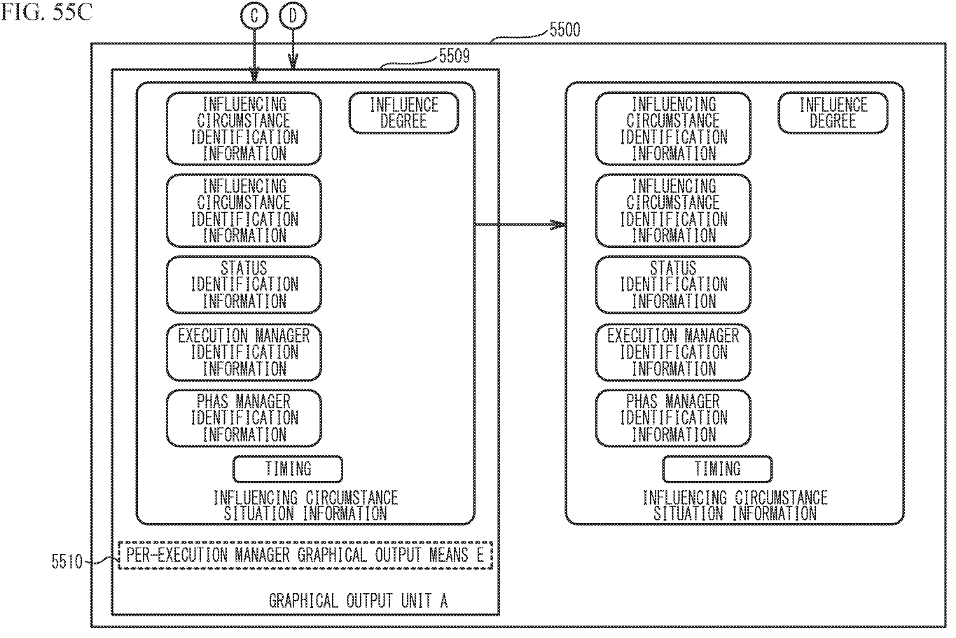

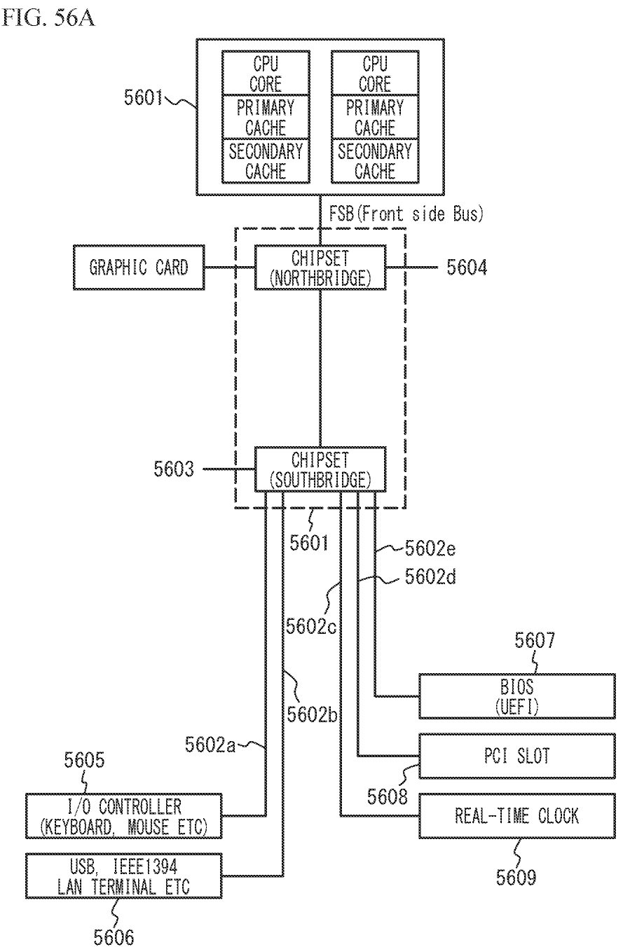

FIGS. 55A to 55C are diagrams illustrating a functional configuration of the present embodiment. The project management system (5500) of the present embodiment has a status identification information holding unit (5501), an executor identification information holding unit (5502), an influencing circumstance situation information holding unit (5503), an execution manager identification information holding unit (5504), a phase identification information holding unit (5505), an influencing circumstance situation information input reception unit (5506), an influencing circumstance situation information holding unit (5507), an influencing circumstance situation information output unit (5508), and a graphical output unit A (5509) having a per-execution manager graphical output means E (5510). Since the functions excluding the per-execution manager graphical output means E have already been described in the eighth embodiment, only the per-execution manager graphical output means E will be described below.

### Twelfth Embodiment; Explanation of Configuration; Per-Execution Manager Graphical Output Means E

The “per-execution manager graphical output means E” has, in the graphical output unit, a function of displaying the graphical output per execution manager identified by the execution manager identification information included in the influencing circumstance situation information.

### Twelfth Embodiment; Hardware Configuration

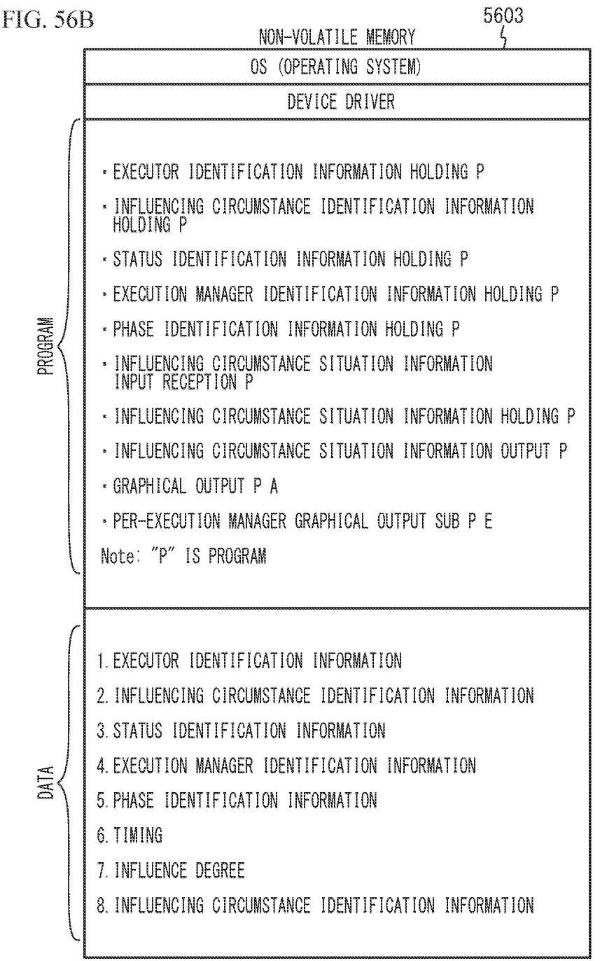

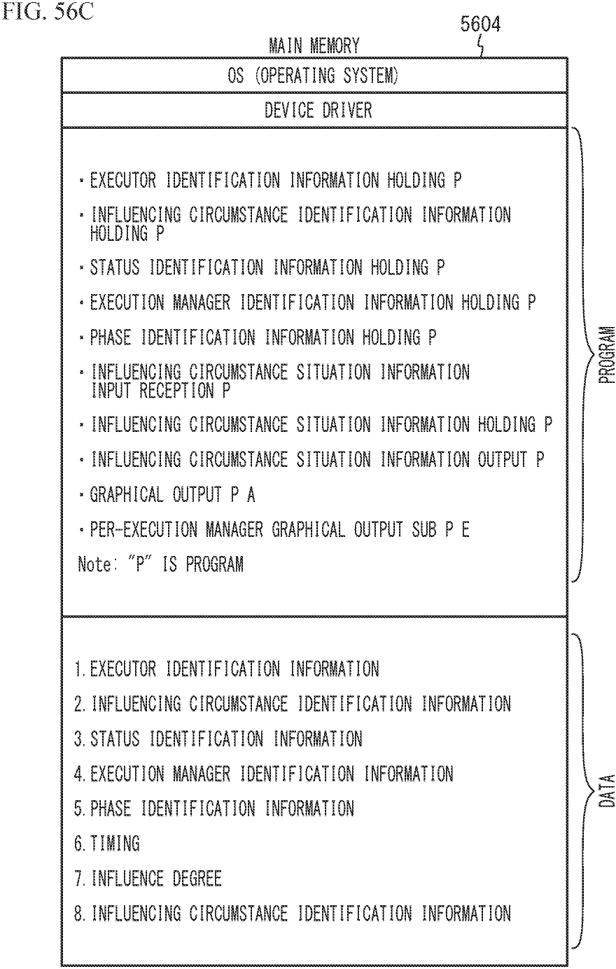

FIGS. 56A to 56C are diagrams illustrating a hardware configuration of the project management system according to the present embodiment. As illustrated in FIGS. 56A to 56C, the computer includes a chipset (5610), a CPU (5601), a non-volatile memory (5603), a main memory (5604), various buses (5602a, 5602b, 5602c, 5602d, 5602e), a BIOS (5607), various interfaces (5605, 5606, 5608), a real-time clock (5609), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 56A to 56C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; the “graphical output program A” that graphically outputs a graph (line graph or bar graph) with one axis as the timing and another axis as the number of recognitions of the influencing circumstance situation information, using the held influencing circumstance situation information; and a “per-execution manager graphical output subprogram E” that displays the graphical output per execution manager identified by the execution manager identification information included in the influencing circumstance situation information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Twelfth Embodiment; Process Flow

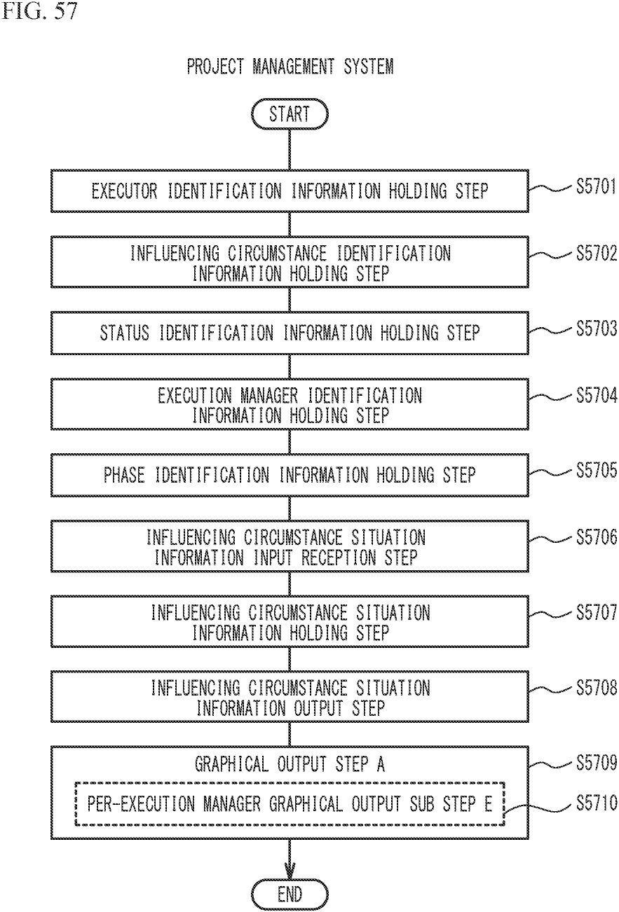

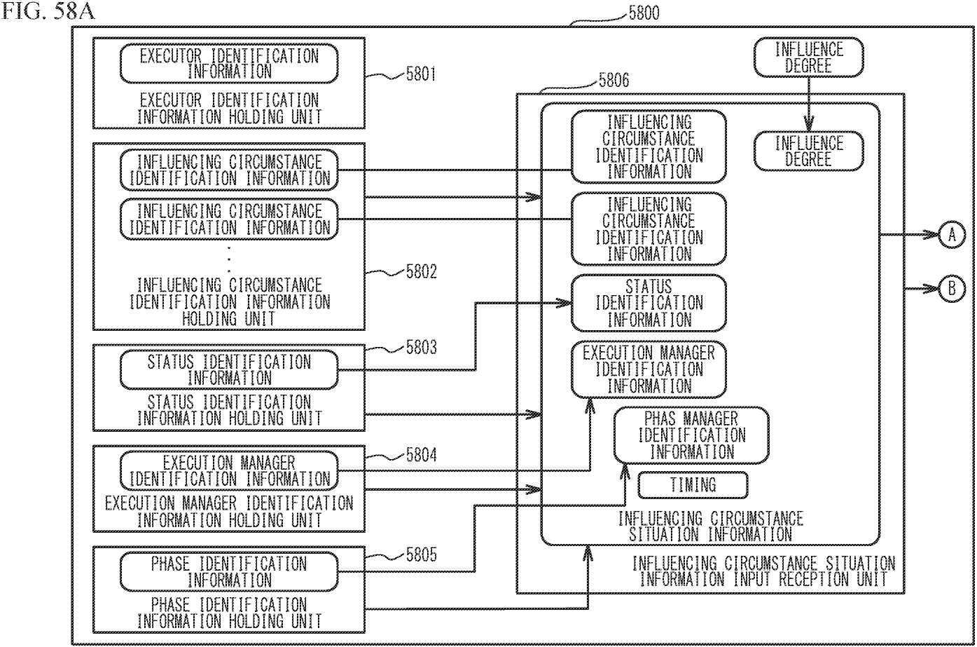

FIG. 57 is a flowchart illustrating the process when the project management system according to the present embodiment is used. The process flow of this embodiment is an operation method of the project management system which is a computer having a status identification information holding step (S5701), an executor identification information holding step (S5702), an influencing circumstance situation information holding step (S5703), an execution manager identification information holding step (S5704), a phase identification information holding step (S5705), an influencing circumstance situation information input reception step (S5706), an influencing circumstance situation information holding step (S5707), an influencing circumstance situation information output step (S5708), a graphical output step A (S5709), and a per-execution manager graphical output substep E (S5710). Each of these steps, except the per-execution manager graphical output substep E, is the same as that in the eighth embodiment. Hereinafter, the per-execution manager graphical output substep E will be described below.

The “per-execution manager graphical output substep E” displays, in the graphical output step, the graphical output per execution manager identified by the execution manager identification information included in the influencing circumstance situation information.

### Thirteenth Embodiment

### Thirteenth Embodiment; Summary; Mainly Relating to Claims 6, 16 and 36

A thirteenth embodiment provides a project management system having a function of outputting a pie chart indicating the number of pieces of influencing circumstance situation information per status as a ratio by setting the total number of pieces of held influencing circumstance situation information as a whole.

### Thirteenth Embodiment; Functional Configuration

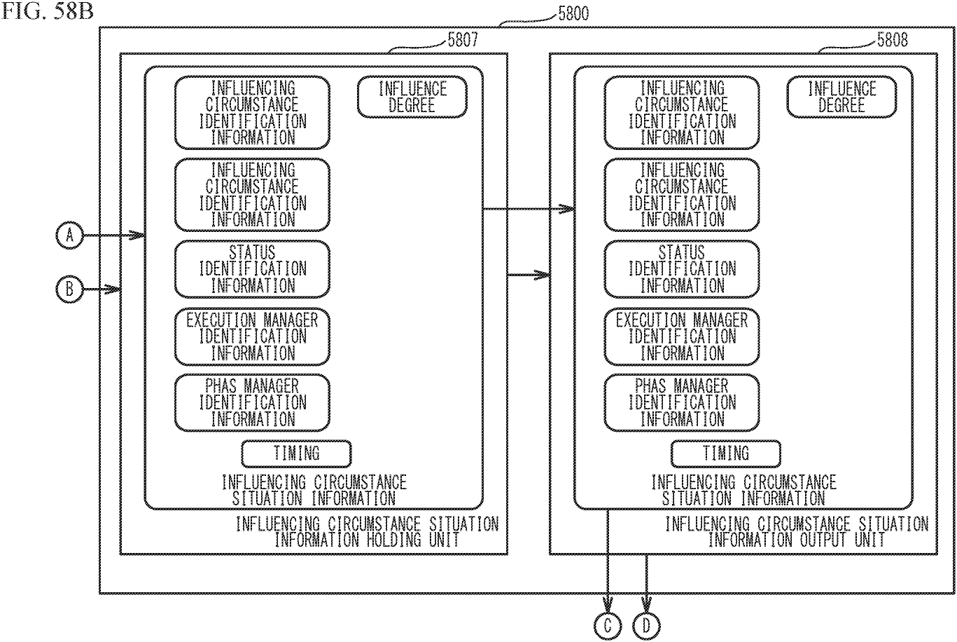

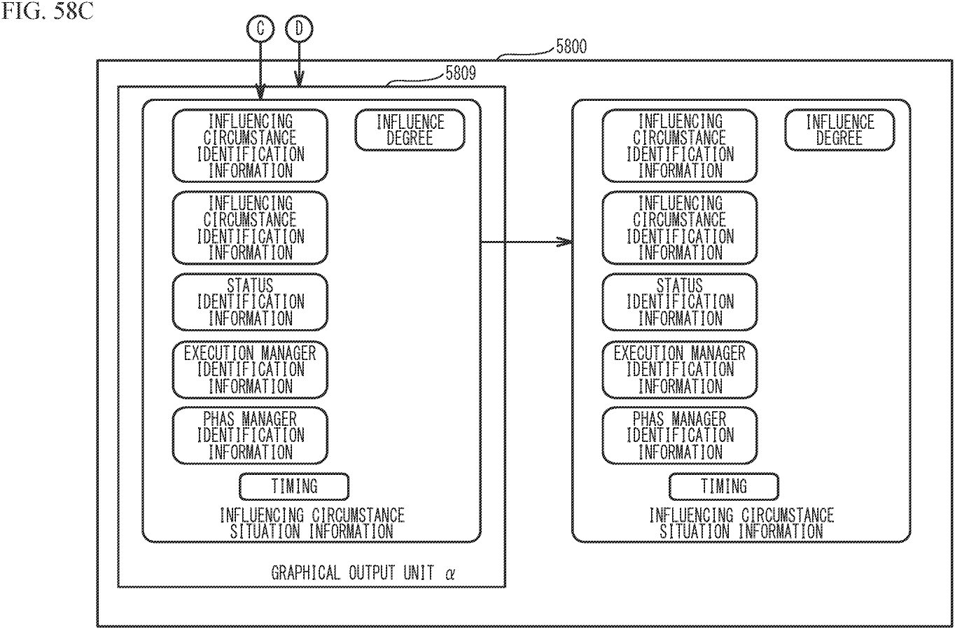

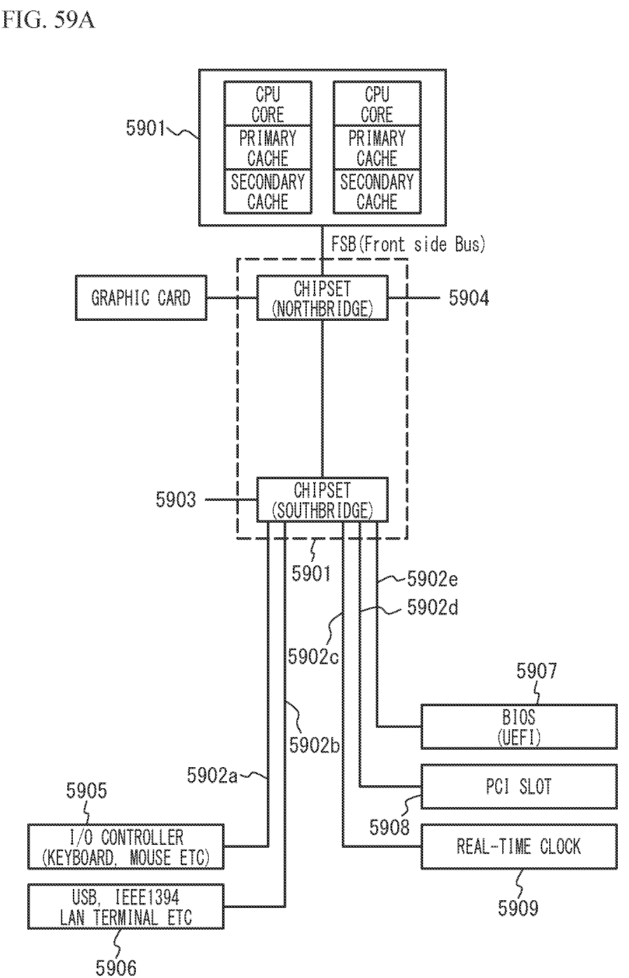

FIGS. 58A to 58C are diagrams illustrating a functional configuration of the present embodiment. The project management system (5800) of the present embodiment has a status identification information holding unit (5801), an executor identification information holding unit (5802), an influencing circumstance situation information holding unit (5803), an execution manager identification information holding unit (5804), a phase identification information holding unit (5805), an influencing circumstance situation information input reception unit (5806), an influencing circumstance situation information holding unit (5807), an influencing circumstance situation information output unit (5808), and a graphical output unit a (5809). The above configurations are substantially the same as the configurations described in the first to the twelfth embodiments. Therefore, detailed description of these configurations will be omitted by referring to the description of the first to the twelfth embodiments. The present embodiment is further characterized by comprising a graphical output unit a that graphically outputs a pie chart. Although not described in the above embodiments, the graphical output unit a may be additionally added as a component of the first to the twelfth embodiments. In other words, the project management system is configured so that the graphical output can be selected from one or more of the bar graph, the line graph, and the pie chart.

### Thirteenth Embodiment; Explanation of Configuration; Graphical Output Unit α

The “graphical output unit a has, as an example, a function of outputting a pie chart indicating the number of pieces of influencing circumstance situation information per status as a ratio by setting the total number of pieces of held influencing circumstance situation information as a whole. As another example, the total number can be the number of influencing circumstance situation information of a predetermined status, a predetermined project execution team, a predetermined influence degree, a predetermined execution manager, a predetermined timing or a predetermined resolution term, in a predetermined phase. When the total number (population) is determined, the composition ratios within the population are also displayed by phase, status, project execution team, impact, execution manager, timing, or resolution term.

FIG. 40 is a diagram illustrating an example of a screen for selecting a percentage presentation graph. For example, “ALL”, “phase selection” and “individual selection” can be considered as “population selection/influencing circumstance situation information selection” output formats such as “bar graph” and “line graph” are selected for them. And in this example, options of each of “phase selection” and “individual selection” have been registered in advance and each option may input in a pull-down format.

FIG. 41 is a diagram illustrating a screen for selecting a percentage presentation element when the percentage presentation graph is selected. For example, this screen includes selection targets such as “influence degree”, “occurrence phase”, “execution manager” and “status”. The “influence degree” may be indicated as large, medium, small, or indicated by “percentage” such as 50% and 80%. The “occurrence phase” may include requirement definition, external design, implementation, integration test, system test, operation and maintenance, and so on. The “execution manager” may be selected from among those registered in advance. The “status” may include options such as new, waiting for new approval, workaround measures being taken, mitigation measures being taken, pass-through measures being taken, acceptance measures being taken, corrections being made, and just before completion.

FIG. 42A is a diagram illustrating an example of the pie chart, and FIG. 42B is a diagram illustrating an example of the area graph. In the case of area graphs, it is possible to visually grasp what elements are large, rather than the exact differences between elements. FIGS. 74 to 77 are diagrams illustrating examples of the pie chart output by the graphical output unit A, and FIGS. 78 and 79 are diagrams illustrating examples of the bar graph output by the graphical output unit A.

Furthermore, the project management system may have a timing information acquisition unit. The “timing information acquisition unit” has a function of acquiring timing information related to timing such as the influencing circumstances and the phases.

### Thirteenth Embodiment; Hardware Configuration

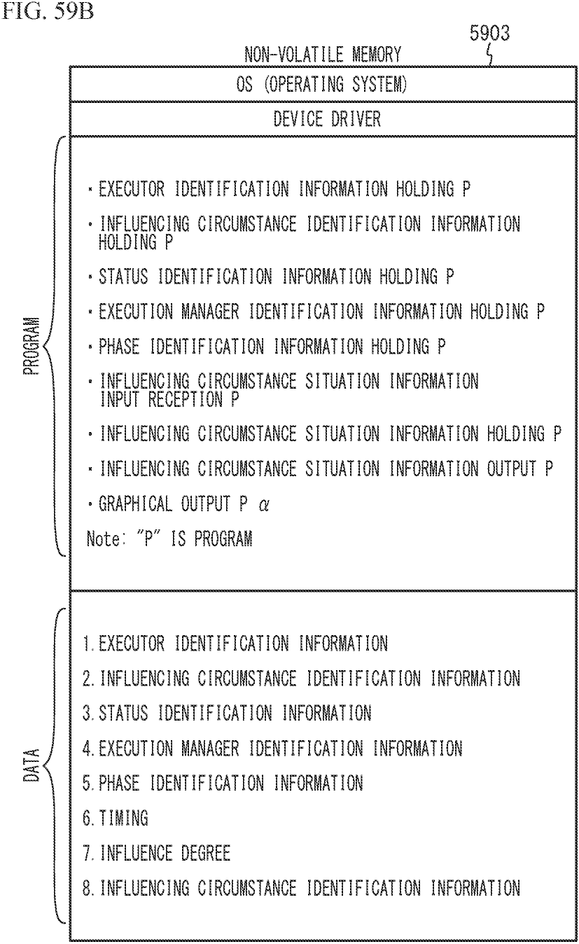

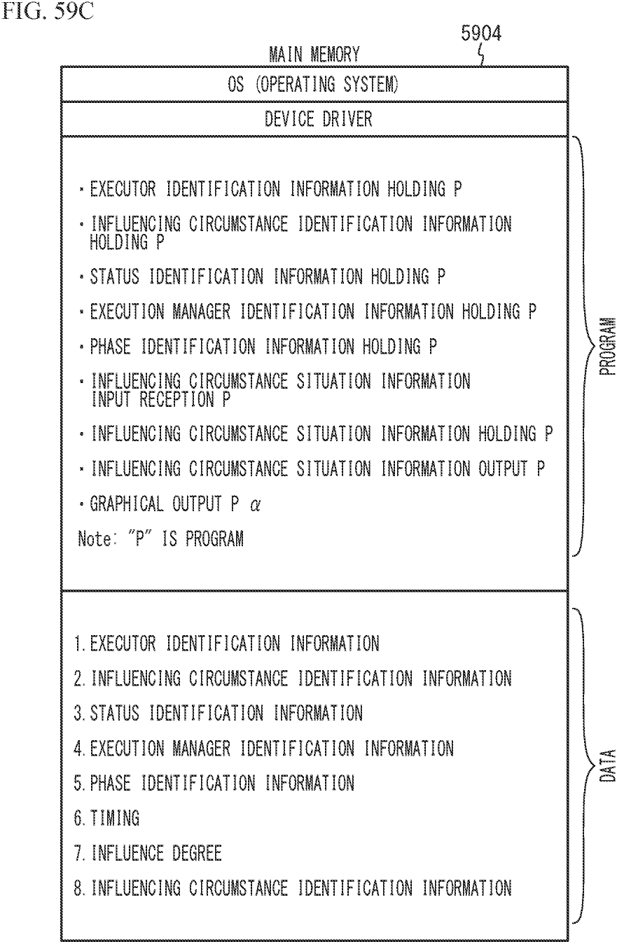

FIGS. 59A to 59C are diagrams illustrating a hardware configuration of the project management system according to the present embodiment. As illustrated in FIGS. 59A to 59C, the computer includes a chipset (5910), a CPU (5901), a non-volatile memory (5903), a main memory (5904), various buses (5902a, 5902b, 5902c, 5902d, 5902e), a BIOS (5907), various interfaces (5905, 5906, 5908), a real-time clock (5909), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 59A to 59C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; and a “graphical output program” that outputs a pie chart indicating the number of pieces of influencing circumstance situation information per status as a ratio by setting the total number of pieces of held influencing circumstance situation information as a whole. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Thirteenth Embodiment; Process Flow

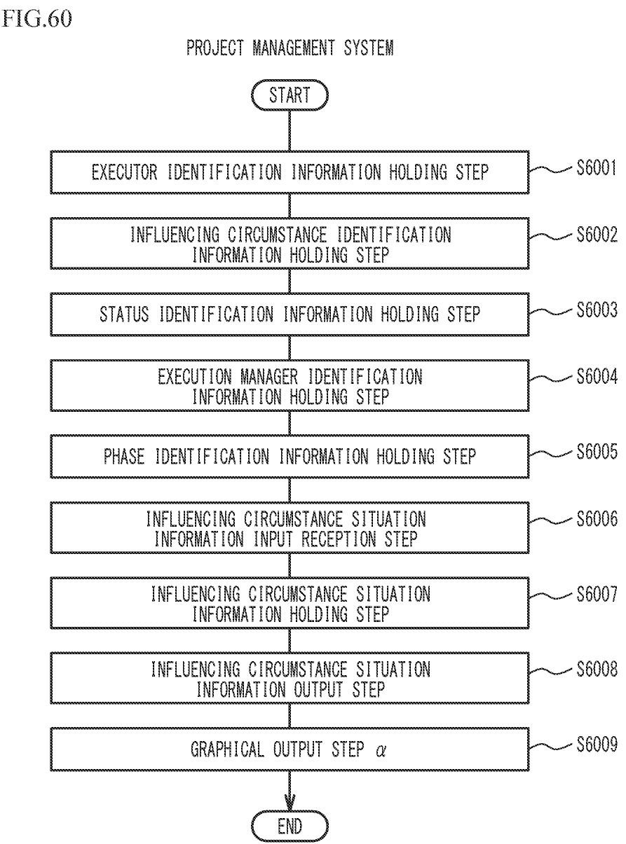

FIG. 60 is a flowchart illustrating the process when the project management system according to the present embodiment is used. The process flow of this embodiment is an operation method of the project management system which is a computer having a status identification information holding step (S6001), an executor identification information holding step (S6002), an influencing circumstance situation information holding step (S6003), an execution manager identification information holding step (S6004), a phase identification information holding step (S6005), an influencing circumstance situation information input reception step (S6006), an influencing circumstance situation information holding step (S6007), an influencing circumstance situation information output step (S6008), and a graphical output step a (S6009). Each of these steps, except the graphical output step a, is the same as that in the eighth embodiment. Hereinafter, the graphical output step a will be described below.

The “graphical output step α” outputs a pie chart indicating the number of pieces of influencing circumstance situation information per status as a ratio by setting the total number of pieces of held influencing circumstance situation information as a whole.

### Fourteenth Embodiment

### Fourteenth Embodiment; Summary; Mainly Relating to Claims 7, 17 and 27

In addition to the thirteenth embodiment described above, a fourteenth embodiment provides a project management system in which the graphical output unit a has a function of outputting a pie chart indicating the number of pieces of influencing circumstance situation information per influence degree as a ratio by setting the total number of pieces of held influencing circumstance situation information as a whole.

### Fourteenth Embodiment; Functional Configuration

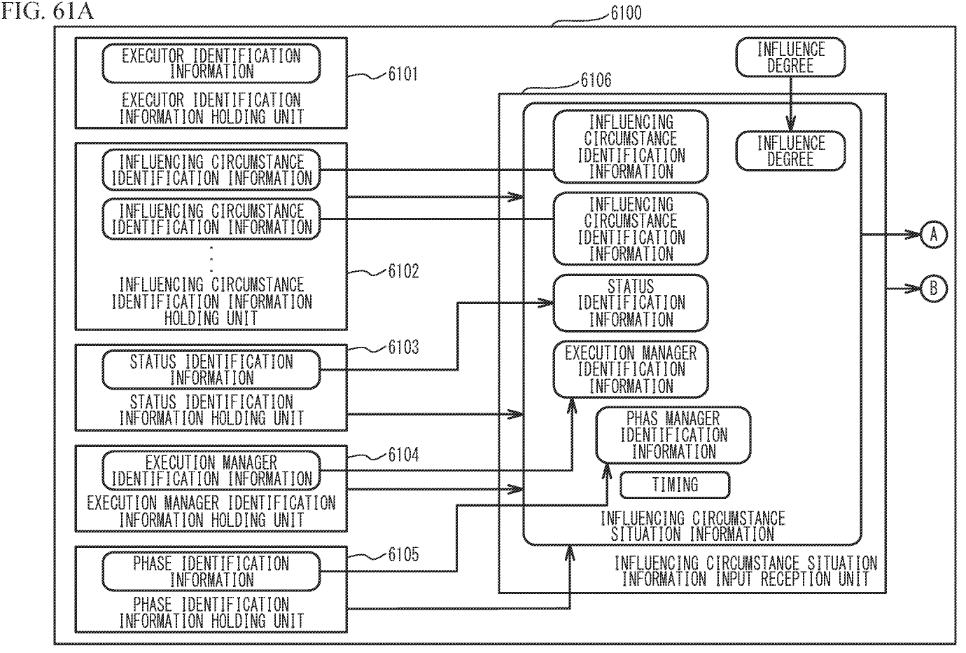

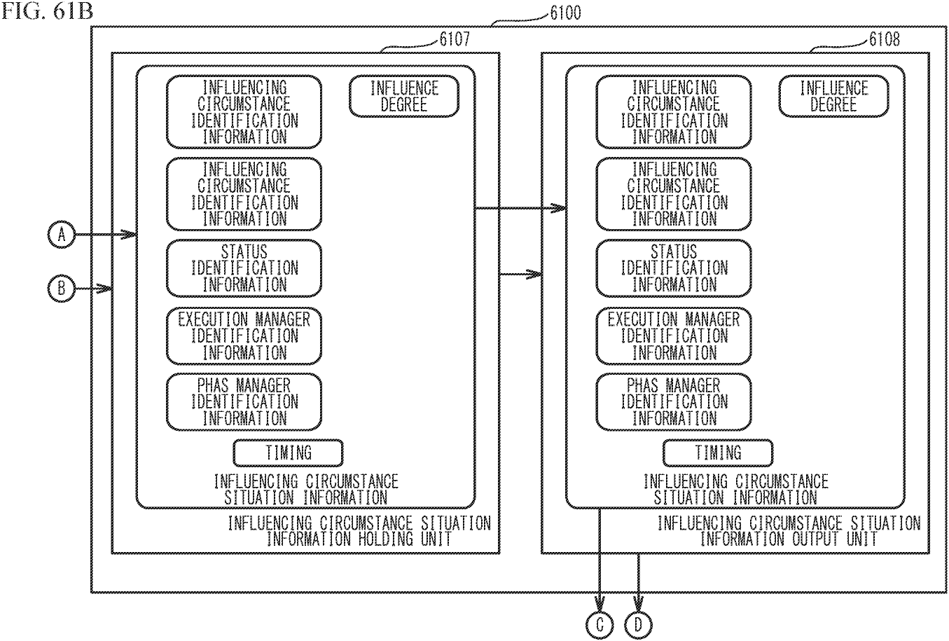

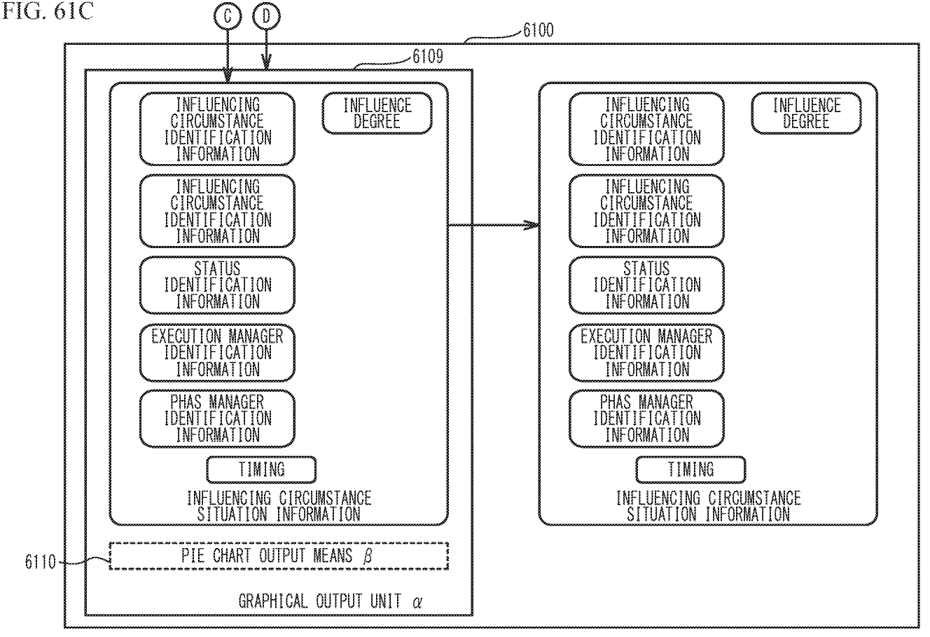

FIGS. 61A to 61C are diagrams illustrating a functional configuration of the present embodiment. The project management system (6100) of the present embodiment has a status identification information holding unit (6101), an executor identification information holding unit (6102), an influencing circumstance situation information holding unit (6103), an execution manager identification information holding unit (6104), a phase identification information holding unit (6105), an influencing circumstance situation information input reception unit (6106), an influencing circumstance situation information holding unit (6107), an influencing circumstance situation information output unit (6108), and a graphical output unit A (6109) having a pie chart output means β (6110). Since the functions excluding the pie chart output means β have already been described in the thirteenth embodiment, only the pie chart output means β will be described below.

### Fourteenth Embodiment; Explanation of Configuration; Pie Chart Output Means β

The “pie chart output means β” has a function of outputting a pie chart indicating the number of pieces of influencing circumstance situation information per influence degree as a ratio by setting the total number of pieces of held influencing circumstance situation information as a whole. Here, “per influence degree” refers to a display showing the ratio of each influence degree by dividing the total number of pieces of influencing circumstance situation information according to a magnitude of the influence degree. The influence degree may be configured to be displayed by grade if it is graded. If the influence degree is indicated by a number, and there are a large number of the types of the influence degree, it may be configured to be divided by levels each having a predetermined range. For example, when the magnitude of the influence degree is from 1 to 50, an influence degree A may be assigned to 1 to 10, an influence degree B may be assigned to 11 to 20, an influence degree C may be assigned to 21 to 30, an influence degree D may be assigned to 31 to 40, and an influence degree E may be assigned to 41 to 50.

### Fourteenth Embodiment; Hardware Configuration

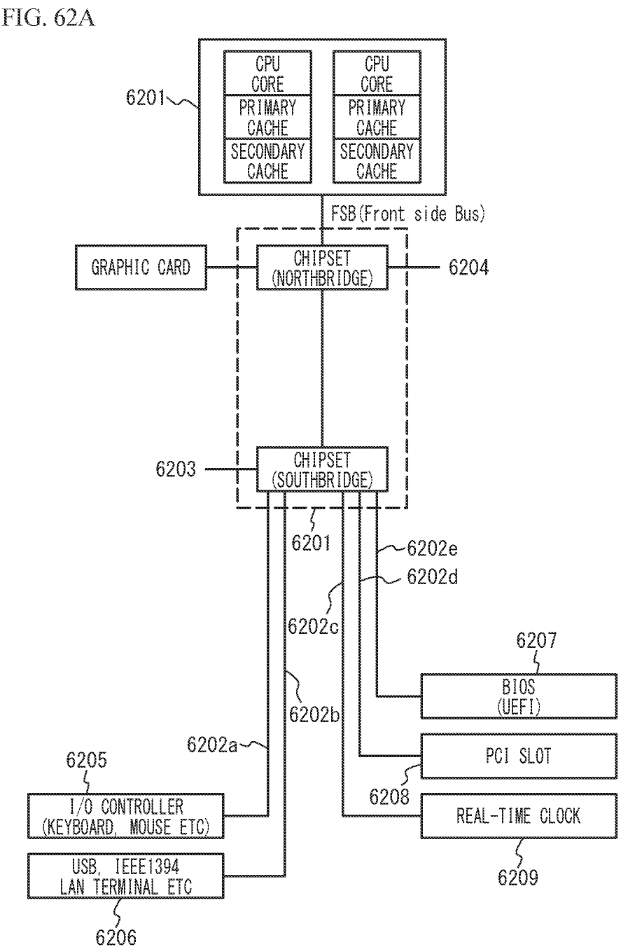

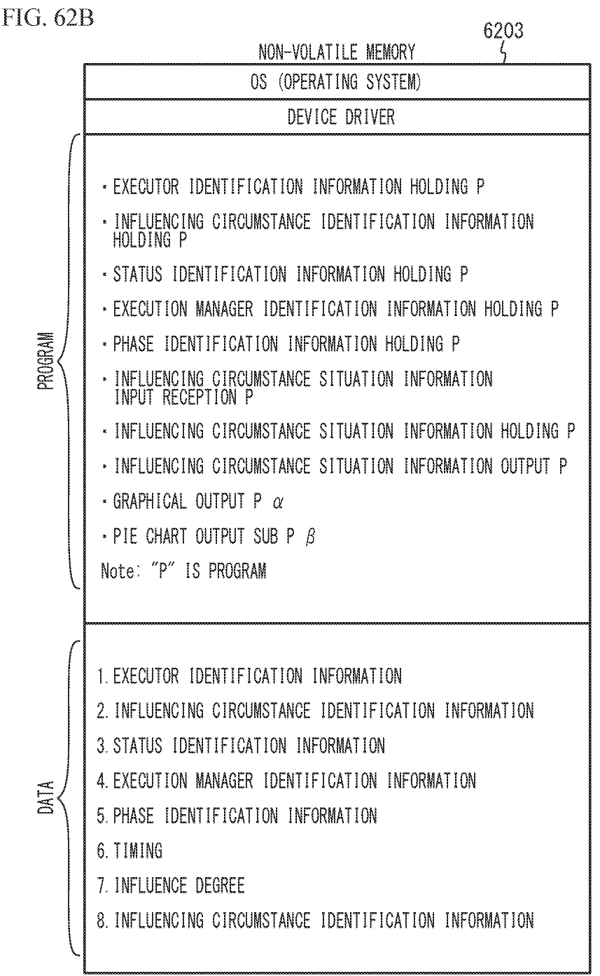

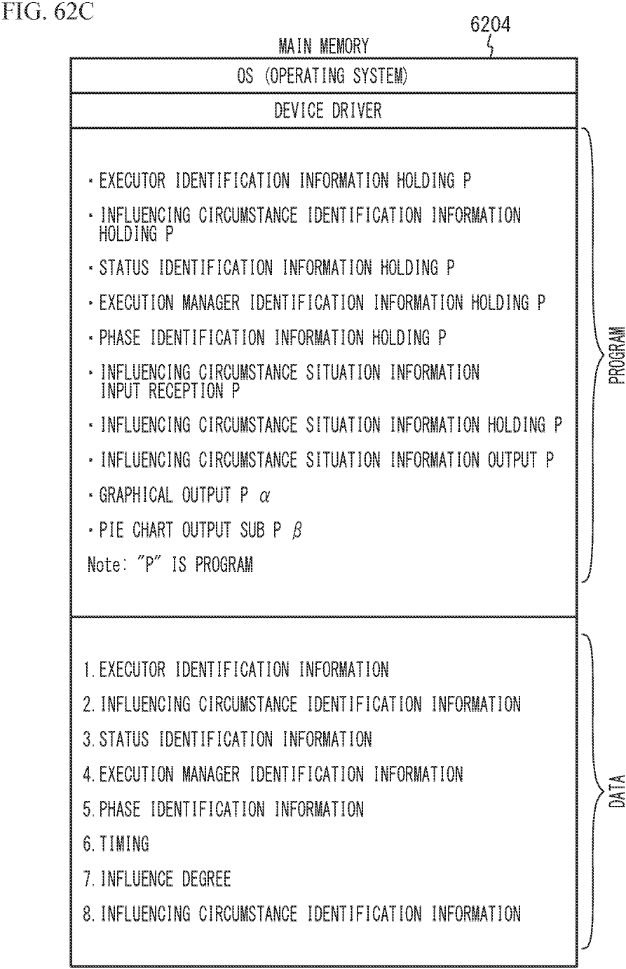

FIGS. 62A to 62C are diagrams illustrating a hardware configuration of the project management system according to the present embodiment. As illustrated in FIGS. 62A to 62C, the computer includes a chipset (6210), a CPU (6201), a non-volatile memory (6203), a main memory (6204), various buses (6202a, 6202b, 6202c, 6202d, 6202e), a BIOS (6207), various interfaces (6205, 6206, 6208), a real-time clock (6209), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 62A to 62C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; a “graphical output program” that outputs a pie chart indicating the number of pieces of influencing circumstance situation information per status as a ratio by setting the total number of pieces of held influencing circumstance situation information as a whole; and a “pie chart output subprogram β” that outputs a pie chart indicating the number of pieces of influencing circumstance situation information per influence degree as a ratio by setting the total number of pieces of held influencing circumstance situation information as a whole. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Fourteenth Embodiment; Process Flow

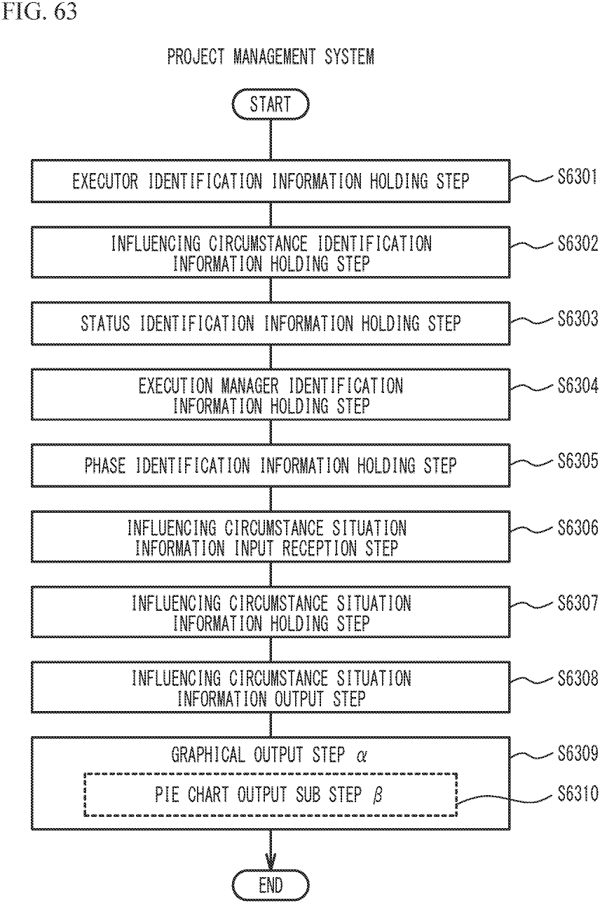

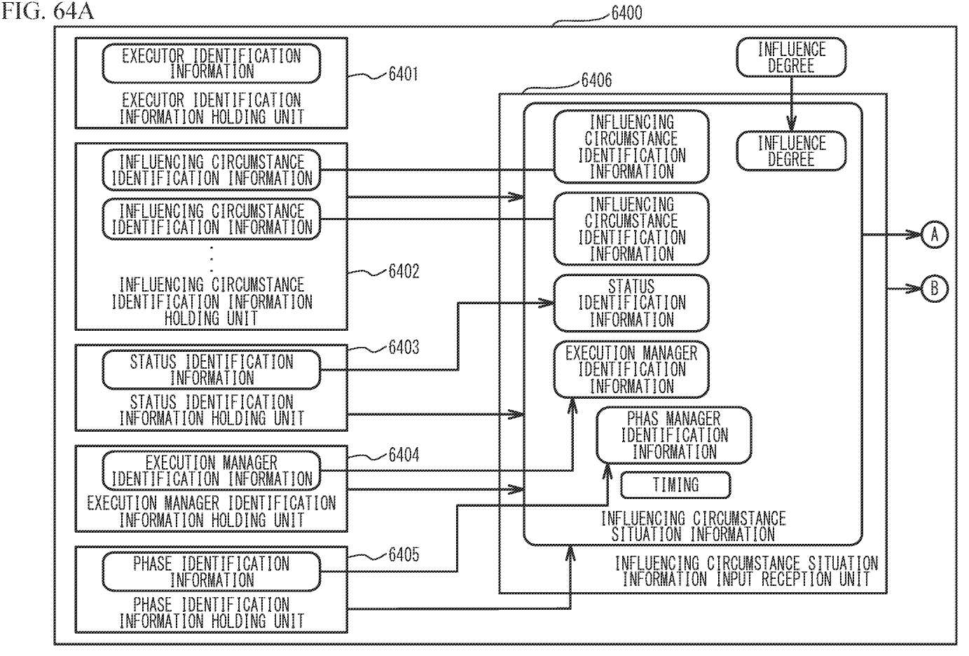

FIG. 63 is a flowchart illustrating the process when the project management system according to the present embodiment is used. The process flow of this embodiment is an operation method of the project management system which is a computer having a status identification information holding step (S6301), an executor identification information holding step (S6302), an influencing circumstance situation information holding step (S6303), an execution manager identification information holding step (S6304), a phase identification information holding step (S6305), an influencing circumstance situation information input reception step (S6306), an influencing circumstance situation information holding step (S6307), an influencing circumstance situation information output step (S6308), and a graphical output step a (S6309) having a pie graph output substep β (S6310). Each of these steps, except the pie graph output substep β, is the same as that in the thirteenth embodiment. Hereinafter, the pie graph output substep β will be described below.

The “pie graph output substep β” outputs a pie chart indicating the number of pieces of influencing circumstance situation information per influence degree as a ratio by setting the total number of pieces of held influencing circumstance situation information as a whole.

### Fifteenth Embodiment

### Fifteenth Embodiment; Summary; Mainly Relating to Claims 8, 18 and 28

In addition to the thirteenth embodiment described above, a fifteenth embodiment provides a project management system in which the graphical output unit a has a function of outputting a pie chart indicating the number of pieces of influencing circumstance situation information per occurrence phase which is an occurred phase as a ratio by setting the total number of pieces of held influencing circumstance situation information as a whole.

### Fifteenth Embodiment; Functional Configuration

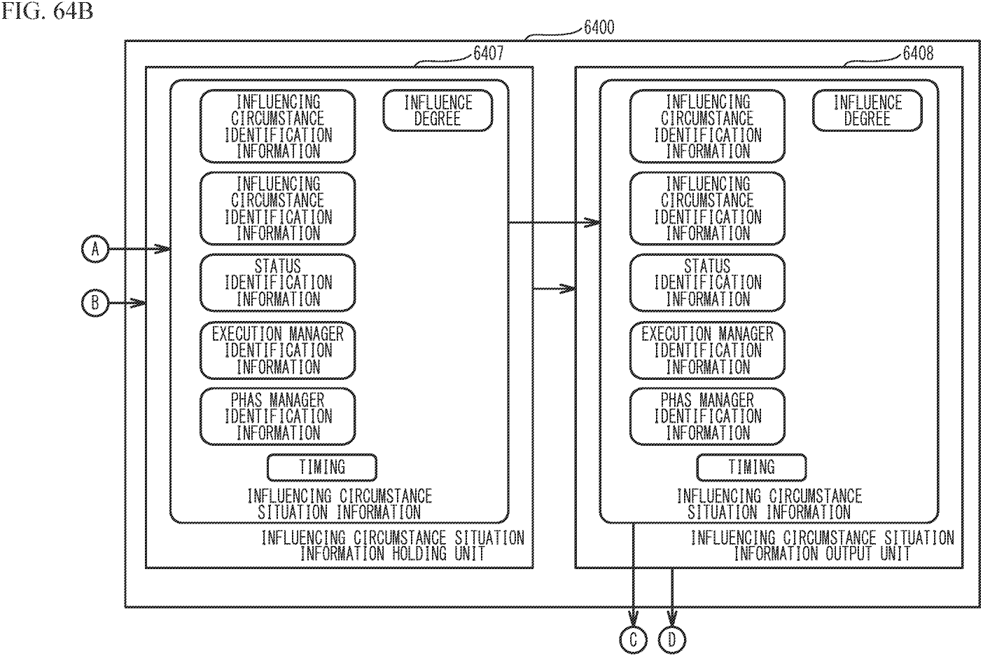

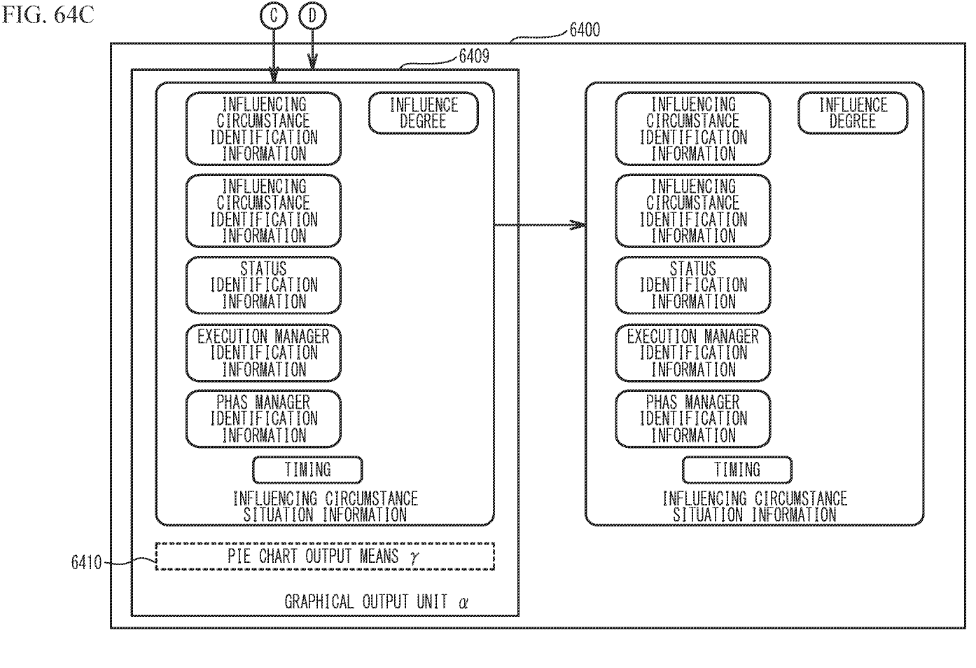

FIGS. 64A to 64C are diagrams illustrating a functional configuration of the present embodiment. The project management system (6400) of the present embodiment has a status identification information holding unit (6401), an executor identification information holding unit (6402), an influencing circumstance situation information holding unit (6403), an execution manager identification information holding unit (6404), a phase identification information holding unit (6405), an influencing circumstance situation information input reception unit (6406), an influencing circumstance situation information holding unit (6407), an influencing circumstance situation information output unit (6408), and a graphical output unit a (6409) having a pie chart output means γ (6410). Since the functions excluding the pie chart output means γ have already been described in the thirteenth embodiment, only the pie chart output means γ will be described below.

### Fifteenth Embodiment; Explanation of Configuration; Pie Chart Output Means γ

The “pie chart output means γ” has a function of outputting a pie chart indicating the number of pieces of influencing circumstance situation information per occurrence phase which is an occurred phase as a ratio by setting the total number of pieces of held influencing circumstance situation information as a whole. As mentioned above, the phase is a term that indicates the stage of the project, and it is any design items whether the phase indicates a top-level stage of the project, a stage of the project below it, or a stage of the project further below it. However, it is preferable to divide the phases into multiple layers and present them to the project members in order to manage the project efficiently. Therefore, the pie chart according to the present embodiment may show an uppermost phase on the outermost side when viewed from the center of the circle, and its lower phase on a side closer to the center of the circle, which is also helpful in understanding the overall picture of the phases. The phases are defined by a manager of the project before starting the management of the project using the project management system. This may be done by a phase definition unit. The phase definition unit can be provided in all embodiments.

### Fifteenth Embodiment; Hardware Configuration

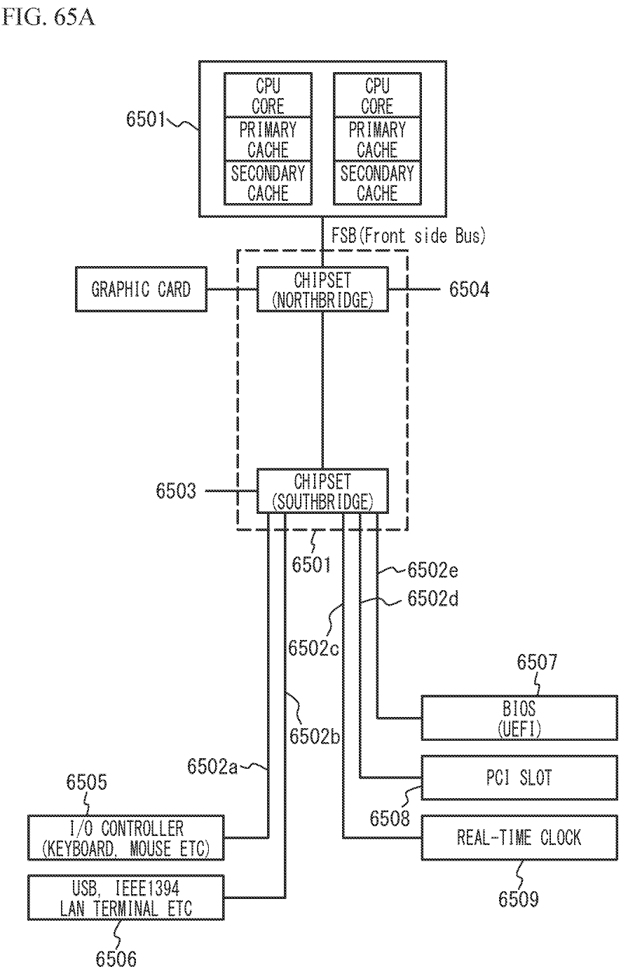

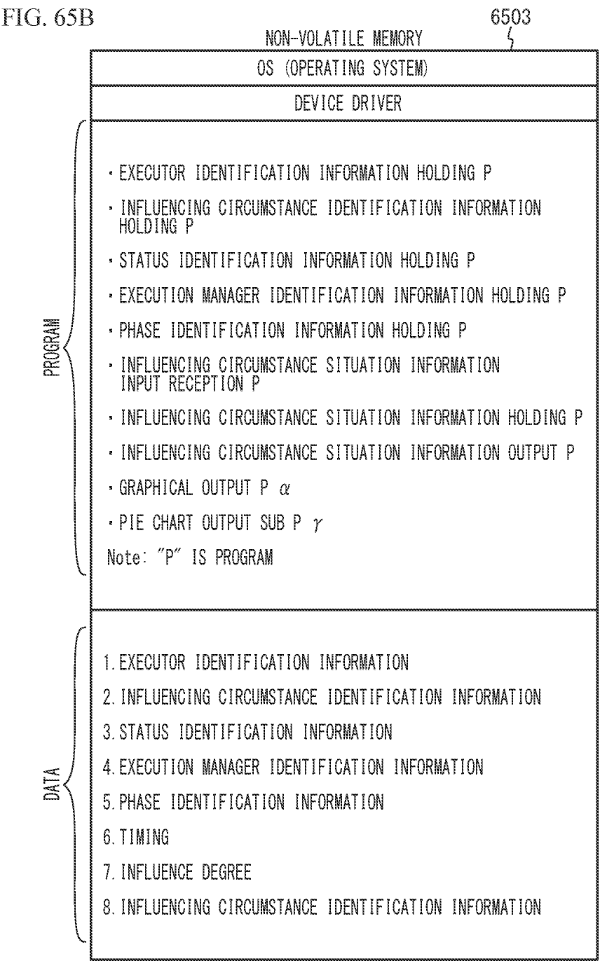

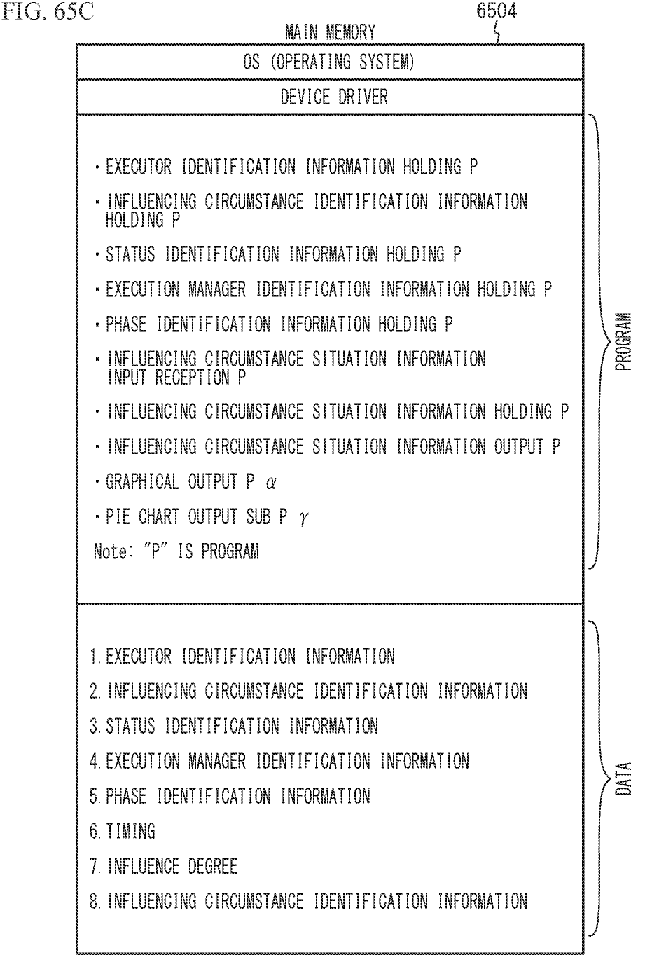

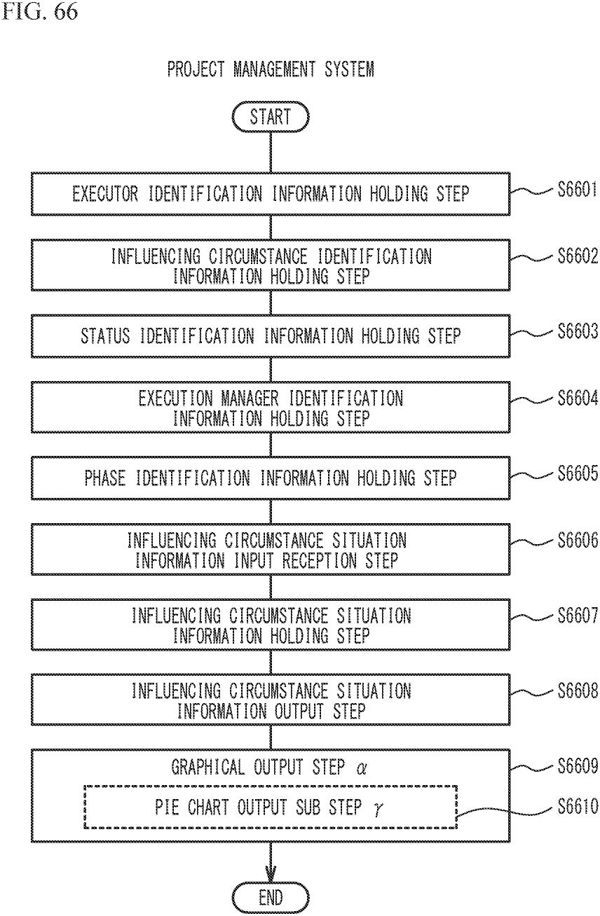

FIGS. 65A to 65C are diagrams illustrating a hardware configuration of the project management system according to the present embodiment. As illustrated in FIGS. 65A to 65C, the computer includes a chipset (6510), a CPU (6501), a non-volatile memory (6503), a main memory (6504), various buses (6502a, 6502b, 6502c, 6502d, 6502e), a BIOS (6507), various interfaces (6505, 6506, 6508), a real-time clock (6509), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 65A to 65C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; a “graphical output program” that outputs a pie chart indicating the number of pieces of influencing circumstance situation information per status as a ratio by setting the total number of pieces of held influencing circumstance situation information as a whole; and a “pie chart output subprogram γ” that outputs a pie chart indicating the number of pieces of influencing circumstance situation information per occurrence phase which is an occurred phase as a ratio by setting the total number of pieces of held influencing circumstance situation information as a whole. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Fifteenth Embodiment; Process Flow

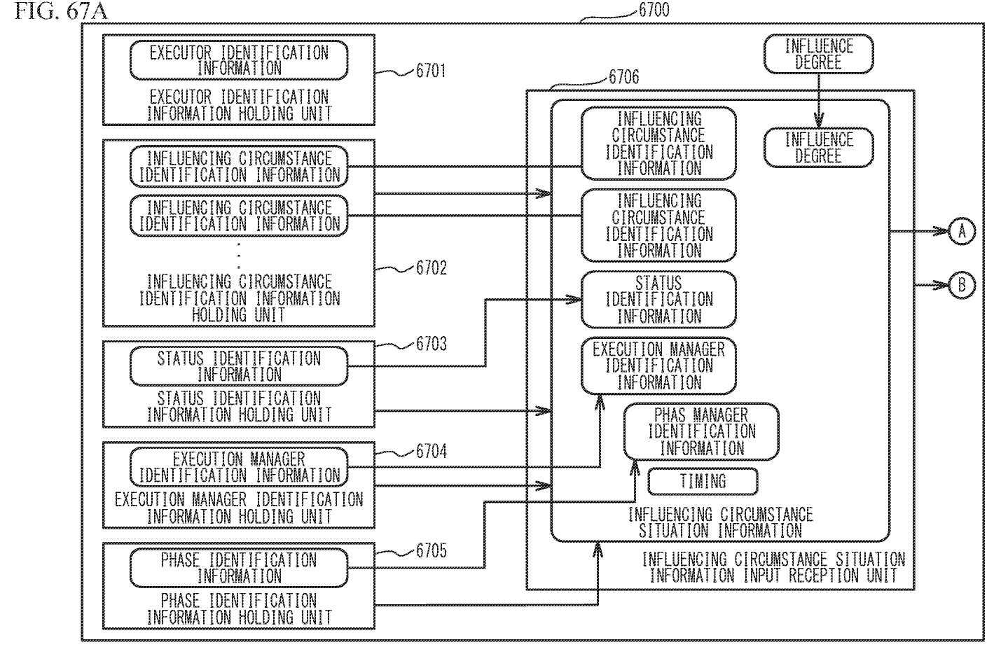

FIG. 66 is a flowchart illustrating the process when the project management system according to the present embodiment is used. The process flow of this embodiment is an operation method of the project management system which is a computer having a status identification information holding step (S6601), an executor identification information holding step (S6602), an influencing circumstance situation information holding step (S6603), an execution manager identification information holding step (S6604), a phase identification information holding step (S6605), an influencing circumstance situation information input reception step (S6606), an influencing circumstance situation information holding step (S6607), an influencing circumstance situation information output step (S6608), and a graphical output step a (S6609) having a pie graph output substep γ (S6610). Each of these steps, except the pie graph output substep γ, is the same as that in the thirteenth embodiment. Hereinafter, the pie graph output substep γ will be described below.

The “pie graph output substep γ” outputs a pie chart indicating the number of pieces of influencing circumstance situation information per occurrence phase which is an occurred phase as a ratio by setting the total number of pieces of held influencing circumstance situation information as a whole.

### Sixteenth Embodiment

### Sixteenth Embodiment; Summary; Mainly Relating to Claims 9, 19 and 29

In addition to the thirteenth embodiment described above, a sixteenth embodiment provides a project management system in which the graphical output unit a has a function of displaying, with a pie chart, an influence degree of the held influencing circumstance situation information per execution manager identified by the execution manager identification information.

### Sixteenth Embodiment; Functional Configuration

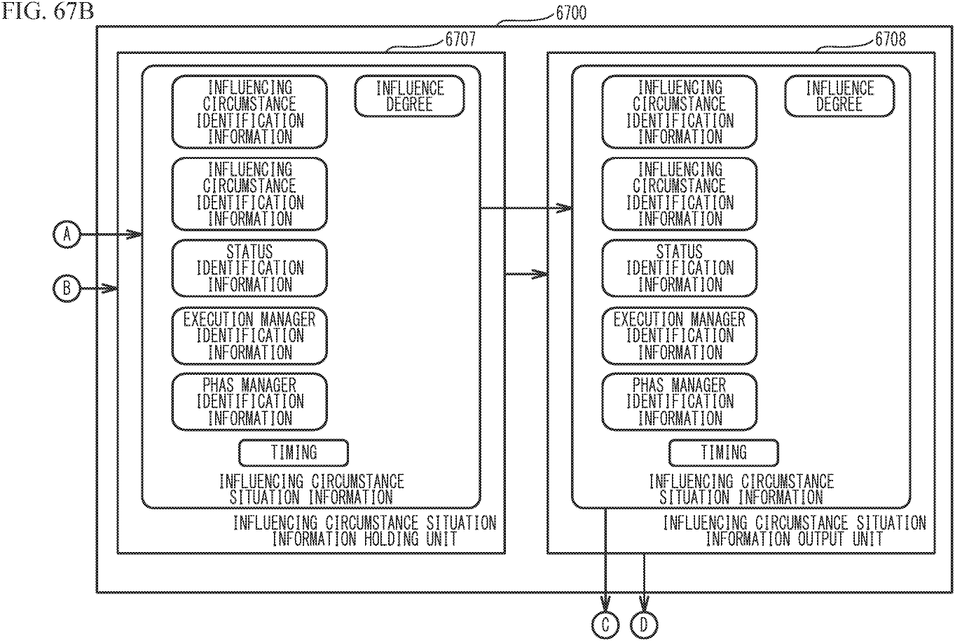

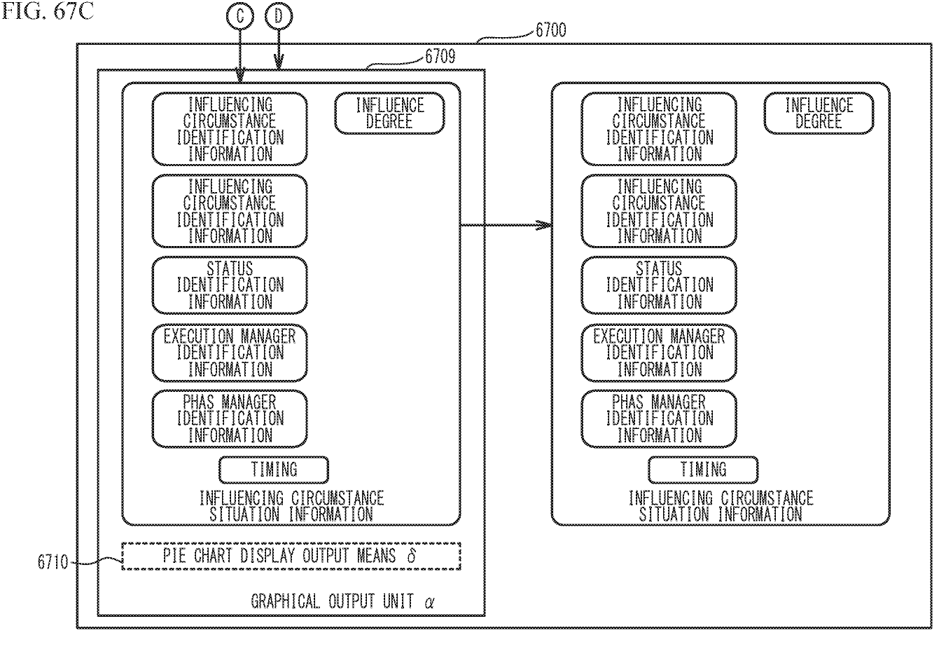

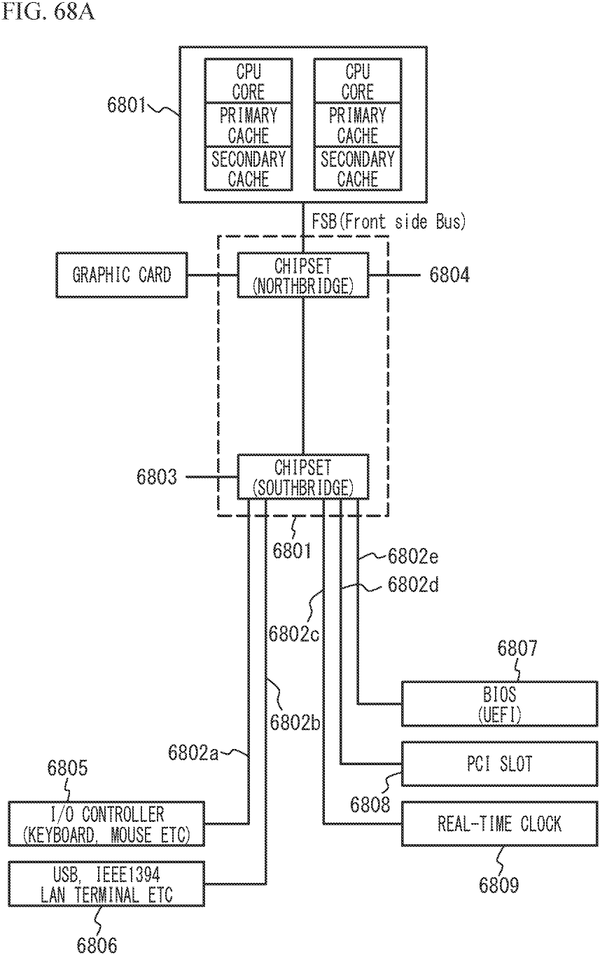

FIGS. 67A to 67C are diagrams illustrating a functional configuration of the present embodiment. The project management system (6700) of the present embodiment has a status identification information holding unit (6701), an executor identification information holding unit (6702), an influencing circumstance situation information holding unit (6703), an execution manager identification information holding unit (6704), a phase identification information holding unit (6705), an influencing circumstance situation information input reception unit (6706), an influencing circumstance situation information holding unit (6707), an influencing circumstance situation information output unit (6708), and a graphical output unit a (6709) having a pie chart output means δ (6410). Since the functions excluding the pie chart output means δ have already been described in the thirteenth embodiment, only the pie chart output means δ will be described below.

### Sixteenth Embodiment; Explanation of Configuration; Pie Chart Output Means δ

The “pie chart output means δ” has a function of displaying, with a pie chart, an influence degree of the held influencing circumstance situation information per execution manager identified by the execution manager identification information.

### Sixteenth Embodiment; Hardware Configuration

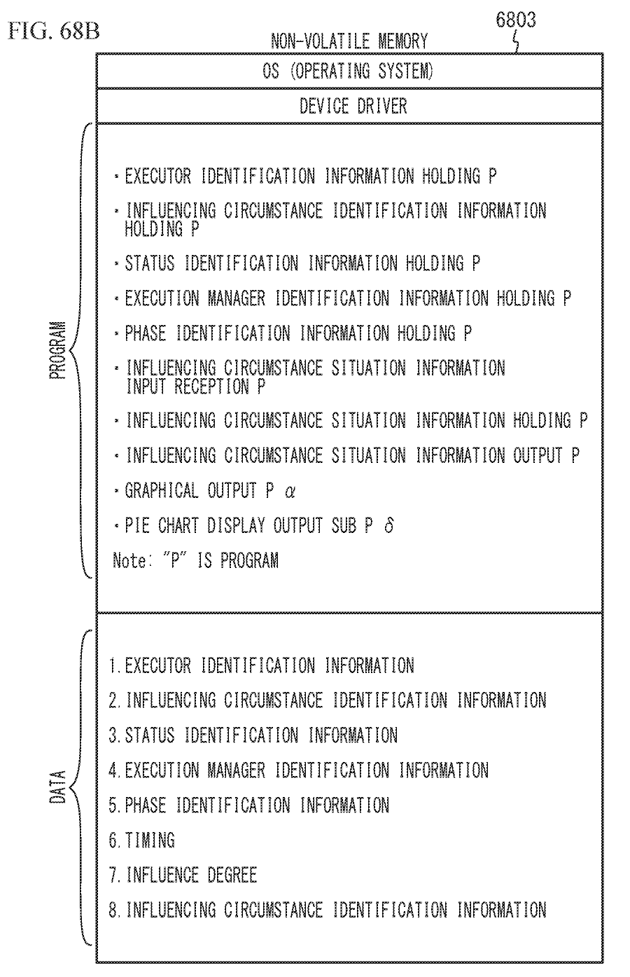

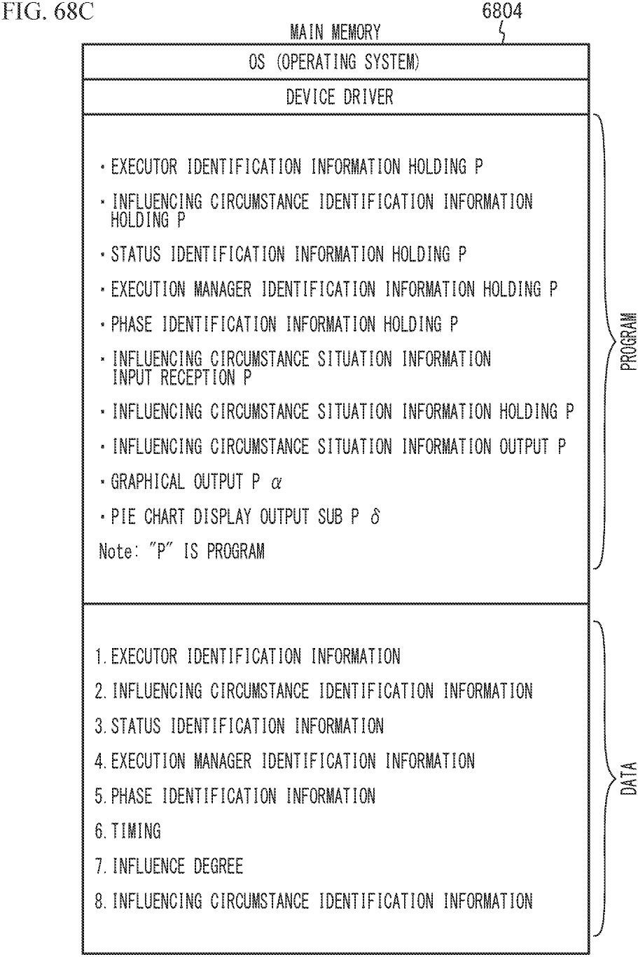

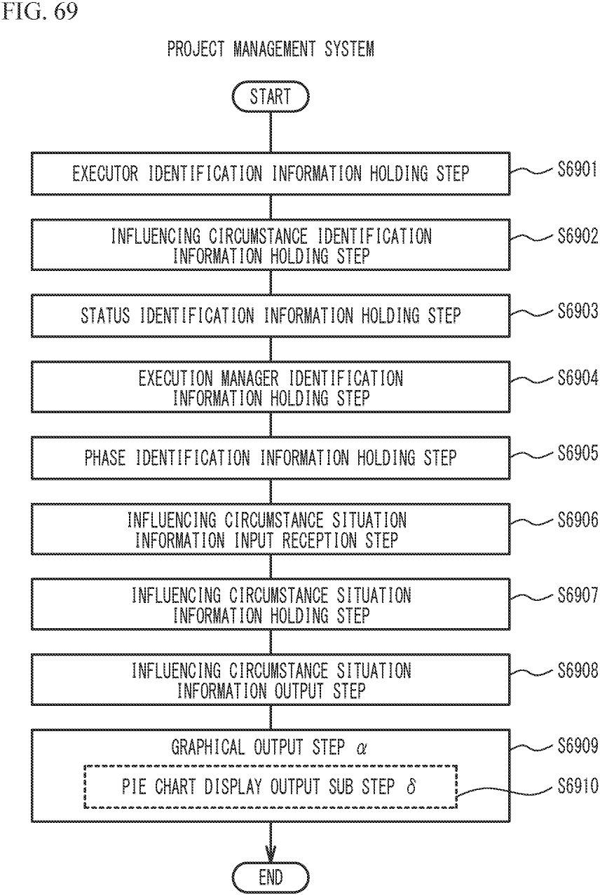

FIGS. 68A to 68C are diagrams illustrating a hardware configuration of the project management system according to the present embodiment. As illustrated in FIGS. 68A to 68C, the computer includes a chipset (6810), a CPU (6801), a non-volatile memory (6803), a main memory (6804), various buses (6802a, 6802b, 6802c, 6802d, 6802e), a BIOS (6807), various interfaces (6805, 6806, 6808), a real-time clock (6809), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 68A to 68C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “influencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; a “graphical output program” that outputs a pie chart indicating the number of pieces of influencing circumstance situation information per status as a ratio by setting the total number of pieces of held influencing circumstance situation information as a whole; and a “pie chart output subprogram δ” that displays, with a pie chart, an influence degree of the held influencing circumstance situation information per execution manager identified by the execution manager identification information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Sixteenth Embodiment; Process Flow

FIG. 69 is a flowchart illustrating the process when the project management system according to the present embodiment is used. The process flow of this embodiment is an operation method of the project management system which is a computer having a status identification information holding step (S6901), an executor identification information holding step (S6902), an influencing circumstance situation information holding step (S6903), an execution manager identification information holding step (S6904), a phase identification information holding step (S6905), an influencing circumstance situation information input reception step (S6906), an influencing circumstance situation information holding step (S6907), an influencing circumstance situation information output step (S6908), and a graphical output step a (S6909) having a pie graph output substep δ (S6910). Each of these steps, except the pie graph output substep δ, is the same as that in the thirteenth embodiment. Hereinafter, the pie graph output substep δ will be described below.

The “pie graph output substep δ” displays, with a pie chart, an influence degree of the held influencing circumstance situation information per execution manager identified by the execution manager identification information.

### Seventeenth Embodiment

### Seventeenth Embodiment; Summary; Mainly Relating to Claims 10, 20 and 30

In addition to the thirteenth embodiment described above, a seventeenth embodiment provides a project management system in which the graphical output unit a has a function of displaying, with a pie chart, an influence degree of the held influencing circumstance situation information per status identified by the status identification information.

### Sixteenth Embodiment; Functional Configuration

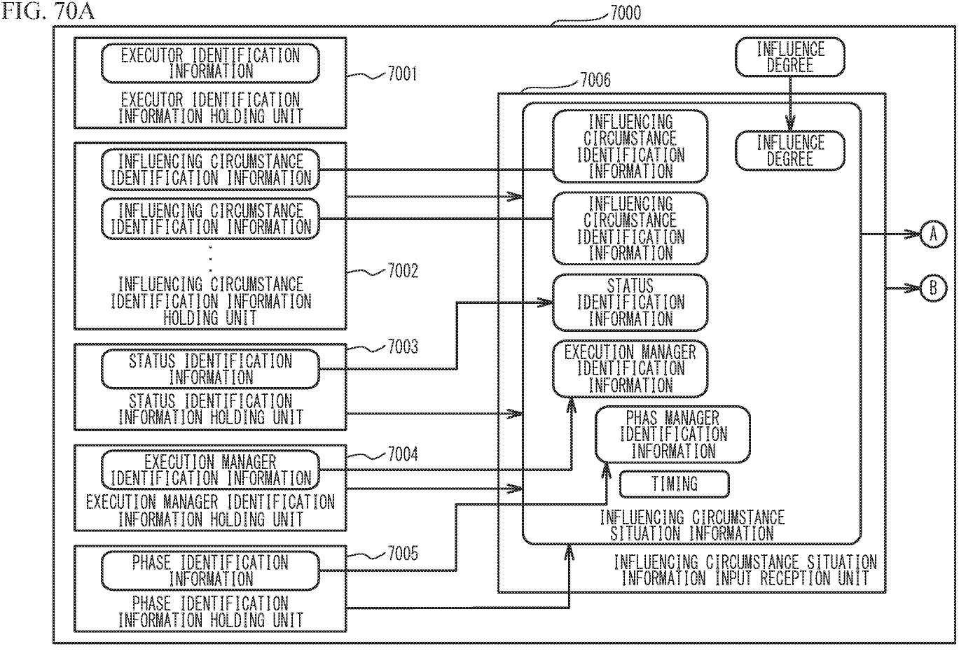

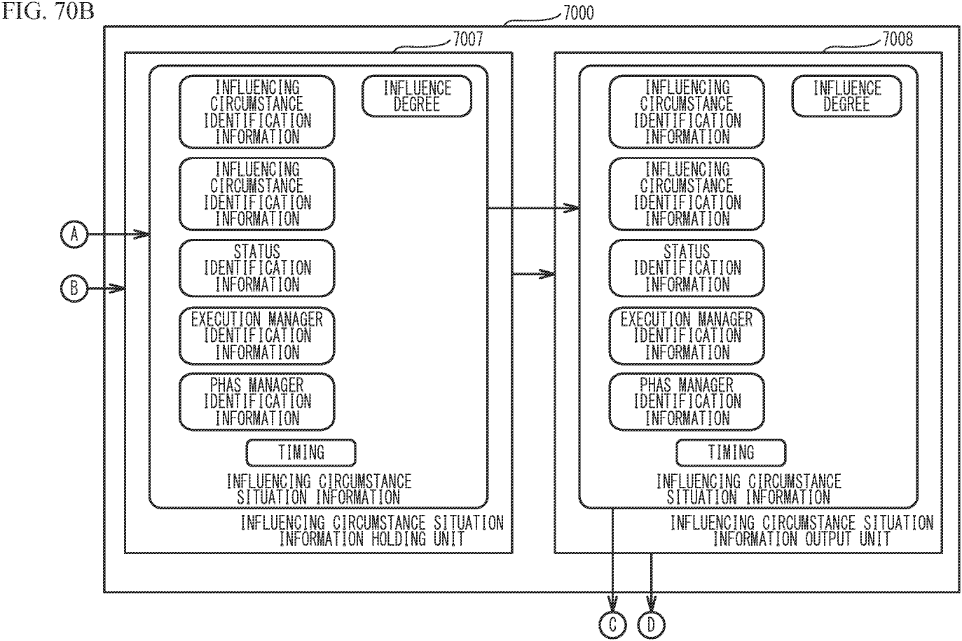

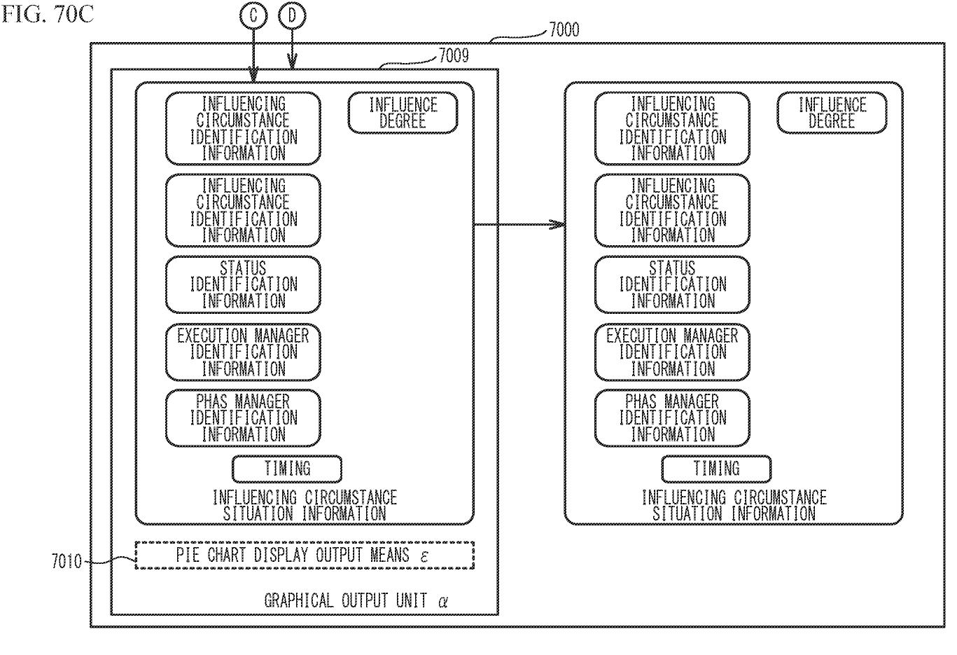

FIGS. 70A to 70C are diagrams illustrating a functional configuration of the present embodiment. The project management system (7000) of the present embodiment has a status identification information holding unit (7001), an executor identification information holding unit (7002), an influencing circumstance situation information holding unit (7003), an execution manager identification information holding unit (7004), a phase identification information holding unit (7005), an influencing circumstance situation information input reception unit (7006), an influencing circumstance situation information holding unit (7007), an influencing circumstance situation information output unit (7008), and a graphical output unit a (7009) having a pie chart output means ε (7010). Since the functions excluding the pie chart output means ε have already been described in the thirteenth embodiment, only the pie chart output means ε will be described below.

### Sixteenth Embodiment; Explanation of Configuration; Pie Chart Output Means ε

The “pie chart output means ε” has a function of displaying, with a pie chart, an influence degree of the held influencing circumstance situation information per status identified by the status identification information.

### Seventh Embodiment; Hardware Configuration

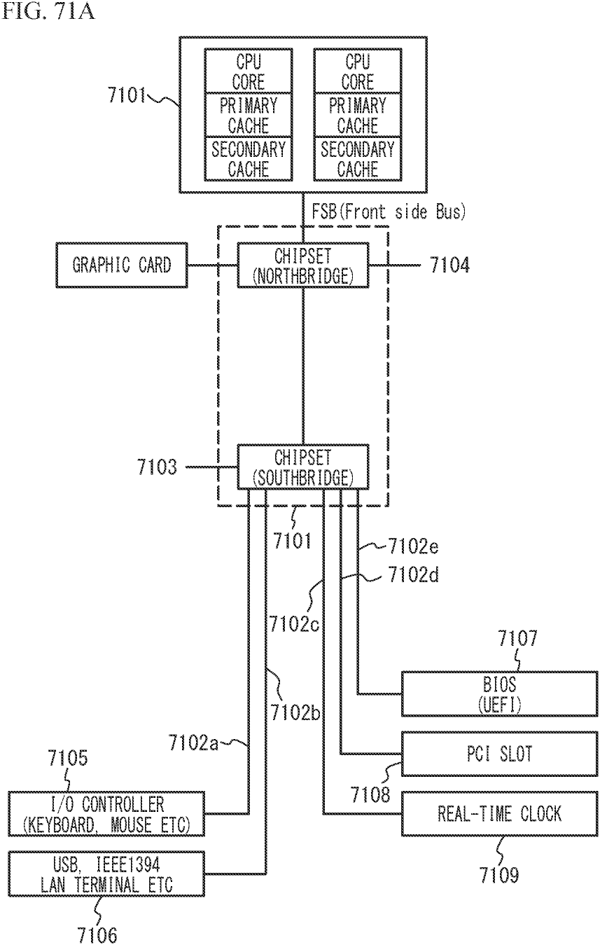

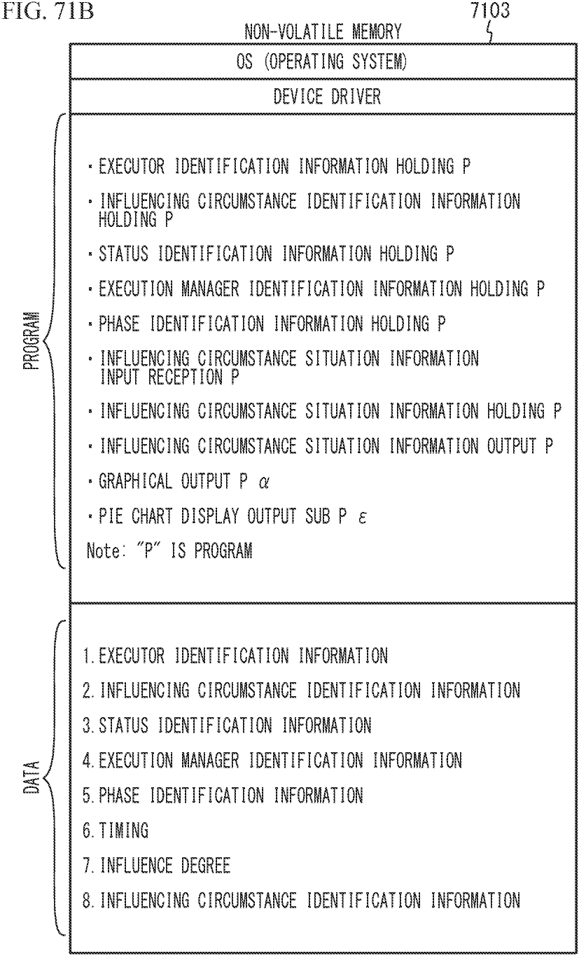

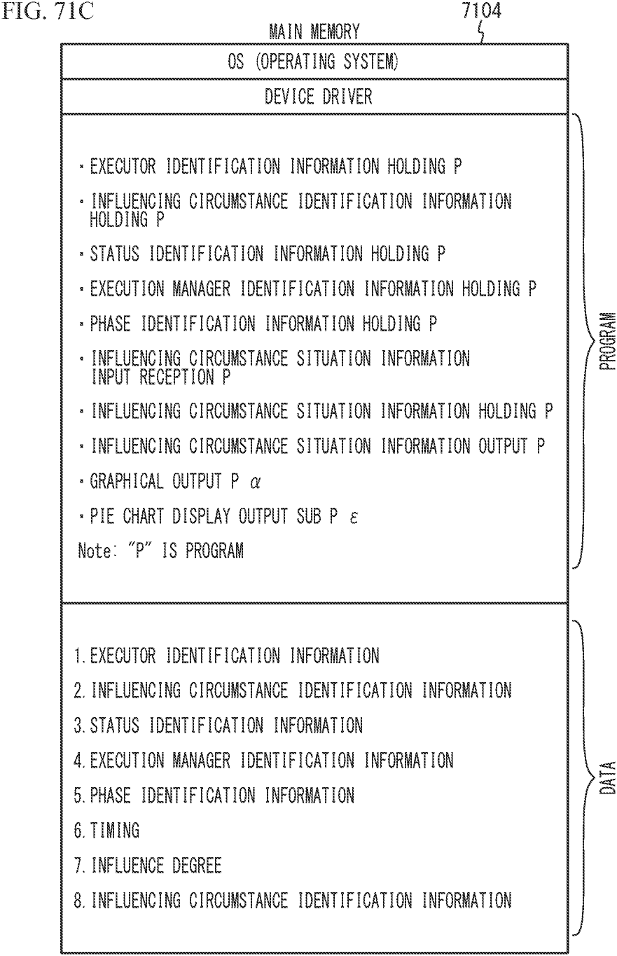

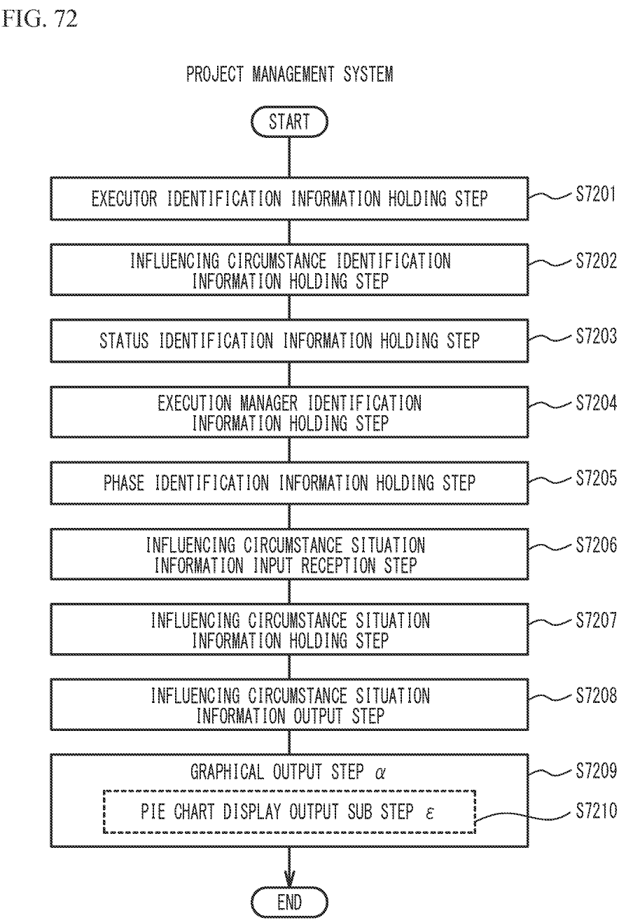

FIGS. 71A to 71C are diagrams illustrating a hardware configuration of the project management system according to the present embodiment. As illustrated in FIGS. 71A to 71C, the computer includes a chipset (7110), a CPU (7101), a non-volatile memory (7103), a main memory (7104), various buses (7102a, 7102b, 7102c, 7102d, 7102e), a BIOS (7107), various interfaces (7105, 7106, 7108), a real-time clock (7109), and the like, which are configured on the motherboard. These work in conjunction with an operating system, device drivers, various programs, and so on. The various programs and various data constituting the present disclosure are configured to efficiently utilize these hardware resources to execute various processes.

The “main memory” reads programs for performing various processes to be executed by the “CPU”, and provides work areas which are also working areas of the programs at the same time. In addition, multiple addresses are assigned to the “main memory” and the “HDD”, respectively. The program executed by the “CPU” can exchange data with each other and perform processes by specifying and accessing the addresses.

As illustrated in FIGS. 71A to 71C, the non-volatile memory includes: the “status identification information holding program” that holds status identification information that identifies a status (e.g., information indicating “new”, “waiting for new approval”, “workaround measures being taken”, “mitigation measures being taken”, “pass-through measures being taken”, “acceptance measures being taken”, “corrections being made”, “just before completion”, “waiting for completion approval” or “completion”.); the “executor identification information holding program” that holds executor identification information that identifies an executor of the project; the “nfluencing circumstance situation information holding program” that holds a plurality of types of influencing circumstance situation information that expresses the influencing circumstance that is a circumstance that influences the progress of the project recognized in the phase of the project; the “execution manager identification information holding program” that holds execution manager identification information that identifies an execution manager as an executor who is responsible for executing a workaround to avoid an adverse influence on the project due to the influencing circumstance; the “phase identification information holding program” that holds phase identification information that identifies the phase of the project (this indicates the stage of the project. For example, “design phase, procurement phase, manufacturing phase, testing phase, delivery phase”, “requirement definition phase, external design phase, implementation phase, integration testing phase, system testing phase, system operation and maintenance phase”, and so on); the “influencing circumstance situation information input reception program” that receives an input of the influencing circumstance situation information which is information that associates, with each other, the held influencing circumstance identification information, the phase identification information of a phase in which the influencing circumstance identified by the influencing circumstance identification information is recognized, the timing such as recognized date and time, the execution manager identification information that identifies an execution manager as an executor who is responsible for executing a workaround to avoid an adverse influence on the project due to the influencing circumstance, the influence degree (e.g., large, medium, small, 50%, 80%, etc.) to which the influencing circumstance identified by the influencing circumstance identification information influences the project, and the status identification information of the status which is information indicating the status of resolution to the influencing circumstance situation information; the “influencing circumstance situation information holding program” that holds the received influencing circumstance situation information; the “influencing circumstance situation information output program” that outputs the held influencing circumstance situation information; a “graphical output program” that outputs a pie chart indicating the number of pieces of influencing circumstance situation information per status as a ratio by setting the total number of pieces of held influencing circumstance situation information as a whole; and a “pie chart output subprogram ε” that displays, with a pie chart, an influence degree of the held influencing circumstance situation information per status identified by the status identification information. These programs are read into the main memory based on the execution instruction of the series of programs, and these programs are executed based on the operation start instruction. In this computer, the non-volatile memory, the main memory, the CPU, and the interfaces (for example, a display, a keyboard, communication, etc.) are connected to the bus line so that they can communicate with each other.

### Seventeenth Embodiment; Process Flow

FIG. 72 is a flowchart illustrating the process when the project management system according to the present embodiment is used. The process flow of this embodiment is an operation method of the project management system which is a computer having a status identification information holding step (S7201), an executor identification information holding step (S7202), an influencing circumstance situation information holding step (S7203), an execution manager identification information holding step (S7204), a phase identification information holding step (S7205), an influencing circumstance situation information input reception step (S7206), an influencing circumstance situation information holding step (S7207), an influencing circumstance situation information output step (S7208), and a graphical output step a (S7209) having a pie graph output substep ε (S7210). Each of these steps, except the pie graph output substep ε, is the same as that in the thirteenth embodiment. Hereinafter, the pie graph output substep ε will be described below.

The “pie graph output substep ε” displays, with a pie chart, an influence degree of the held influencing circumstance situation information per status identified by the status identification information.

What is claimed is:

1. A project management system comprising:
a memory;
a processor coupled to the memory and the processor configured to:
hold executor identification information that identifies an executor of a project;
hold a plurality of types of influencing circumstance identification information that identifies an influencing circumstance which is a circumstance that influences the progress of the project recognized in a phase of the project;
hold status identification information that identifies a status which is information indicating a status of resolution to an influencing circumstance identified by the influencing circumstance identification information;
hold execution manager identification information that identifies an execution manager as an executor who is responsible for executing a workaround to avoid an adverse influence on the project due to the influencing circumstance;
hold phase identification information that identifies a phase of the project;
receive an input of influencing circumstance situation information which is information that associates, with each other, the held influencing circumstance identification information, the phase identification information of the phase in which the influencing circumstance identified by the influencing circumstance identification information is recognized, recognized timing thereof, the execution manager identification information that identifies the execution manager as the executor who is responsible for executing the workaround to avoid the adverse influence on the project due to the influencing circumstance, an influence degree to which the influencing circumstance influences the project, the status identification information of the status which is information indicating the status of resolution to the influencing circumstance;
hold the received influencing circumstance situation information;
output the held influencing circumstance situation information; and
graphically output a graph with one axis as timing and another axis as the recognized number of pieces of influencing circumstance situation information using the held influencing circumstance situation information.

2. The project management system according to claim 1, wherein the processor is further configured to graphically output a graph with the one axis as the timing and the another axis as the number of recognitions per influence degree of the influencing circumstance situation information, using received per-phase influencing circumstance situation information.

3. The project management system according to claim 1, wherein the processor is further configured to graphically outputting a graph with the one axis as the timing and the another axis as the number of cases per status of the influencing circumstance situation information, using received per-phase influencing circumstance situation information.

4. The project management system according to claim 1, wherein the processor is further configured to display a graphical output per phase identified by the phase identification information included in the influencing circumstance situation information.

5. The project management system according to claim 1, wherein the processor is further configured to display a graphical output per execution manager identified by the execution manager identification information included in the influencing circumstance situation information.

6. A project management system comprising:
a memory;
a processor coupled to the memory and the processor configured to:
hold executor identification information that identifies an executor of a proj ect;
hold a plurality of types of influencing circumstance identification information that identifies an influencing circumstance which is a circumstance that influences the progress of the project recognized in a phase of the project;
hold status identification information that identifies a status which is information indicating a status of resolution to an influencing circumstance identified by the influencing circumstance identification information;
hold execution manager identification information that identifies an execution manager as an executor who is responsible for executing a workaround to avoid an adverse influence on the project due to the influencing circumstance;
hold phase identification information that identifies a phase of the project;
receive an input of influencing circumstance situation information which is information that associates, with each other, the held influencing circumstance identification information, the phase identification information of the phase in which the influencing circumstance identified by the influencing circumstance identification information is recognized, recognized timing thereof, the execution manager identification information that identifies the execution manager as the executor who is responsible for executing the workaround to avoid the adverse influence on the project due to the influencing circumstance, an influence degree to which the influencing circumstance influences the project, the status identification information of the status which is information indicating the status of resolution to the influencing circumstance;
hold the received influencing circumstance situation information;
output the held influencing circumstance situation information; and
output a pie chart indicating the number of pieces of influencing circumstance situation information per status as a ratio by setting the total number of pieces of held influencing circumstance situation information as a whole.

7. The project management system according to claim 6, wherein the processor is further configured to output a pie chart indicating the number of pieces of influencing circumstance situation information per influence degree as a ratio by setting the total number of pieces of held influencing circumstance situation information as a whole.

8. The project management system according to claim 6, wherein the processor is further configured to output a pie chart indicating the number of pieces of influencing circumstance situation information per occurrence phase which is an occurred phase as a ratio by setting the total number of pieces of held influencing circumstance situation information as a whole.

9. The project management system according to claim 6, wherein the processor is further configured to display, with a pie chart, an influence degree of the held influencing circumstance situation information per execution manager identified by the execution manager identification information.

10. The project management system according to claim 6, wherein the processor is further configured to display, with a pie chart, an influence degree of the held influencing circumstance situation information per status identified by the status identification information.

11. A method of operating a project management system executed by a computer to execute a process, the process comprising:
holding executor identification information that identifies an executor of a project;
holding a plurality of types of influencing circumstance identification information that identifies an influencing circumstance which is a circumstance that influences the progress of the project recognized in a phase of the project;
holding status identification information that identifies a status which is information indicating a status of resolution to an influencing circumstance identified by the influencing circumstance identification information;
holding execution manager identification information that identifies an execution manager as an executor who is responsible for executing a workaround to avoid an adverse influence on the project due to the influencing circumstance;
holding phase identification information that identifies a phase of the project;
receiving an input of influencing circumstance situation information which is information that associates, with each other, the held influencing circumstance identification information, the phase identification information of the phase in which the influencing circumstance identified by the influencing circumstance identification information is recognized, recognized timing thereof, the execution manager identification information that identifies the execution manager as the executor who is responsible for executing the workaround to avoid the adverse influence on the project due to the influencing circumstance, an influence degree to which the influencing circumstance influences the project, the status identification information of the status which is information indicating the status of resolution to the influencing circumstance;
holding the received influencing circumstance situation information;
outputting the held influencing circumstance situation information; and
graphically outputting a graph with one axis as timing and another axis as the recognized number of pieces of influencing circumstance situation information using the held influencing circumstance situation information.

12. The method of operating the project management system according to claim 11, wherein
the graphically outputting the graph is further configured to graphically output a graph with the one axis as the timing and the another axis as the number of recognitions per influence degree of the influencing circumstance situation information, using received per-phase influencing circumstance situation information.

13. The method of operating the project management system according to claim 11, wherein
the graphically outputting the graph is further configured to graphically outputting a graph with the one axis as the timing and the another axis as the number of cases per status of the influencing circumstance situation information, using received per-phase influencing circumstance situation information.

14. The method of operating the project management system according to claim 11, wherein
the graphically outputting the graph is further configured to display a graphical output per phase identified by the phase identification information included in the influencing circumstance situation information.

15. The method of operating the project management system according to claim 11, wherein
the graphically outputting the graph is further configured to display a graphical output per execution manager identified by the execution manager identification information included in the influencing circumstance situation information.

16. A method of operating a project management system executed by a computer to execute a process, the process comprising:
holding executor identification information that identifies an executor of a proj ect;
holding a plurality of types of influencing circumstance identification information that identifies an influencing circumstance which is a circumstance that influences the progress of the project recognized in a phase of the project;
holding status identification information that identifies a status which is information indicating a status of resolution to an influencing circumstance identified by the influencing circumstance identification information;
holding execution manager identification information that identifies an execution manager as an executor who is responsible for executing a workaround to avoid an adverse influence on the project due to the influencing circumstance;
holding phase identification information that identifies a phase of the project;
receiving an input of influencing circumstance situation information which is information that associates, with each other, the held influencing circumstance identification information, the phase identification information of the phase in which the influencing circumstance identified by the influencing circumstance identification information is recognized, recognized timing thereof, the execution manager identification information that identifies the execution manager as the executor who is responsible for executing the workaround to avoid the adverse influence on the project due to the influencing circumstance, an influence degree to which the influencing circumstance influences the project, the status identification information of the status which is information indicating the status of resolution to the influencing circumstance;
holding the received influencing circumstance situation information;
outputting the held influencing circumstance situation information; and
outputting a pie chart indicating the number of pieces of influencing circumstance situation information per status as a ratio by setting the total number of pieces of held influencing circumstance situation information as a whole.

17. The method of operating the project management system according to claim 16, wherein
the outputting the pie chart is further configured to output a pie chart indicating the number of pieces of influencing circumstance situation information per influence degree as a ratio by setting the total number of pieces of held influencing circumstance situation information as a whole.

18. The method of operating the project management system according to claim 16, wherein
the outputting the pie chart is further configured to output a pie chart indicating the number of pieces of influencing circumstance situation information per occurrence phase which is an occurred phase as a ratio by setting the total number of pieces of held influencing circumstance situation information as a whole.

19. The method of operating the project management system according to claim 16, wherein
the outputting the pie chart is further configured to display, with a pie chart, an influence degree of the held influencing circumstance situation information per execution manager identified by the execution manager identification information.

20. The method of operating the project management system according to claim 16, wherein
the outputting the pie chart is further configured to display, with a pie chart, an influence degree of the held influencing circumstance situation information per status identified by the status identification information.

21. A non-transitory computer-readable medium having stored therein a program for causing a computer to execute a process, the process comprising:
holding executor identification information that identifies an executor of a project;
holding a plurality of types of influencing circumstance identification information that identifies an influencing circumstance which is a circumstance that influences the progress of the project recognized in a phase of the project;
holding status identification information that identifies a status which is information indicating a status of resolution to an influencing circumstance identified by the influencing circumstance identification information;
holding execution manager identification information that identifies an execution manager as an executor who is responsible for executing a workaround to avoid an adverse influence on the project due to the influencing circumstance;
holding phase identification information that identifies a phase of the project;
receiving an input of influencing circumstance situation information which is information that associates, with each other, the held influencing circumstance identification information, the phase identification information of the phase in which the influencing circumstance identified by the influencing circumstance identification information is recognized, recognized timing thereof, the execution manager identification information that identifies the execution manager as the executor who is responsible for executing the workaround to avoid the adverse influence on the project due to the influencing circumstance, an influence degree to which the influencing circumstance influences the project, the status identification information of the status which is information indicating the status of resolution to the influencing circumstance;
holding the received influencing circumstance situation information;
outputting the held influencing circumstance situation information; and
graphically outputting a graph with one axis as timing and another axis as the recognized number of pieces of influencing circumstance situation information using the held influencing circumstance situation information.

22. The non-transitory computer-readable medium according to claim 21, wherein
the graphically outputting the graph is further configured to graphically output a graph with the one axis as the timing and the another axis as the number of recognitions per influence degree of the influencing circumstance situation information, using received per-phase influencing circumstance situation information.

23. The non-transitory computer-readable medium according to claim 21, wherein
the graphically outputting the graph is further configured to graphically outputting a graph with the one axis as the timing and the another axis as the number of cases per status of the influencing circumstance situation information, using received per-phase influencing circumstance situation information.

24. The non-transitory computer-readable medium according to claim 21, wherein
the graphically outputting the graph is further configured to display a graphical output per phase identified by the phase identification information included in the influencing circumstance situation information.

25. The non-transitory computer-readable medium according to claim 21, wherein
the graphically outputting the graph is further configured to display a graphical output per execution manager identified by the execution manager identification information included in the influencing circumstance situation information.

26. A non-transitory computer-readable medium having stored therein a program for causing a computer to execute a process, the process comprising:
holding executor identification information that identifies an executor of a proj ect;
holding a plurality of types of influencing circumstance identification information that identifies an influencing circumstance which is a circumstance that influences the progress of the project recognized in a phase of the project;
holding status identification information that identifies a status which is information indicating a status of resolution to an influencing circumstance identified by the influencing circumstance identification information;
holding execution manager identification information that identifies an execution manager as an executor who is responsible for executing a workaround to avoid an adverse influence on the project due to the influencing circumstance;
holding phase identification information that identifies a phase of the project;
receiving an input of influencing circumstance situation information which is information that associates, with each other, the held influencing circumstance identification information, the phase identification information of the phase in which the influencing circumstance identified by the influencing circumstance identification information is recognized, recognized timing thereof, the execution manager identification information that identifies the execution manager as the executor who is responsible for executing the workaround to avoid the adverse influence on the project due to the influencing circumstance, an influence degree to which the influencing circumstance influences the project, the status identification information of the status which is information indicating the status of resolution to the influencing circumstance;
holding the received influencing circumstance situation information;
outputting the held influencing circumstance situation information; and
outputting a pie chart indicating the number of pieces of influencing circumstance situation information per status as a ratio by setting the total number of pieces of held influencing circumstance situation information as a whole.

27. The non-transitory computer-readable medium according to claim 26, wherein
the outputting the pie chart is further configured to output a pie chart indicating the number of pieces of influencing circumstance situation information per influence degree as a ratio by setting the total number of pieces of held influencing circumstance situation information as a whole.

28. The non-transitory computer-readable medium according to claim 26, wherein
the outputting the pie chart is further configured to output a pie chart indicating the number of pieces of influencing circumstance situation information per occurrence phase which is an occurred phase as a ratio by setting the total number of pieces of held influencing circumstance situation information as a whole.

29. The non-transitory computer-readable medium according to claim 26, wherein
the outputting the pie chart is further configured to display, with a pie chart, an influence degree of the held influencing circumstance situation information per execution manager identified by the execution manager identification information.

30. The non-transitory computer-readable medium according to claim 26, wherein
the outputting the pie chart is further configured to display, with a pie chart, an influence degree of the held influencing circumstance situation information per status identified by the status identification information.

31. A project management system comprising:
a memory;
a processor coupled to the memory and the processor configured to:
hold process identification information that identifies a process of a project;
hold a plurality of types of influencing circumstance situation information, each of which expressing an influencing circumstance which is a circumstance that influences the progress of the project recognized in the process of the project;
receive an input of per-process influencing circumstance situation information which is information that associates the held influencing circumstance situation information with process identification information of a process in which an influencing circumstance indicated by the influencing circumstance situation information is recognized; and
graphically output the per-process influencing circumstance situation information.

32. The project management system according to claim 31, wherein
the processor is further configured to graphically output the per-process influencing circumstance situation information with a matrix of the process and the influencing circumstance.

33. The project management system according to claim 31, wherein
the processor is further configured to acquire time information, further acquire per-time process influencing situation circumstance information which is information that associates the acquired time information with the per-process influencing situation circumstance information, and indicate a change in the influencing situation on a time axis.

34. The project management system according to claim 31, wherein
the type of the influencing circumstance in the influencing situation circumstance information includes information indicating an influence degree of the influencing circumstance on the completion of the project or process.

35. The project management system according to claim 31, wherein
the type of the influencing circumstance in the influencing situation circumstance information includes information indicating a possibility of appearance of the influencing circumstance on a negative side.

36. The project management system according to claim 31, wherein
the processor is further configured to hold issue information, which is information indicating an issue which hinders the complete execution of the process recognized in the process, as the influencing circumstance.

37. The project management system according to claim 31, wherein
the processor is further configured to hold essential work information, which is information indicating a work that must be processed indispensably for the complete execution of the process recognized in the process, as the influencing circumstance.

38. The project management system according to claim 31, wherein
the processor is further configured to hold change request information, which is information indicating a matter that is required to be changed for the complete execution of the process recognized in the process, as the influencing circumstance.

39. The project management system according to claim 31, wherein
the processor is further configured to hold the risk information, which is information indicating a risk recognized in the process, as the influencing circumstance.

40. A method of operating a project management system executed by a computer to execute a process, the process comprising:
holding process identification information that identifies a process of a project;
holding a plurality of types of influencing circumstance situation information, each of which expressing an influencing circumstance which is a circumstance that influences the progress of the project recognized in the process of the project;
receiving an input of per-process influencing circumstance situation information which is information that associates the held influencing circumstance situation information with process identification information of a process in which an influencing circumstance indicated by the influencing circumstance situation information is recognized; and
graphically outputting the per-process influencing circumstance situation information.

41. The method of operating the project management system according to claim 40, wherein
the graphically outputting is further configured to graphically output the per-process influencing circumstance situation information with a matrix of the process and the influencing circumstance.

42. The method of operating the project management system according to claim 40, wherein
the process includes acquiring time information, and acquiring per-time process influencing situation circumstance information which is information that associates the acquired time information with the per-process influencing situation circumstance information, and
the graphically outputting includes indicating a change in the influencing situation on a time axis.

43. The method of operating the project management system according to claim 40, wherein
the type of the influencing circumstance in the influencing situation circumstance information includes information indicating an influence degree of the influencing circumstance on the completion of the project or process.

44. The method of operating the project management system according to claim 40, wherein
the type of the influencing circumstance in the influencing situation circumstance information includes information indicating a possibility of appearance of the influencing circumstance on a negative side.

45. The method of operating the project management system according to claim 40, wherein
the holding the plurality of types of influencing circumstance situation information includes holding issue information, which is information indicating an issue which hinders the complete execution of the process recognized in the process, as the influencing circumstance.

46. The method of operating the project management system according to claim 40, wherein
the holding the plurality of types of influencing circumstance situation information includes holding essential work information, which is information indicating a work that must be processed indispensably for the complete execution of the process recognized in the process, as the influencing circumstance.

47. The method of operating the project management system according to claim 40, wherein
the holding the plurality of types of influencing circumstance situation information includes holding change request information, which is information indicating a matter that is required to be changed for the complete execution of the process recognized in the process, as the influencing circumstance.

48. The method of operating the project management system according to claim 40, wherein
the holding the plurality of types of influencing circumstance situation information includes holding the risk information, which is information indicating a risk recognized in the process, as the influencing circumstance.

49. A non-transitory computer-readable medium having stored therein a program for causing a computer to execute a process, the process comprising:
holding process identification information that identifies a process of a project;
holding a plurality of types of influencing circumstance situation information, each of which expressing an influencing circumstance which is a circumstance that influences the progress of the project recognized in the process of the project;
receiving an input of per-process influencing circumstance situation information which is information that associates the held influencing circumstance situation information with process identification information of a process in which an influencing circumstance indicated by the influencing circumstance situation information is recognized; and
graphically outputting the per-process influencing circumstance situation information.

50. The non-transitory computer-readable medium according to claim 49, wherein
the graphically outputting is further configured to graphically output the per-process influencing circumstance situation information with a matrix of the process and the influencing circumstance.

51. The non-transitory computer-readable medium according to claim 49, wherein
the process includes acquiring time information, and acquiring per-time process influencing situation circumstance information which is information that associates the acquired time information with the per-process influencing situation circumstance information, and
the graphically outputting includes indicating a change in the influencing situation on a time axis.

52. The non-transitory computer-readable medium according to claim 49, wherein
the type of the influencing circumstance in the influencing situation circumstance information includes information indicating an influence degree of the influencing circumstance on the completion of the project or process.

53. The non-transitory computer-readable medium according to claim 49, wherein
the type of the influencing circumstance in the influencing situation circumstance information includes information indicating a possibility of appearance of the influencing circumstance on a negative side.

54. The non-transitory computer-readable medium according to claim 49, wherein
the holding the plurality of types of influencing circumstance situation information includes holding issue information, which is information indicating an issue which hinders the complete execution of the process recognized in the process, as the influencing circumstance.

55. The non-transitory computer-readable medium according to claim 49, wherein
the holding the plurality of types of influencing circumstance situation information includes holding essential work information, which is information indicating a work that must be processed indispensably for the complete execution of the process recognized in the process, as the influencing circumstance.

56. The non-transitory computer-readable medium according to claim 49, wherein
the holding the plurality of types of influencing circumstance situation information includes holding change request information, which is information indicating a matter that is required to be changed for the complete execution of the process recognized in the process, as the influencing circumstance.

57. The non-transitory computer-readable medium according to claim 49, wherein
the holding the plurality of types of influencing circumstance situation information includes holding the risk information, which is information indicating a risk recognized in the process, as the influencing circumstance.
